(19) United States
(12) Patent Application Publication
(10) Pub. No.: US 2002/0118671 A1
(43) Pub. Date: Aug. 29, 2002

(54) Extending office telephony and network data services to a remote client through the internet

(75) Inventors: Leven E. Staples, Granbury, TX (US); William Benjamin Barker, San Antonio, TX (US); Kenneth L. Witt, San Antonio, TX (US); David C. Oliver, San Antonio, TX (US)

Correspondence Address: Robert C. Kowert, Conley, Rose, & Tayon, P.C., P.O. Box 398, Austin, TX, 78767, US

(73) Assignee: Data Race, Inc.

(21) Appl. No.: 09/905,162

(22) Filed: Jul. 12, 2001

Related U.S. Application Data
(63) Continuation-in-part of application No. 08/995,765, filed on Dec. 22, 1997, now Pat. No. 6,301,339.
(63) Continuation-in-part of application No. 08/740,775, filed on Nov. 1, 1996, now Pat. No. 5,889,845.
(63) Continuation-in-part of application No. 08/708,267, filed on Sep. 6, 1996.
(63) Continuation of application No. 08/559,472, filed on Nov. 15, 1995, now Pat. No. 5,764,639.
(60) Provisional application No. 60/218,077, filed on Jul. 12, 2000.

(51) Int. Cl. H04L 12/66

(52) U.S. Cl. 370/352; 379/93.01

(57) ABSTRACT

A communication system, extends office telephony and network data services to remote clients through the Internet, comprises a telephony server, a local area network, a server system, and a user communication device. The telephony server (e.g. a Private Branch Exchange) provides telephony services for a plurality of office lines. The local area network couples to the Internet. The telephony server and local area network may reside within an office environment. The server system couples to the telephony server and to the local area network. The user communication device establishes a first connection to the server system through the Internet. In response to the first connection, the server system automatically provides access for the user communication device to the telephony server. Also, the server system automatically invokes a call forwarding operation in response to the first connection, so that subsequent telephone calls, intended to reach the user's office line, are forwarded to the server system. When the server system receives a first telephone call, which has been redirected by the telephony server from the user's office line, the server system forwards the first telephone call to the user communication device through the first connection. The user communication device may also establish a secure data connection to the server system through the Internet. The secure data connection provides the remote user with access to the local area network in a manner which protects the data security of the local area network.

### CONTINUATION DATA

This application claims benefit of priority to U.S. Provisional application Serial No. 60/218,077, filed Jul. 12, 2000.

This is a continuation-in-part of co-pending U.S. application Ser. No. 08/995,765 titled “System And Method For Providing A Remote User With A Virtual Presence To An Office”, and filed Dec. 22, 1997, whose inventors were Leven E. Staples, W. B. Barker and Kenneth L. Witt, and which is assigned to Data Race, Inc.

The U.S. application Ser. No. 08/995,765 is a continuation-in-part of U.S. application Ser. No. 08/740,775 (now U.S. Pat. No. 5,889,845) titled “System And Method For Providing A Remote User With A Virtual Presence To An Office”, and filed Nov. 1, 1996, whose inventors were Leven E. Staples, W. B. Barker and Kenneth L. Witt, and which is assigned to Data Race, Inc., which is a continuation of U.S. application Ser. No. 08/559,472 (now U.S. Pat. No. 5,764,639) titled “System And Method For Providing A Remote User With A Virtual Presence To An Office”, and filed Nov. 15, 1995, whose inventors were Leven E. Staples, W. B. Barker and Kenneth L. Witt, and which is assigned to Data Race, Inc.

The U.S. application Ser. No. 08/995,765 is also a continuation-in-part of copending application Ser. No. 08/708,267 titled “System And Method for Providing User Connectivity to a Remote Data Site on a Communication Line While Maintaining Telephone Connectivity on the Communication Line”, and filed Sep. 6, 1996, whose inventor was W. B. Barker, and which is assigned to Data Race, Inc.

### FIELD OF THE INVENTION

The present invention relates to a communication system for extending the telephony services and network data services available in an office environment to a remote user who connects to the office environment through the Internet.

### DESCRIPTION OF THE RELATED ART

As illustrated in FIG. 1, the typical modem office 5 includes an office data network 10 and a Private branch exchange (PBX). The office data network 10 comprises a system of interconnected computers, and provides data resources such as file servers, print servers, email servers, application servers, remote access servers, fax servers, Internet firewalls, routers, domain controllers, etc. Some of the network computers are generally assigned to individual workers in the office as suggested by computers 15A, 15B and 15C. The three computers 15A, 15B and 15C are meant to represent an arbitrary number of such personally assigned computers. The PBX couples to a set of PBX office phones and provides a host of telephony functions for office workers who use the PBX office phones. The three PBX phones 20A, 20B and 20C are meant to represent an arbitrary number of PBX phones. The PBX also couples to the Public Switched Telephone Network (PSTN).

A worker who is physically present in the office may use one of the network computers 15A-C to access the data resources available on the office data network 10. In addition, the worker may also have a dedicated PBX phone. Using the PBX phone, the worker has access to the telephony functions provided by the PBX. The worker may use the PBX phone to:

(1) initiate “outside” telephone calls to the PSTN;

(2) receive “outside” telephone calls from the PSTN;

(3) initiate telephone calls to other office workers using a contracted PBX extension, e.g. a three-digit extension;

(4) receive telephone calls from other office workers;

(5) transfer a received telephone call to another office worker;

(6) initiate a conference call;

(7) playback voice mail messages left by other office workers or outside callers;

(8) leave a voice mail message for another office worker;

(9) initiate an intercomm dialog with another office worker;

(10) automatically receive an intercomm dialog initiated by another office worker;

(11) disable reception of intercomm dialogs;

(12) place one or more telephone calls on hold;

(13) pick up one of the telephone calls that are “on hold”;

(14) automatically redial a previously dialed telephone number;

(15) examine a caller's identity (name and number) before answering a telephone call;

(16) etc.

The telephony resources provided by the PBX and the data resources provided by the office data network greatly extend the worker's capacity to conduct business as long as he/she is physically present in the office.

The worker quite often has an assigned work area in the office. For the worker's convenience, one of the network computers may be assigned to the worker and located in his/her work area. Similarly, one of the PBX phone extensions may be assigned to the worker and located in his/her work area. Thus, while physically present in his/her work area, the worker has immediate and simultaneous access to network data services through the assigned network computer and telephony services through the assigned PBX phone. This simultaneous availability of network data and telephony services greatly extends the worker's productivity, especially since the two types of services are often synergistic.

If a worker is away from the office, he/she may access the office data network through the Public Switched Telephone Network (PSTN) provided (a) the worker has a computer 25 configured with a modem 30 and remote access client software (not shown), and (b) the office data network has a remote access server (RAS). The remote access server is typically configured with a bank of server modems which couple to the PSTN. For simplicity, only one server modem is illustrated. The remote access client software allows the remote user to initiate a dial-up connection to the remote access server through the PSTN. Once the dial-up connection is established, the remote access server may allow the remote worker to access the resources of the office data network 10. The remote worker may perform data transfer activities using the office network resources. For example, the remote worker may copy files to/from an office file server.

However, even with the dial-up connection to the office data network, the remote worker's capacity to effect business does not approach that of being physically present in the office because the remote worker is isolated from the office PBX and the telephony services it provides. In particular, the remote worker is isolated from his/her office telephone (e.g. PBX phone 20A), and thus, not able to answer calls directed to his/her office telephone. This problem is exacerbated by the fact that the remote worker is often situated in a location where only one telephone line is readily available. The dial-up connection to the remote access server ties up the one telephone line. In order to initiate or receive a telephone call on the one telephone line, the remote worker must terminate the remote access connection and connect a telephony device to the one telephone line.

In some situations, the remote worker may have access to a second telephone line at the remote location (e.g. at home, in a hotel room, etc.), i.e. a second connection to the PSTN. The second telephone line may be used for normal PSTN telephone calls, while the first telephone line is used for the dial-up connection to the office data network 10. The two telephone lines allow the remote worker to have simultaneous access to the office data resources and to PSTN telephone calls. However, the costs associated with installing and/or leasing two telephone lines may discourage the remote worker from pursuing this solution. In addition, even with a second telephone line, the remote worker is effectively isolated from his/her office telephone. Any calls to the worker's office telephone go unanswered, and the remote worker is not cognizant that others have been calling his/her office telephone.

If the remote worker's computer is configured with Internet Telephony (IT) software, the remote worker may use the dial-up connection to converse with an IT correspondent. The IT correspondent may be situated at one of the network computers (e.g. computer 15B) on the office data network 10. In this case, voice packets generated by the remote worker's computer 25 flow through the dial-up connection to the remote access server, onto the data network, and through the data network to the IT correspondent. Voice packets from the IT correspondent follow the reverse path to the remote worker's computer. It is also possible that the IT correspondent may be situated at an arbitrary Internet location because the office data network may be connected to the Internet. In this case, voice packets from the remote worker's computer 25 flow through the dial-up connection to the remote access server, through the office data network to the firewall, out the firewall, and through the Internet to the IT correspondent.

It is noted that the client modem 30 may connect to the PSTN through a low-bandwidth connection such as an analog telephone line. In this case, the remote worker may have to shut down all applications except the IT application when performing Internet telephony because conventional operating systems and modems may do nothing to prioritize the transfer of telephony data (or real-time data) over the transfer of non-real-time data. If the remote worker tries to run a second application in addition to the IT application, the telephony packets generated by the IT application may suffer increased delays in transmission especially when the second application generates large data packets. The delays may be sufficient to compromise the intelligibility of the reconstructed speech at the telephony packet receiver. Thus, there exists a need for a system and method which could prioritize the transfer of real-time data over non-real-time data especially when using a low-bandwidth connection to a switching network such as the PSTN or the Internet.

While the IT software allows the remote worker to converse with IT correspondents through the dial-up connection, the set of all IT correspondents in the world (i.e. people who have access to a computer configured with appropriate IT hardware and software as well as connectivity to the Internet) is much smaller than the set of all PSTN users (i.e. people who have ready access to a PSTN phone). Furthermore, there is a large intersection between the two sets, i.e. many IT correspondents are often PSTN users as well. It should be noted that PSTN phones are generally “online” 24 hours a day, seven days a weeks, while IT phones are online only when the owner is connected to the Internet and has chosen to invoke his/her IT software. Thus, at least for the near future, remote workers will continue to have a substantial interest in conversing with PSTN correspondents through their dial-up connections.

In the telecommunication marketplace, systems known as VoIP (Voice over Internet Protocol) gateways may provide Internet telephony users with access to the PSTN. If the office data network is equipped with a VoIP gateway, the remote worker may use Internet telephony software (perhaps a different IT software application from the one discussed above) to converse with a PSTN correspondent. In response to inputs provided by the remote worker, the Internet Telephony software may establish an IP connection to the VoIP gateway through the dial-up connection and office data network 10. However, again, the remote worker may have to shut down all applications except the IT application when performing Internet telephony to a VoIP gateway because the data traffic generated by the competing applications may induce excessive delays in delivery of telephony packets to/from the VoIP gateway.

The VoIP gateway couples to the PSTN through a number K_{g1} of physical lines. Generally, a significantly larger number N_{g1} of telephone numbers is associated with the K_{g1} physical lines. The owner of the VoIP gateway will have negotiated with a local telephone company for a lease of the K_{g1} physical lines and the N_{g1} telephone numbers. The local telephone company configures its switching hardware so that any telephone call directed to one of the N_{g1} telephone numbers is mapped onto an available one of the K_{g1} physical lines. A physical line is said to be available if it is not currently handling a telephone call. Thus, the K_{g1} physical lines cannot support more than K_{g1} simultaneous telephone conversations.

In addition, the remote worker may access a VoIP gateway external to the office network through the office firewall. For example, a VoIP gateway may be physically located on the premises of a company specializing in VoIP services.

Because the PSTN dynamically maps calls directed for the N_{g1} telephone numbers to the K_{g1} physical lines on the basis of availability, any of the telephone numbers may be mapped to any one of the physical lines. Thus, when the switching hardware forwards a telephone call directed for telephone number X onto physical line Y, an indication of the telephone number X is embedded in the analog telephone signal which carries the telephone call and is transmitted onto physical line Y. When the VoIP gateway receives the telephone call on physical line Y, it recovers the embedded telephone number X from the analog telephone signal. It is noted that the PSTN and VoIP gateway may be connected by digital telephone lines instead of or in addition to the analog telephone lines described above.

The VoIP gateway also manages the K_{g1} physical lines as a shared resource. When a VoIP client (such as the remote worker's computer 25) establishes an IP connection to the VoIP gateway, the VoIP gateway assigns an available one of the N_{g1} telephone numbers to the VoIP client. A telephone number is said to be available if it is not currently assigned to any VoIP client. The VoIP gateway may transmit the assigned telephone number to the VoIP client through the IP connection. Because the VoIP gateway dynamically assigns telephone numbers to VoIP clients as they login, a VoIP client must inform potential PSTN correspondents of his/her assigned telephone number. The VoIP client may use an alternate communication means (such as email) to inform potential PSTN correspondents of his/her assigned telephone number at the VoIP gateway. The necessity of informing potential PSTN correspondents of a new telephone number at each login to the gateway is awkward and time-consuming.

A PSTN correspondent (e.g. one situated at phone 35) desiring to converse with the remote worker may call the worker's assigned telephone number. The VoIP gateway receives the telephone call on arbitrary line Y of the K_{g1} physical lines. The VoIP gateway decodes the telephone number X associated with the telephone call from the analog signal conveyed on line Y. The VoIP gateway looks up the worker's IP address based on the associated telephone number X. (The VoIP gateway will have stored the IP address and the assigned telephone number for each VoIP client at connect time.) The VoIP gateway forwards an indication of the telephone call to the remote worker's computer 25. If the remote worker chooses to answer the call, the VoIP gateway starts to digitize the correspondent's analog voice signal from line Y, to compress the digitized voice data, and to forward the compressed voice data to the VoIP client through the IP connection. The compressed voice packets flow from the VoIP gateway to the RAS server through the office data network 10, and through the dial-up connection to the remote worker's computer. In the reverse direction, compressed voice packets from the remote worker's computer flow through the dial-up connection to the RAS server, and through the office data network 10 to the VoIP gateway. The VoIP gateway receives and decompresses the compressed voice packets from the VoIP client, converts the decompressed voice data into a second analog signal, and transmits the second analog signal to the correspondent through line Y.

The VoIP gateway also allows the remote worker make a VoIP call out to the PSTN. In response to a dial command asserted by the remote worker, the IT software may prompt the remote worker for the telephone number of a PSTN phone such as phone 35. The IT software receives the telephone number from the remote worker, and transmits the phone number to the VoIP gateway through the IP connection. In response to receiving the phone number, the VoIP gateway dials the phone number (i.e. initiates a telephone call to phone 35 using the phone number). If a PSTN correspondent picks up (i.e. answers the telephone call to) phone 35, the remote worker's computer may direct voice packets to the VoIP gateway through the dial-up connection (including client modem 30, PSTN, server modem 32 and the RAS) and office data network 10. The VoIP gateway decompresses the voice packets and converts the decompressed voice data into an analog signal for transmission to phone 35 through the PSTN. In the reverse direction, the VoIP gateway receives a second analog signal from the PSTN (comprising a representation of the PSTN correspondent's voice). The VoIP gateway digitizes the second analog signal, compresses the resulting digital data into voice packets, and forwards the voice packets to the remote worker's computer through the office data network and the dial-up connection.

Alternatively, the remote worker's computer may connect to a VoIP gateway (not shown) provided by an Internet Telephony Provider. In this case, voice packets generated by the remote worker's computer flow through the dial-up connection to the RAS, onto the office data network 10, through the office data network to the office firewall, out the firewall onto the Internet, and through the Internet to the VoIP gateway at the IT provider.

Thus, the number N_{g1} of telephone numbers associated with the K_{g1} physical lines may be significantly larger than N_{g1}. The number N_{g1} may be chosen based on an estimate of the maximum expected number of simultaneously connected clients. The number K_{g1} is based on a estimate of the maximum number of clients who are expected to be simultaneously conversing.

In addition to the dial-up RAS connection to the office data network described above, many modern offices allow remote workers to access the office data network through the Internet as shown in FIG. 2. The remote worker's computer may be configured with a client modem 30 and Internet access software, and the office data network may be equipped with a firewall and a virtual private network (VPN) server. The Internet access software allows the remote worker to initiate a dial-up connection to a remote access server at an Internet Service Provider (ISP). When the dial-up connection to the ISP has been established, a VPN client (also executing on the remote worker's computer) may establish a reliable TCP/IP connection to the office VPN server through the Internet. To provide security and prevent unauthorized access, encryption may be employed. Software applications running on the remote worker's computer may then communicate with the office data network through the VPN connection (i.e. the reliable TCP/IP connection). Because user data is multiplexed at a very high level (IP frame level) and the VPN connection is reliable (i.e. data is resent when errors occur, causing arbitrary delays), a VPN connection is not an effective means for transferring voice data such as Voice over IP.

Thus, the Internet-based connection to the office data network may allow the remote worker to access some of the resources of the office data network 10. These resources may include the ability to initiate/receive calls to/from PSTN phones through a VoIP gateway. However, the remote worker is still isolated from the telephony services provided by the office PBX. Thus, there exists a need for a system and method which could provide a remote worker with simultaneous access (a) to some or all of the telephony services of an office telephony server (e.g. PBX) and (b) to the data resources of the office data network 10.

### SUMMARY OF THE INVENTION

The problems described above are addressed by a communication system according to the present intention which extends office telephony and network data services to remote clients through the Internet. In one embodiment, the communication system comprises a telephony server, a local area network, a server system, and a first user communication device. The telephony server is configured to provide telephony services for a plurality of office communication lines, e.g. office telephone lines. The telephony server may be a private branch exchange (PBX). Alternatively, the telephony server may represent a service provided by a local telephone company. The local area network comprises a system of interconnected computers or computer networks, and couples to the Internet (typically through a firewall computer). The telephony server and local area network may reside within an office environment. A user who is physically present in the office environment may be assigned one of the network computers (i.e. one of the computers of the local area network) and one of the office communication lines.

The server system is configured for coupling to the telephony server and to the local area network. The first user communication device may be situated remotely from the telephony server and/or local area network. The first user communication device is configured to establish a first connection (i.e. a telephony connection) to the server system through the Internet. In response to the first user communication device establishing the first connection to the server system, the server system is configured to automatically provide access for the first user communication device to the telephony server. The server system is further configured to automatically invoke a call forwarding operation in response to the first user communication device establishing the first connection to the server system, so that subsequent telephone calls, intended to reach the user's office communication line, are forwarded to the server system.

In the preferred embodiment, the telephony server associates a first telephone number with the user's office communication line. The server system invokes to call forwarding operation by commanding the telephony server to redirect subsequent telephone calls addressing the user's telephone number to a second telephone number. The second telephone number is a number associated with the server system.

The server system may couple to the telephony server through a collection of physical lines. The telephony server associates a plurality of telephone numbers to the collection of physical lines. The telephony server may manage the collection of physical lines as a hunt group with respect to the plurality of telephone numbers. The server system is configured to support a plurality of the user communication devices simultaneously connected to the server system. Each of the user communication devices may connect to the server system over the Internet through one or more Internet protocol (IP) connections. The server system allocates one of the plurality of telephone numbers to the first user communication device in response to the first user communication device establishing the first connection to the server system. This allocated telephone number is the second telephone number referred to above. The first user communication device is configured to transmit information which identifies the remote user to the server system. The server system may use the identifying information to look up the user's telephone number.

When the server system receives a first telephone call, which has been redirected by the telephony server from the user's telephone number to the second telephone number, the server system is configured to forward an indication of the first telephone call to the first user communication device through the first connection. In response to an answer indication received from the first user communication device, the server system is configured to receive a voice signal from the telephony server, and to transmit corresponding voice data (e.g. encoded voice packets) to the first user communication device through the first connection. The first voice signal represents the voice of a correspondent who initiated the first telephone call expecting to be connected to the user at the first office communication line. The first telephone call may originate from an office mate in the office environment having access to one of the office communication lines. In addition, the telephony server made connect to the PSTN. Thus, the first telephone call may originate from the PSTN.

In the preferred embodiment, the server system is further configured to provide access for the first user communication device to the local area network. The server system is configured to provide access to the local area network and to the telephony server for a plurality of user communication devices including the first user communication device. The first user communication device may comprise a client computer and a client modem.

The server system may include a telephony gateway which interfaces with the telephony server. The client computer is configured to execute an arbitrary number of software applications. The remote user may load and execute a telephony client application on the client computer. The telephony client application is configured to establish the first connection through the Internet to the telephony gateway. The telephony client application supports a remote phone for the remote user. The telephony client application and the telephony gateway maintain a voice and telephony control interface between the remote phone and the telephony server by exchanging telephony packets through the first connection. The telephony packets comprise voice data and/or control messages.

The telephony client application is configured to repeatedly transmit a first control message in successive telephony packets to the telephony gateway through the first connection until it receives a return telephony packet from telephony gateway containing an indication that the telephony gateway has received the first control message. After the acknowledgement indication has been received, the telephony client application may transmit a second control message in successive telephony packet. Conversely, the telephony gateway is configured to repeatedly transmit a control message in successive telephony packets to the telephony client application through the first connection until receiving a first telephony packet from the telephony client application containing an indication that the telephony client application has received the control message.

The telephony server is configured to provide telephony services for the office communication lines. In particular, the telephony server is configured to provide a first set of telephony functions to the user's office communications line. The voice and telephony control interface sustained by the telephony client and the telephony gateway extends to the remote phone at least a subset of the first set off telephony functions. For example, the subset of telephony functions may include extension dialing, where the user specifies only an extension number to the remote phone in order to call one of the office communication lines. The remote phone may comprise a graphical user interface and/or a physical user phone.

The telephony gateway to measure an elapsed time from the reception of a last telephony packet from the telephony client application. The telephony gateway is configured to automatically cancel the call forwarding operation when the elapsed time exceeds a predefined timeout value. The telephony client application may transmit telephony packets comprising “keep-alive” messages to the telephony gateway through the first connection to prevent cancellation of the call forwarding operation.

In addition to receiving incoming calls, the remote user may initiate outgoing telephone calls. In response to user manipulations of the remote phone, the telephony client application is configured to transmit a telephone number to the telephony gateway through the first connection. The telephony gateway receives the telephone number and initiates a telephone call addressed to the telephone number through the telephony server.

The server system may further include a virtual private network (VPN) server, and the client computer may execute a VPN client application. The VPN client application is configured to establish a second connection through the Internet to the VPN server. The VPN server and telephony gateway may reside within a common host computer or distinct host computers. The VPN client application is configured to transmit first network data to the VPN server through the second connection. The VPN server is configured to receive the first network data and to transmit the first network data onto the local area network. The VPN server is further configured to receive second network data, generated in response to the first network data, from the local area network, and to transmit the second network data to the VPN client application through the second connection.

In one embodiment, the telephony client and the VPN client are integrated into a virtual presence application. When the remote user invokes the virtual presence application, the virtual presence application may automatically establish the first connection to the telephony gateway, and the second connection to the VPN server.

As described above, the first user communication device may include a client computer and a client modem. The client modem is configured for coupling to a server modem through a switching network. The server modem is configured for coupling to a remote access server. The remote access server connects to the Internet. The remote access server may be situated on the premises of an Internet service provider (ISP). The switching network may be the public switched telephone network (PSTN), the Digital Subscriber Line (DSL) network, the cable network, etc.

In one alternative embodiment, remote access server (RAS) may reside in a remote branch office of the same organization which owns/controls the office environment. For example, workers for XYZ Corporation visiting Tokyo may access the Internet through a remote access server in XYZ's Tokyo office. These workers may then connect through the Internet to a server system in the Amsterdam home office.

The client computer is configured to execute one or more real-time applications including the telephony client application. The one or more real-time applications generate first real-time data frames. For example, the telephony client application generates first real-time telephony frames addressed for the telephony gateway. In addition, the VPN client generates first regular data frames. The client modem receives the first real-time data frames and the first regular data frames, and transmits the first real-time data frames and first regular data frames to the server modem through the switching network. The server modem sends the first real-time data frames and first regular data frames to the remote access server. The remote access server transmits the real-time data frames and the first regular data frames onto the Internet. Normal IP routing mechanisms are responsible for delivering the first real-time telephony frames and first regular data frames to the telephony gateway and the VPN server respectively through the Internet.

In addition, the telephony gateway transmits second telephony frames, addressed for the telephony client, onto the local area network. The VPN server transmits second regular data frames, addressed for the VPN client, onto the local area network. Normal IP routing mechanisms are responsible for delivering the second telephony frames and the second regular data frames to the remote access server through the Internet from the local area network. The remote access server is configured to receive the second telephony frames and the second regular data frames from the Internet, and to send the second telephony frames and second regular data frames to the server modem. The server modem transmits the second telephony frames and the second regular data frames to the client modem through the switching network. The client modem is configured to send the second telephony frames and the second regular data frames to the client computer. An IP stack executing on the client computer is configured to receive the second telephony frames and the second regular data frames from the client modem. The IP stack sends the second telephony frames to the telephony client, and sends the second regular data frames to the VPN client.

In one embodiment, the client modem receives first real-time data frames and the first regular data frames from the client computer, stores the first real-time data frames in a first real-time buffer, stores the first regular data frames in a first regular data buffer, transmits real-time data from the first real-time buffer onto the switching network when the first real-time buffer is nonempty, and transmits regular data from the first regular data buffer onto the switching network only when the first real-time buffer is empty and when the first regular data buffer is nonempty. The client modem preferably transmits a first escape sequence prior to transmitting the real-time data.

Similarly, the server modem receives the second telephony frames and the second regular data frames from the remote access server, stores the second telephony frames in a second real-time buffer, stores the second regular data frames in a second regular data buffer, transmits real-time data from the second real-time data buffer onto the switching network when the second real-time buffer is nonempty, and transmits regular data from the second regular data buffer onto the switching network only when the second real-time buffer is empty and when the second regular data buffer is nonempty. The server modem preferably transmits a first escape sequence prior to transmitting the real-time data from the second time data buffer.

In a second embodiment, the server system further comprises a proxy server, and the server modem comprises a conventional modem. The client modem establishes a third IP connection to the proxy server through the switching network, the server modem, the remote access server, and the Internet. The proxy server and the telephony gateway may reside within a common host computer or within distinct host computers.

In the second embodiment, the client modem multiplexes the first real-time data frames and the first regular data frames into a first stream of tinygrams addressed for the proxy server, and transmits the first stream to the proxy server through the third IP connection. The client modem is configured to embed real-time data from the first real-time buffer into the tinygrams comprising the first stream with priority over regular data from the first regular data buffer. The proxy server recovers the first real-time data frames and the first regular data frames from the first stream of tinygrams, and sends the first telephony frames to the telephony gateway through the local area network, and sends the first regular data frames to the VPN server through the local area network.

In the second embodiment, the client modem receives the first real-time data frames and the first regular data frames from the client computer, stores the first real-time data frames in a first real-time buffer, stores the first regular data frames in a first regular data buffer, initiates transmission of a first tinygram commencing with regular data from the first regular data buffer in response to the first regular data buffer becoming nonempty when the first real-time buffer is empty, and concludes transmission of the first tinygram if the first real-time buffer remains empty until a complete regular data frame has been transmitted from the first regular data buffer. If the first real-time buffer becomes nonempty before the complete regular data frame has been transmitted, the client modem interrupts transmission of the regular data within the first tinygram, and concludes transmission of the first tinygram by transmitting real-time data from the first real-time buffer.

In the reverse direction, the proxy server receives the second telephony frames from the telephony gateway, and the second regular data frames from the VPN server. The proxy server multiplexes the second telephony frames and the second regular data frames into a second stream of tinygrams, and transmits the second stream of tinygrams to the client modem through the third IP connection. The client modem recovers the second telephony frames and the second regular data frames from the second stream of tinygrams, and sends the second telephony frames and the second regular data frames to the client computer. The proxy server is configured to embed real-time data (e.g. telephony data) from the second real-time buffer into tinygrams comprising the second stream with priority over regular data from the second regular data buffer.

### BRIEF DESCRIPTION OF THE DRAWINGS

A better understanding of the present invention can be obtained when the various embodiments of the following detailed description is considered in conjunction with the following drawings, in which:

FIG. 1 illustrates a modern office environment according to the prior art comprising an office data network 10 and a Private branch exchange (PBX);

FIG. 2 illustrates a prior art configuration by which a remote client may access a Voice over IP (VoIP) gateway in the office environment through the Internet, where the VoIP gateway connects to the PSTN;

FIG. 3A illustrates a communication system 100 for extending telephony access and/or network data access to a remote user equipped with user communication device 130;

FIG. 3B illustrates an alternate embodiment of communication system 100 where functionality of telephony server 110 is provided by the local telephone company;

FIG. 4 illustrates one embodiment of server system 120, where server system 120 includes a virtual private network server 122 and a telephony gateway 123;

FIG. 5 illustrates user communication device 130 connecting to the Internet 125 through a remote access connection;

FIG. 6 is an abstracted diagram of the system components at both ends of the telephony connection and secure data connection to telephony gateway 123 and VPN server 122 respectively;

FIG. 7 illustrates one embodiment of a telephony application window 95 and one embodiment of a virtual phone interface 94 in telephony application window 95;

FIG. 8 illustrates the transmission side of one embodiment of a telephony transfer protocol between telephony client 91 and telephony gateway 123;

FIG. 9 illustrates the reception side of a telephony transfer protocol between telephony client 91 and telephony gateway 123;

FIG. 10 illustrates one possible format for telephony packets transmitted/received by telephony client 91 and telephony server 123;

FIG. 11 illustrates a modem-to-modem based system 1000 for expediting the transfer of real-time data with respect to non-real-time data through a switching network such as the PSTN;

FIG. 12A illustrates the transmission architecture of client modem 1113;

FIG. 12B illustrates a state diagram for transmission logic 1146 of modem 1113;

FIG. 12C illustrates an escape sequence protocol for real-time data injection into an output data stream;

FIG. 12D illustrates further features of the escape sequence protocol;

FIG. 12E illustrates the initiation of a frame transmission in response to the availability of real-time data;

FIG. 13A illustrates the reception architecture of modem 1113;

FIG. 13B illustrates a state diagram for transmit logic 1170 which handles data transmissions from modem 1113 to first computer 112;

FIG. 14A illustrates a Point-to-Point Protocol (PPP) frame format;

FIG. 14B illustrates the format of a PPP header field; and

FIG. 15 illustrates an alternate embodiment of modem 1113 comprising a convention modem 1210 and a software client 1200;

FIG. 16 illustrates a hybrid modem-server system 2000 for providing simultaneous real-time and regular data transfer between client computer 112 and a data network 2119;

FIG. 17 illustrates one embodiment of proxy server 2120;

FIG. 18A illustrates a transmission architecture for modem 2113;

FIG. 18B is a transmission state diagram for modem 1113 describing the transmission of real-time data and non-real-time data (i.e. regular data) onto subscriber connection SC#1;

FIG. 18C provides an example of the multiplexing performed by transmit logic 2246 in accordance with the transmission state diagram of FIG. 18B;

FIG. 18D provides another example of the multiplexing performed by transmit logic 2246 in accordance with the transmission state diagram of FIG. 18B;

FIG. 19A illustrates one possible format for a generic UDP tinygram;

FIG. 19B illustrates the format of a UDP header;

FIG. 20A illustrates a reception architecture for software adapter 2137;

FIGS. 20B and 20C illustrate a flowchart for the processing of tinygrams by reception interface 2464;

FIG. 21A illustrates a transmission architecture for software adapter 2137;

FIG. 21B illustrates a transmission state diagram for transmission interface 2480;

FIG. 22 illustrates a reception architecture for modem 2113;

FIG. 23 illustrates a software client 2200 which performs tinygram multiplexing/demultiplexing in conjunction with a conventional modem 2210;

FIG. 24 illustrates an alternate embodiment for server-modem system 2000 which translates UDP tinygrams into TCP-format tinygrams for transmission across the Internet backbone;

FIG. 25A shows client computer 112 connecting to the Internet 125 through an Internet Service Provider 170, and modem 2113 connecting to proxy server 2120 through the Internet, where proxy server 2120 is comprised within server system 120 in the office environment;

FIG. 25B shows one embodiment for proxy server 2120, VPN server 122 and telephony gateway 123;

FIG. 26 illustrates an integrated server which integrates the functions performed by proxy server 2120, VPN server 122 and telephony server 123.

While the invention is susceptible to various modifications and alternative forms, specific embodiments are shown by way of example in the drawings and will herein be described in detail. It should be understood however, that the drawings and detailed description thereto are not intended to limit the invention to the particular forms disclosed. But on the contrary the invention is to cover all modifications, equivalents and alternatives following within the spirit and scope of the present invention as defined by the appended claims.

### DETAILED DESCRIPTION OF THE PREFERRED EMBODIMENTS

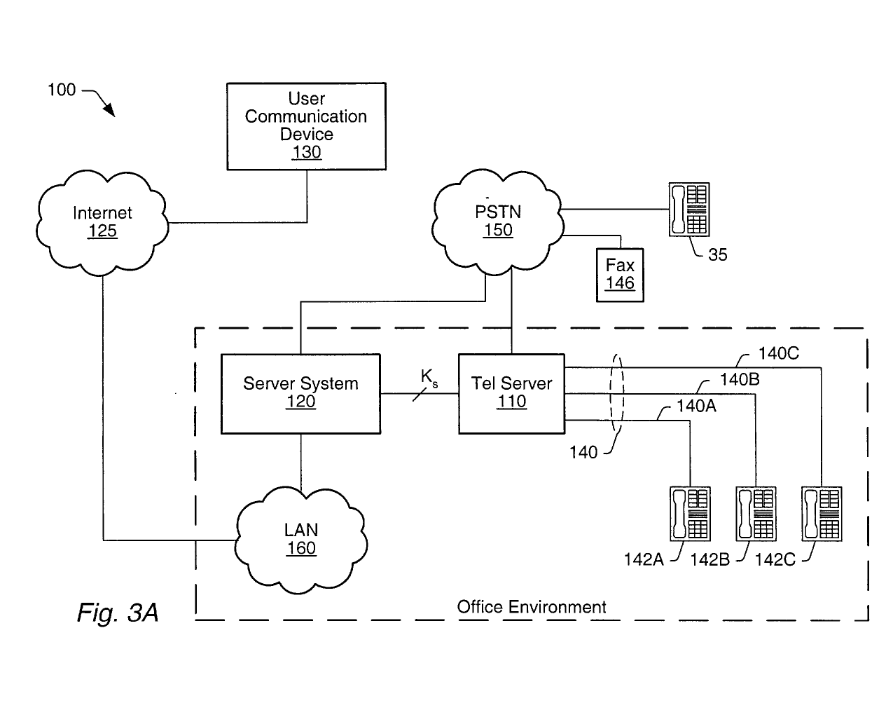

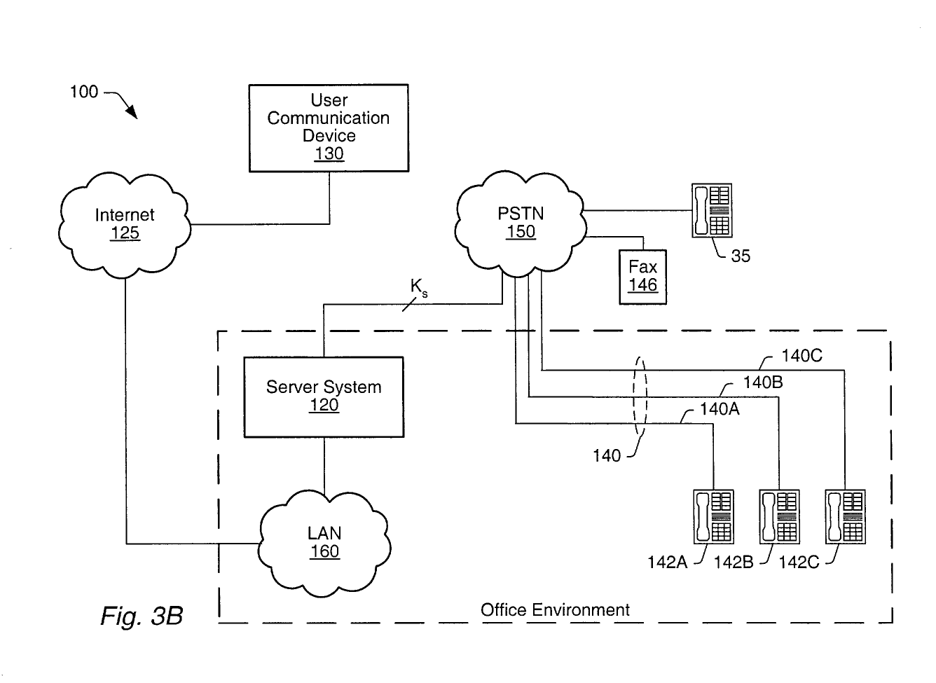

FIG. 3A depicts a communication system 100 which provides a remotely located user with access to at least a subset of the telephony functions supported by a telephony server 110 and/or the data services supported by local area network 160. Communication system 100 comprises a telephony server 110, a server system 120, a user communication device 130 and a local area network 160. Server system 120 is configured to provide access to telephony server 120 and local area network 160 for a number of remotely located users, i.e. users equipped with user communication devices such as user communication device 130.

Telephony server 110 couples to the PSTN 150 and to a plurality of office communication lines 140. Telephony server 110 provides a host of telephony services for office communication lines 140. Office phones such as phones 142A-C may be coupled to office communication lines 140. The three office communication lines 140A-C are intended to represent an arbitrary number of office communication lines. One of office communication lines 140, e.g. office line 140A, may serve as the user's dedicated office communication line. For example, office line 140A may be the user's office phone line.

Telephony server 110 may be a Private branch exchange (PBX). Telephony server 110 may be situated in an office environment as shown in FIG. 3A. Alternatively, office communication lines 140 may be supported by a PBX-like service such as Centrex (also referred to as Plexar, Comstar, etc.) provided by a local telephone company. In this alternative case, telephony server 110 may reside at the local telephone company as suggested by FIG. 3B. The local telephony company may be considered as part of the PSTN 150.

Server system 120 is configured for coupling to telephony server 110 through a number Kₛ of physical lines. Server system 120 also couples to local area network 160. Local area network 160 couples to the Internet 125 (generally through a firewall). Thus, server system 120 has access to the Internet 125 through local area network 160. User communication device 130 may be situated remotely from telephony server 110, local area network 160 and/or server system 120. For example, telephony server 110, server system 120 and local area network 160 may be located in an office environment while user communication device 130 is located at a remote site (e.g. user's home, hotel room, airport lobby, dormitory, etc.).

Telephony server 110 allocates a set S of telephone numbers to office communication lines 140. Each of communication lines 140 has an associated telephone number from the set S. For example, the user's office line 140A may be associated with a telephone number S₀. In an initial state, telephony server 110 directs any telephone calls addressed for the telephone number S₀ to the user's office line 140A. Thus, the telephone number S₀ is referred to herein as the user's office number. Telephony server 110 may be reprogrammed so that telephone calls addressed to the user's office number S₀ are redirected (i.e. forwarded) to a desired second telephone number. Telephony server 110 may perform such reprogramming in response to command signals received from server system 120.

As mentioned above, server system 120 couples to telephony server 110 through Kₛ physical lines. Telephony server 110 allocates Nₛ telephone numbers to the Kₛ physical lines. In the preferred embodiment, the number Nₛ of telephone numbers is greater than the number Kₛ of physical lines, and telephony server 110 manages the Nₛ telephone numbers as a hunt group with respect to the Kₛ physical lines. In an alternative embodiment, the number Nₛ of telephone numbers is equal to the number Kₛ of physical lines, and telephony server 110 allocates a unique telephone number to each of the physical lines.

User communication device 130 is configured to connect to server system 120 through the Internet 125. Thus, user communication device 130 and server system 120 may exchange data comprised within Internet Protocol (IP) packets. User communication device 130 may establish one or more IP-based connections to server system 120 through the Internet 125. In particular, user communication device 130 may establish (a) a telephony connection Cₜ to server system 120 in order to access telephony services provided by telephony server 110, and (b) a secure data connection Cᵥ to server system 120 in order to access data services provided by local area network 160.

Once the secure data connection CV has been established, user communication device 130 may transfer network data to server system 120 through the secure data connection Cᵥ. Server system 120 receives the network data, and transmits the network data onto local area network 160. In the reverse direction, server system 120 receives network data from local area network 160, and transmits the network data to user communication device 130 through the secure data connection Cᵥ.

In response to user communication device 130 establishing the telephony connection Cₜ to server system 120 through the Internet, server system 120 may automatically provide user communication device 130 with access to telephony server 110. When initiating the telephony connection Cₜ, user communication device 130 may transmit information which identifies and authenticates the remote user to server system 120. Server system 120 may use the identifying and authenticating information (e.g. user name, password, access code, etc.) to selectively grant access to telephony server 110 only to authorized users.

Server system 120 may maintain a database of identifying/authenticating information for each authorized user. A system administrator may enter the user's identifying/authenticating information and office number S₀ in the authorized user database prior to user communication device 130 establishing the telephony connection Cₜ for the first time. Server system 120 may use the identifying information to look up the user's office number S₀.

Server system 120 may automatically invoke a call forwarding operation so that subsequent telephone calls, intended to reach the user's office line 140A, are forwarded to server system 120. In the preferred embodiment, server system 120 commands telephony server 110 to redirect subsequent telephone calls addressing the user's office number S₀ to a second telephone number (i.e. one of the Nₛ telephone numbers associated with the Kₛ physical lines) associated with server system 120.

A voice correspondent (e.g. a coworker situated at office phone 142B or a PSTN correspondent situated at phone 35) desiring to converse with the user may call the user's office number S₀ expecting to be connected to the user's office phone 142A. However, telephony server 110 redirects (i.e. forwards) the telephone call to the second telephone number due to the call forwarding operation which has been previously invoked by server system 120.

When server system 120 receives a telephone call, which has been redirected (by telephony server 110) from the user's office number to the second telephone number, server system 120 forwards a first indication of the telephone call to user communication device 130 through the telephony connection Cₜ. As noted above, the telephone call may originate from a second line (e.g. line 140B) of office communication lines 140. Because telephony server 110 connects to the Public Switched Telephone Network (PSTN) 150, the telephone call may also originate from the PSTN 150.

If the remote user chooses to answer the telephone call, user communication device 130 transmits an answer indication to server system 120 through the telephony connection Cₜ. In response to receiving the answer indication from user communication device 130, server system 120 answers the telephone call with respect to telephony server 110. When telephony server 110 senses that server system 120 has answered the telephone call, telephony server 110 may transmit the correspondent's voice signal to server system 110. Server system 110 is configured to receive the correspondent's voice signal, and to transmit corresponding first voice data to user communication device 130 through the telephony connection Cₜ. User communication device 130 receives the first voice data and reconstructs the correspondent's voice signal for presentation to the remote user. In the reverse direction, user communication device 130 captures the user's voice, and transmits corresponding second voice data to server system 120 through the telephony connection Cₜ. Server system 120 receives the second voice data, reconstructs the user's voice signal from the second voice data, and transmits the user's voice signal to telephony server 110. Telephony server 110 transmits the users voice signal to the voice correspondent. Thus, user communication device 130 and server system 120 initiate a bi-directional exchange of voice data through the telephony connection Cₜ when the remote user answers the telephone call.

Local area network 160 comprises a system of interconnected computers. Local area network 160 may be situated in the same office environment with telephony server 110 and/or server system 120. By virtue of coupling to local area network 160, server system 120 may be considered part of local area network 160.

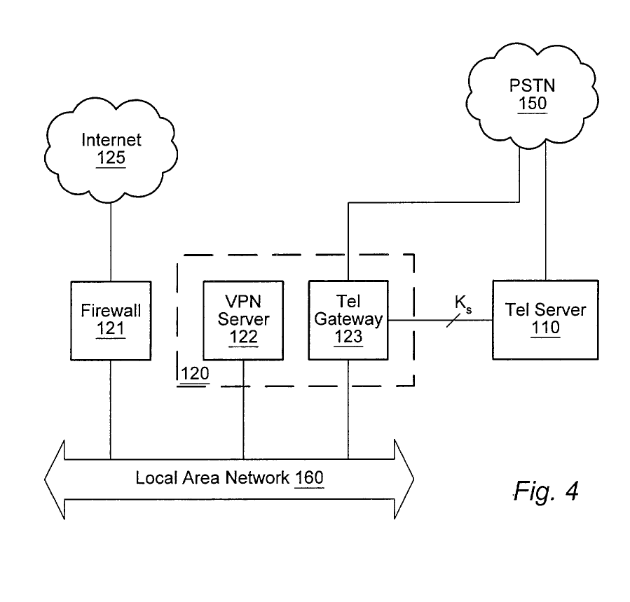

Server system 120 may include a virtual private network (VPN) server 122 and a telephony gateway 123 as shown in FIG. 4. VPN server 122 may be conventional VPN server product. VPN server 122 and telephony gateway 123 may reside on separate network computers (i.e. computers connected to local area network 160). Alternatively, VPN server 122 and telephony gateway 123 may reside on the same network computer.

Telephony gateway 123 is responsible for providing remote users with access to telephony server 110. Thus, the Kₛ physical lines from telephony server 110 couple to telephony gateway 123. Telephony gateway 123 may also support Kₚ physical lines which couple directly to the PSTN 150. User communication device 130 may establish the telephony connection Cₜ to telephony gateway 123 through the Internet 125. Thus, telephony gateway 123 invokes the call forwarding operation in response to user communication device 130 establishing the telephony connection Cₜ. User communication device 130 exchanges telephony data (i.e. voice and telephony control data) with telephony gateway 123 through the telephony connection Cₜ.

VPN server 122 is responsible for providing remote users with access to local area network 160 in a manner which guarantees the data security of local area network 160. User communication device 130 may establish the secure data connection Cᵥ to VPN server 122 through the Internet 125. Thus, the secure data connection is also referred to herein as the VPN connection Cᵥ. User communication device 130 may exchange data with LAN 160 through the VPN connection Cᵥ.

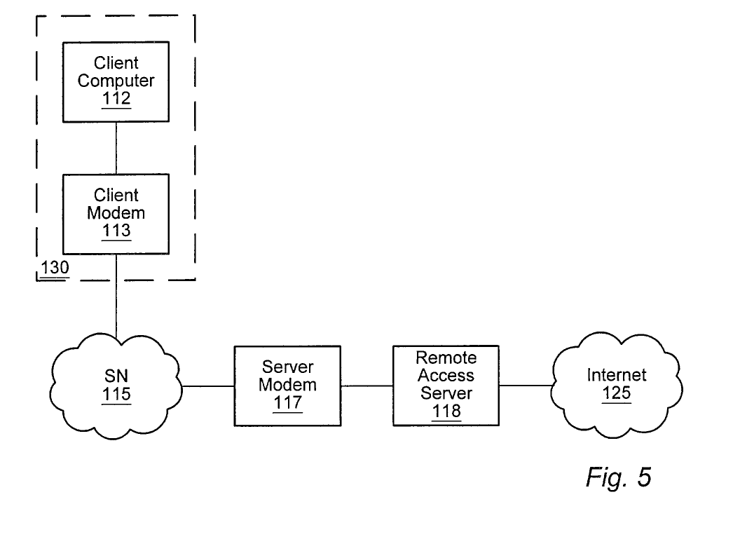

In the preferred embodiment, user communication device 130 comprises a remote client computer 112 coupled to a client modem 113 as shown in FIG. 5. Client computer 112 connects to a remote access server (RAS) 118 through a switching network 115 (such as the PSTN). Remote access server 118 provides the remote client computer 112 with connectivity to the Internet 125. Remote access server 118 may be a conventional remote access server system. Remote access server 118 may belong to an Internet service provider. Alternatively, remote access server 118 may belong to a branch office of the same organization which controls/maintains the office environment of FIG. 3.

Client computer 112 uses the Internet connectivity provided by RAS 118 to establish the telephony connection Cₜ and secure data connection CV to server system 120 in the office environment. Telephony data and network data flow from the client computer 112 to server system 120 through modem 113, switching network 115, server modem 117, RAS 118, Internet 125, office firewall 121 and local area network 160. Similarly, telephony data and network data flow from server system 120 to client computer 112 by the reverse sequence of entities.

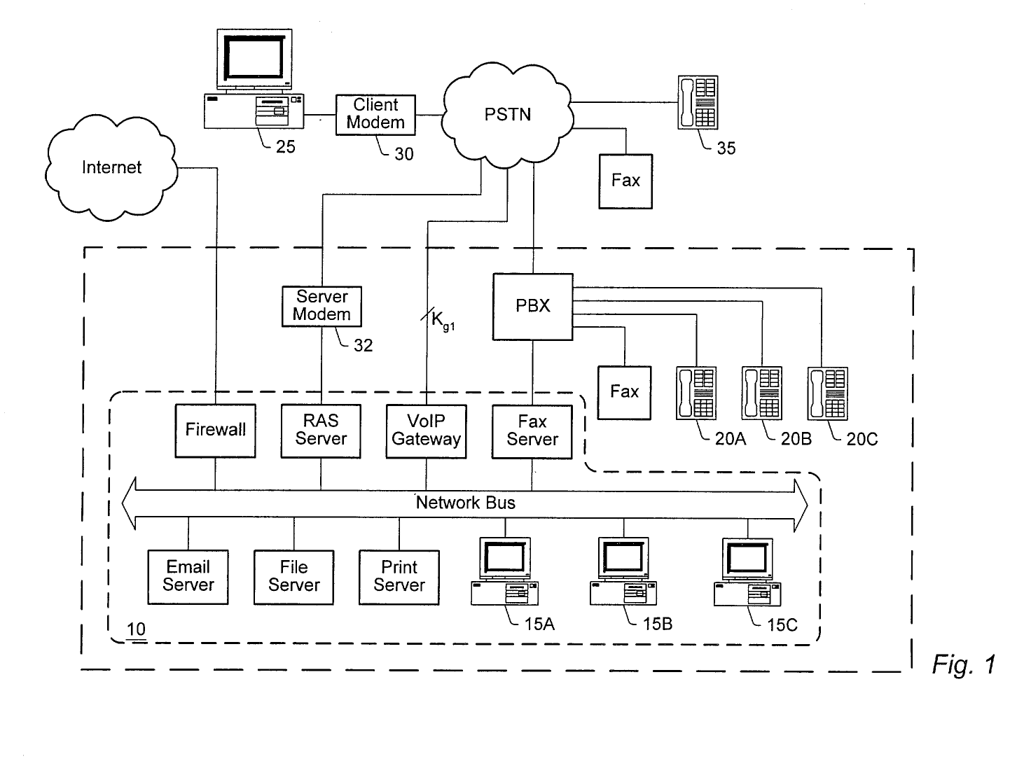

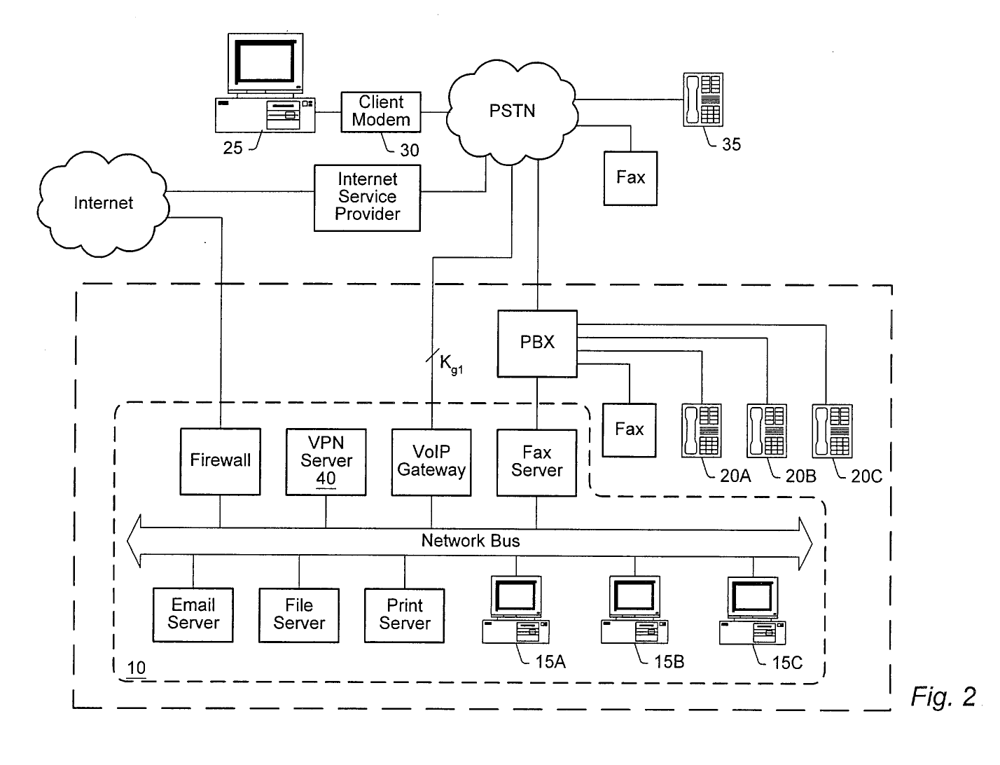

Because of the rapid and global proliferation of the Internet in recent years, the remote user (equipped with client computer 112 and modem 113) may connect to the Internet 125 through a remote access server such as RAS 118 from almost anywhere in the world. Furthermore, it is likely that there are one or more remote access servers such as RAS 118 within the geographical vicinity of the remote user (i.e. client computer 112). For example, in every major metropolitan city in the world, there may be a variety of Internet service providers. Thus, the remote user may be able to connect to remote access server 118 through switching network 115 without incurring long distance charges for the use of switching network 115 (e.g. the PSTN). In particular, the remote user avoids the exorbitant cost (i.e. long-distance phone charges) of attempting to connect to a remote access server in the office environment through the PSTN from a remote location as shown in FIG. 1.

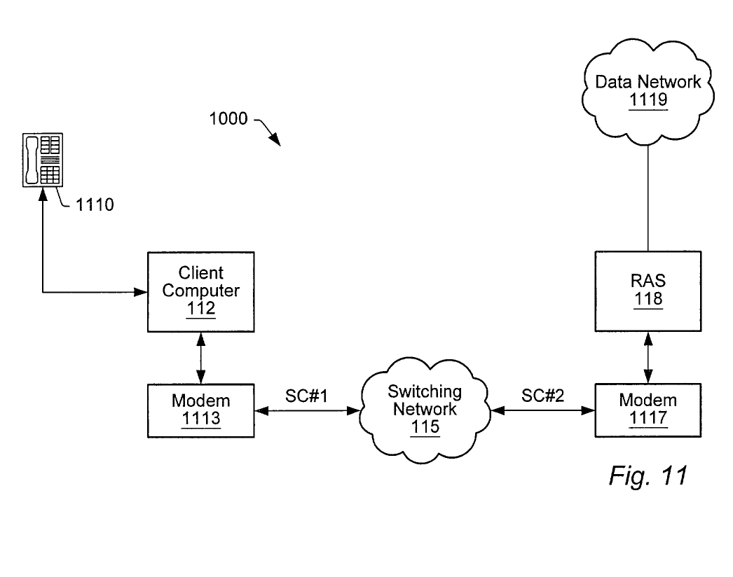

Client modem 113 provides an interface to switching network 115 for client computer 112. Remote access server 118 is configured to support a number of remote clients, and thus, couples to a bank of server modems of which server modem 117 is a representative. Server modem 117 couples to switching network 115. The term modem is used broadly herein to refer to any type of communication device including devices such as analog (e.g. POTS) modems, Integrated Services Digital Network (ISDN) modems, Digital Subscriber Line (DSL) modems, cable modems, wireless modems, etc. Thus, modem 113 and switching network 115 may provide a high bandwidth connection to RAS 118 as, e.g., in the case where modem 113 is a cable modem and switching network 115 is the cable network. Alternatively, modem 113 and switching network may provide a low-bandwidth connection to RAS 118 as, e.g., in the case where switching network is the PSTN, and modem 113 couples to the PSTN through an analog telephone line. A wide spectrum of connection bandwidths is contemplated. Modem-to-modem based system 1000 and hybrid modem-server system 2000 described below in conjunction with FIGS. 11-15 and FIGS. 16-26 respectively especially address the low-bandwidth cases.

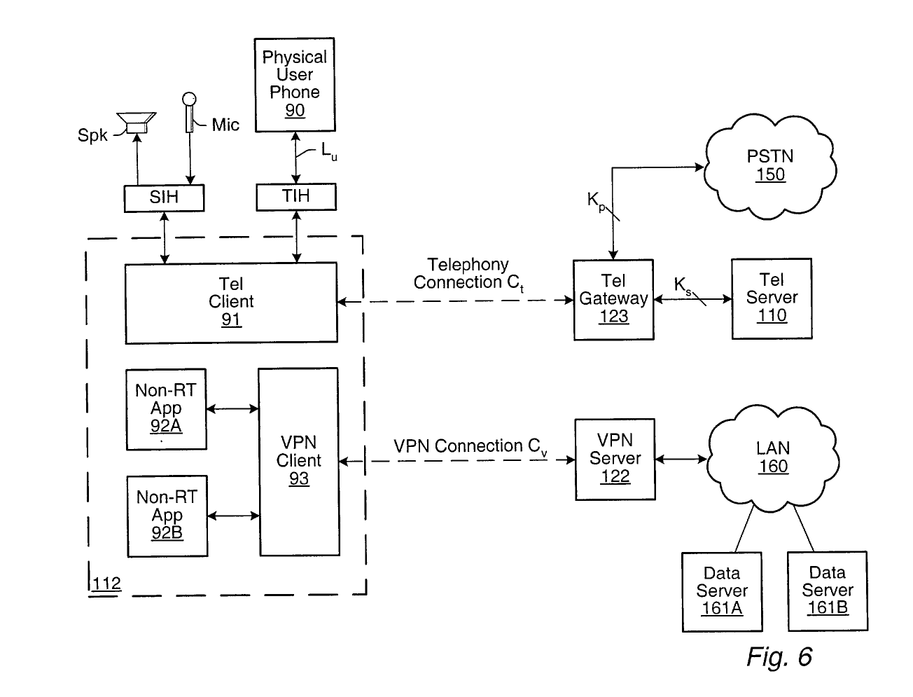

A telephony client application 91 running on remote client computer 112 establishes the telephony connection Cₜ to telephony gateway 123 as shown in FIG. 6. Telephony client application 91 may automatically establish the telephony connection Cₜ when the remote user invokes (i.e. executes) telephony client application 91.

A VPN client application 93 also running on client computer 112 establishes the VPN connection CV to VPN server 122. VPN server 122 may provide the remote client computer 112 with access to local area network 160 as if the remote client computer were an internal node of the local area network 160.

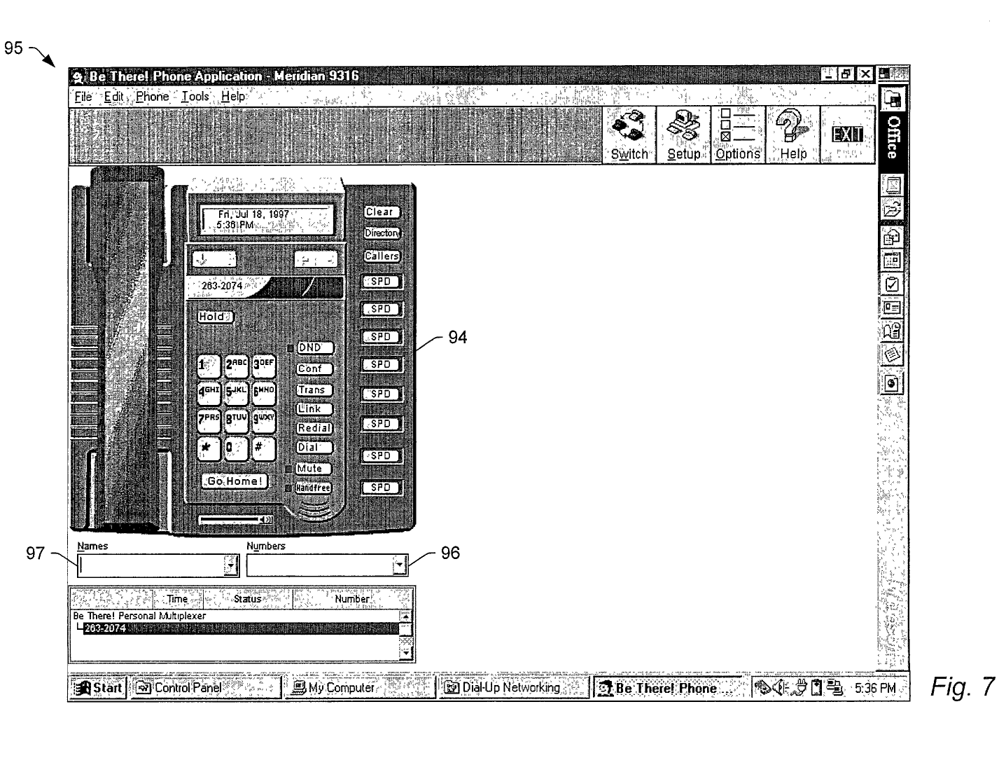

It is noted that telephony client application 91 and VPN client application 93 may be integrated into a virtual presence client application. When a user invokes the virtual presence client application, the virtual presence client application may automatically establish the telephony connection Cₜ to telephony gateway 123 and the VPN connection Cᵥ to the VPN server 122. When the telephony connection Cₜ and the VPN connection CV have been established, the remote user is said to be “virtually present” in the office environment, and a virtual presence session is said to be in force. The virtual presence application may generate an application window 95 for display on the screen of client computer 112 as shown in FIG. 7. Using the icons and controls provided by application window 95, the remote user may invoke or modify various properties of a virtual presence session.

Once the VPN connection CV has been established, non-real-time applications running on client computer 112 may send/receive data to/from local area network 160 through the VPN connection CV. (Non-real-time applications include applications such as email clients and web browsers which tolerate delays in packet transfer, i.e. which operate acceptably even when packets are delayed in their delivery from source to destination.) For example, non-real-time application 92A may generate first data packets addressed for data server 161A on local area network 160. Non-real-time application 92A supplies the first data packets to VPN client 93. VPN client 93 transmits the first data packets to VPN server 122 through the VPN connection Cᵥ. VPN server 122 receives the first data packets, and transmits the first data packets onto local area network 160. Normal IP routing mechanisms are responsible for directing the first data packets to data server 161A through local area network 160.

Data server 161A receives the first data packets, and responsively generates second data packets addressed for non-real-time application 92A. Data server 161A transmits the second data packets onto local area network 160. Again, normal IP routing mechanisms are responsible for sending the second data packets back to VPN server 122 through local area network 160. VPN server 122 receives the second data packets from local area network 160, and transmits the second data packets to VPN client 93 through the VPN connection Cᵥ. VPN client 93 forwards the second data packets to non-real-time application 92A.

In addition, a plurality of non-real-time applications may use the VPN connection Cᵥ to communicate with a plurality of data servers on local area network 160. For example, non-real-time application 92B may exchange data packets with data server 161B through the VPN connection Cᵥ. Non-real-time applications 92A and 92B are intended to represent an arbitrary number of non-real-time applications, and are collectively referred to herein as non-real-time applications 92. Similarly, data servers 161A and 161B are intended to represent an arbitrary number of data servers, and are collectively referred to herein as data servers 161. The data packets exchanged by the non-real-time applications 92 and data servers 161 will be referred to herein as “network data”.

Because local area network 160 couples to the Internet 125, non-real-time applications 92 may access arbitrary locations on the Internet 125. In other words, non-real-time applications 92 may exchange data with data servers residing on the Internet 125 using the VPN connection Cᵥ and the Internet connectivity provided by local area network 160.

Client computer 112 may couple to telephony interface hardware TIH. Telephony interface hardware TIH may couple to a physical user phone 90 through a physical telephone line Lᵤ. The remote user may (a) manipulate the handset and controls (e.g. buttons) of physical user phone 90, (b) speak into a microphone embedded in the handset (or body) of physical user phone 90, and/or (c) listen to a speaker embedded in the handset (or body) of physical user phone 90.

Physical user phone 90 may transmit a telephone signal to telephony interface hardware TIH in response to the voice/control stimuli provided by the remote user. Telephony interface hardware TIH receives the telephone signal generated by physical user phone 90, and translates any control events (e.g. off-hook event, hook-flash event, numeric digit selection, etc.) expressed by the telephone signal into corresponding control messages. Furthermore, telephony interface hardware TIH digitizes the telephone signal when the remote user is speaking, and encodes the digitized voice stream according to a vocoder protocol such as G.729. Telephony interface hardware TIH sends the encoded voice data and control messages to telephony client 91. (In one alternate embodiment, encoding of the digital voice stream may be performed by telephony client 91.)

Telephony client 91 embeds the encoded voice data and control messages into a first stream of telephony packets (e.g. RTP packets) addressed for telephony gateway 123. Telephony client 91 transmits the first stream of telephony packets to telephony gateway 123 through the telephony connection Cₜ. Telephony gateway 123 receives the first stream of telephony packets transmitted from telephony client 91, and recovers the encoded voice data and control messages which are embedded in the first stream. Telephony gateway 123 regenerates the user's voice signal from the encoded voice data and transmits the user's voice signal to telephony server 110 through one of the Kₛ physical lines which is handling the current telephone call. Let L₀ denote this particular physical line. Telephony gateway 123 also interprets the control messages, and transmits corresponding control events to telephony server 110 through the physical line L₀. Telephony server 110 transmits the user's voice signal to the voice correspondent (e.g. a coworker situated at phone 142B or a PSTN correspondent situated at phone 35).

In the reverse direction, telephony server 110 transmits the correspondent's voice signal to telephony gateway 123 through the physical line L₀. Telephony gateway 123 receives the correspondent's voice signal from the physical line L₀, digitizes the correspondent's voice signal, and encodes the resulting digital voice stream. Telephony gateway 123 also translates any control events asserted by telephony server 110 on physical line L₀ into corresponding control messages. Telephony gateway 123 embeds the encoded voice data and control messages into a second stream of telephony packets. 4 Telephony gateway 123 transmits the second stream of telephony packets to telephony client 91 through the telephony connection Cₜ. Telephony client 91 recovers the encoded voice data and control messages embedded in the second stream of telephony packets. Telephony client 91 sends the encoded voice data and control messages to telephony interface hardware TIH. Telephony interface hardware TIH regenerates the correspondent's voice signal from the encoded voice data, and transmits the correspondent's voice signal to the physical user phone 90. Furthermore, telephony interface hardware TIH drives the physical line L, with control events which correspond to control messages received from telephony client 91. Physical user phone 90 provides the correspondent's voice signal to an embedded speaker. In addition, physical user phone 90 may drive various embedded output devices (e.g. indicator lights, display, speaker, bell clapper) with signals corresponding to the control events received from physical line Lᵤ. For example, in response to ring event asserted by telephony interface hardware TIH, physical user phone 90 may drive an embedded speaker with a ring signal.

Telephony gateway 123 includes interface hardware (not shown) for interfacing with telephony server 110. The Kₛ physical lines supplied by telephony server 110 couple to the interface hardware. The interface hardware may handle A/D conversion, D/A conversion, voicing encoding and decoding, and the bi-directional translation between telephony control events (which flow to/from telephony server 110) and control messages.

In the preferred embodiment, telephony client 91 supports a virtual phone 94, i.e. a graphical user interface which emulates the behavior of a telephone, as shown in FIG. 7. Telephony client 91 may display virtual phone 94 in the application window 95. The remote user may manipulate the controls of virtual phone 94 using the mouse and/or keyboard of client computer 112 to elicit various telephony control events. For example, the remote user may initiate a telephone call to a voice correspondent (e.g. an office mate at office line 142B or an external party at PSTN phone 35) using virtual phone 94. In order to dial the digits of a phone number to be called, the remote user may use the mouse to select digits on the virtual keypad of virtual phone 94. In addition, the remote user may (a) type a phone number into a number entry field 96 displayed on or near the virtual phone 94; (b) type the name of the person to be called in a name entry field 97; (c) select a phone number from a displayed call list or phone book (not shown); etc.

Virtual phone 94 may be configured to emulate any of a variety of standard models of office telephones or telephony devices. For example, the remote user may configure virtual phone 94 to resemble his/her office phone 142A for ease of use. Alternatively, the remote user may configure to the virtual phone to provide different and/or more advanced features than his/her office telephone 142A.

Telephony client 91 monitors the controls of virtual phone 94. In response to the remote user's manipulation of the controls, telephony client 91 generates corresponding control messages (which will be transmitted to telephony gateway 123). For example, in response to the user's selection of a “call conference” button of virtual phone 94, telephony client 94 generates a corresponding “call conference” message.

Client computer 112 may couple to sound interface hardware SIH (such as a sound card). Sound interface hardware SIH couples to a speaker SPK and/or microphone MIC. Sound interface hardware SIH receives the remote user's voice signal from speaker SPK, digitizes the remote user's voice signal, and encodes the resulting digital voice stream. Sound interface hardware SIH sends the encoded voice data to telephony client 91. (In an alternative embodiment, telephony client 91 performs the voice encoding.) Telephony client 91 receives the encoded voice data, and embeds the encoded voice data along with any control messages into a stream of telephony packets. The stream of telephony packets is transmitted to telephony gateway 123 through the telephony connection Cₜ. Telephony gateway 123 treats the stream of telephony packets in the same way as in the case above, where physical user phone 90 sources the voice and/control information.

As described above, telephony client 91 receives the second stream of telephony packets transmitted by telephony gateway 123. Telephony client 91 recovers encoded voice data and control messages embedded in the second stream. Telephony client 91 may send the encoded voice data to sound interface hardware SIH. Sound interface hardware SIH recovers the correspondent's voice signal from the encoded voice data, and presents the correspondent's voice signal to speaker SPK. In addition, telephony client 91 may translate the control messages into corresponding output events which are asserted through virtual phone 94 and/or sound interface hardware SIH. For example, in response to a “voice mail” control message, telephony client 91 may “light” a voice mail indicator on virtual phone 94. In response to a ring message, telephony client may command sound interface hardware SIH to present a ring signal to speaker SPK.

In one embodiment, telephony client 91 is configured to support physical user phone 90 and virtual phone 94 in parallel. When the distinction between physical user phone 90 and virtual phone 94 is not material to the discussion at hand, the term “remote phone” may be used herein to refer to either or both of these phones.

Telephony gateway 123 may exchange telephony data with telephony client 91 through the telephony connection Cₜ, while VPN server 122 exchanges network data with VPN client 93 through the VPN connection Cᵥ. In other words, both connections may be active at the same time.

Telephony server 110 is configured to provide a first set of telephony functions to the user's office line 140A, i.e. to the user's office phone 142A. As described above, telephony client 91 and telephony gateway 123 are configured to support a telephony control interface between the remote phone and telephony server 110 through the telephony connection Cₜ. The telephony control interface extends to the remote phone at least a subset of the first set of telephony functions. In other words, the remote user manipulates the remote phone, and thereby, enjoys at least a subset of the first set of telephony functions. In one embodiment, the telephony control interface extends to the remote phone all of the functions comprising the first set, and the remote phone operates as if it were directly connected to telephony server 110.

The subset of telephony functions supported by the telephony interface may include extension dialing. Typically, a person physically located in the office environment dials a local extension number or direct inward dialing (DID) number to call an office mate at one of office phones 142. The local extension number is generally an N-digit abbreviation of the corresponding full telephone number. On the remote phone, the remote user may dial the local extension number of an office mate in the office environment, e.g. the local extension number of office phone 142B, and be transparently connected to the office mate. Similarly, an office mate in the office environment may dial the local extension of the user's office phone 142A, and be transparently connected to the remote user at the remote phone.

As discussed above, telephone calls addressed to the user's office phone 142A (i.e. the user's office number S₀) are redirected to telephony gateway 123, and telephony gateway 123 forwards such telephone calls to the user's remote phone through the telephony connection Cₜ. In addition, the remote user may initiate outgoing calls using the remote phone. The remote user may initiate a telephone call in a variety of ways as described above. For example, the remote user may pick up the handset of physical user phone 90 and enter the telephone number to be called on the numeric keypad of physical user phone 90. In response to the telephone number entered (or indicated) by the remote user, telephony client 91 transmits the telephone number, embedded in telephony packets, to telephony gateway 123 through the telephony connection Cₜ. (The telephone number may be presented to telephony client 91 as a stream of control messages and/or as a stream of encoded audio data, i.e. encoded DTMF tones.) Telephony gateway 123 initiates a telephone call addressing the given telephone number using the resources of telephony server 110. For example, telephony gateway 123 may generate an off-hook condition and transmit DTMF tones (corresponding to the given telephone number) on a selected one of Kₛ physical lines coupling to telephony server 110. Let L₁ denote the selected physical line. It is noted that telephony gateway 123 may also be coupled directly to the PSTN 150. In this case, telephony gateway 123 may initiate a call out to the PSTN 150 without going through telephony server 110.

When a voice correspondent (e.g. an office mate situated at office phone 142B or a PSTN correspondent situated at PSTN phone 35) answers the telephone call, telephony gateway 123 and telephony client 91 engage in a bi-directional exchange of telephony packets through telephony connection Cₜ which supports the ensuing voice conversation as described above.

As alluded to above, telephony gateway 123 may couple to telephony server 110 through Kₛ physical lines. Telephony server 110 may allocate a significantly larger number Nₛ of telephone numbers to the Kₛ physical lines. Telephony server 110 may manage the Kₛ physical lines as a hunt group with respect to the Nₛ telephone numbers. In other words, telephony server 110 is programmed so that any telephone call directed to one of the Nₛ telephone numbers is mapped onto an available one of the Kₛ physical lines. A physical line is said to be available if it is not currently handling a telephone call. Thus, the Kₛ physical lines can support up to Kₛ simultaneous telephone conversations.

Because telephony server 110 dynamically maps calls directed for the Nₛ telephone numbers to the Kₛ physical lines on the basis of availability, any of the Nₛ telephone numbers may be mapped to any one of the Kₛ physical lines. Thus, when telephony server 110 asserts a telephone call directed for telephone number X onto physical line Y, an indication of the telephone number X is embedded in the analog (or digital) telephone signal which is transmitted onto physical line Y. When telephony gateway 123 receives the telephone call on physical line Y, it recovers the embedded telephone number X from the telephone signal.

Telephony gateway 123 also manages the Kₛ physical lines as a shared resource among a plurality of remote telephony clients of which telephony client 91 is a representative. When telephony client 91 establishes the telephony connection Cₜ to telephony gateway 123, telephony gateway 123 may assign an available one of the Nₛ telephone numbers to telephony client 91. A telephone number is said to be available if it is not currently assigned to any remote telephony client. Let X₀ denote the telephone number (of the Nₛ telephone numbers) which has been assigned to telephony client 91. Based on the identifying information transmitted by telephony client 91 during the connection negotiations, telephony gateway 123 looks up the user's office phone number S₀, and commands telephony server 110 to forward the user's phone number S₀ to the assigned phone number X₀. Telephony gateway 123 records the IP address of client computer 112, the remote user's office number S₀, and the assigned telephone number X₀ in a database of connected telephony clients.

Telephony gateway 123 may receive a telephone call targeted for assigned telephone number X₀ on an arbitrary line Y of the Kₛ physical lines. Note that the telephone call may have been redirected by telephony server 110 from the user's office phone number S₀ to the assigned telephone number X₀. Telephony gateway 123 decodes the telephone number X₀ embedded in the telephone signal conveyed on line Y. Telephony gateway 123 looks up the IP address of client computer 112 based on the decoded telephone number X₀ in the database of connected telephony clients. Telephony gateway 123 uses the IP address to transmit subsequent telephony packets (i.e. voice and/or control data) to telephony client 91 through the telephony connection Cₜ.

As described above, telephony gateway 123 commands telephony server 110 to forward the user's office phone number S₀ to the assigned phone number X₀ when telephony client 91 establishes the telephony connection Cₜ to telephony gateway 123. In the preferred embodiment, telephony server 123 measures the amount of time elapsed from the last telephony packet received from telephony client 91 through the telephony connection Cₜ. If this elapsed time exceeds a predefined timeout value, telephony gateway 123 automatically cancels the call forwarding operation, i.e. commands telephony server 110 to undo the call forwarding operation with respect to the user's office number S₀, and telephony client 91 may be removed from the list of connected telephony clients. Thus, the telephone number X₀ which has been allocated to telephony client 91 is liberated for allocation to other remote user's. If the telephony connection Cₜ is unintentionally disrupted for any reason (e.g. a crash of one of the servers/routers carrying the telephony connection Cₜ), the user's office number S₀ will not remain indefinitely in the forwarded state.

In order to prevent termination of the telephony connection Cₜ, telephony client 91 may periodically (or intermittently) transmit “keep alive” messages to telephony gateway 123 when it does not have voice or ordinary telephony control data to transmit. For example, when the remote user is not using the remote phone, voice and ordinary telephony control data may not be generated.

It is noted that telephony gateway 123 allocates one of the Nₛ telephone numbers to telephony client 91 when telephony client 91 establishes the telephony connection Cₜ. However, the remote user may spend only a fraction of the time during a virtual presence session actually engaging in telephony activity through telephony server 110. Telephony client 91 consumes (or occupies) one of the Kₛ physical lines only when the remote user is (a) receiving an in-coming telephone call, (b) initiating an out-going telephone call, or (c) engaging in a telephone conversation already established through telephony server 110.

Thus, the Kₛ physical lines may be shared among the currently connected telephony clients. The number N, of telephone numbers may be chosen based on the maximum expected number of simultaneously connected telephony clients. The number Kₛ of physical lines may be based on the maximum number of telephony clients who are expected to be simultaneously engaging in telephony activity (placing calls, receiving call, or actually conversing) through telephony gateway 123.

In one embodiment, telephony gateway 123 is configured to maintain a log file. The log file maintains records concerning each outgoing call initiated by remote users. The log file may be used for billing purposes.

As described above, telephony client 91 embeds control messages and audio data into telephony packets (e.g. RTP packets), and transmits the telephony packets to telephony gateway 123 through the telephony connection Cₜ. The audio data may include encoded voice data, encoded DTMF tones, etc. Similarly, telephony gateway 123 embeds control messages and audio data into a second stream of telephony packets, and transmits the second stream to telephony client 91 through the telephony connection Cₜ.

In general, control messages (e.g. hook flash message, off hook message, etc.) are of such a nature that they need to be transferred reliably (i.e. with guaranteed fidelity) from source to destination. In contrast, the transfer of audio data requires timeliness instead of reliability. The intelligibility of a telephone conversation is not significantly degraded by the intermittent loss of audio data frames due to errors in transmission. However, it is important that audio data be transferred with minimum latency (i.e. with minimum time-delay between the source and destination). Thus, telephony client 91 and telephony gateway 123 exchange telephony packets according to a telephony transfer protocol which satisfies the fundamental transfer constraints presented by the control messages and the audio data.

A telephony packet may include a control indicator bit CIO in its header indicating whether or not it contains a control message, i.e. a sequence of control data. If the control bit CIO is set, the telephony packet may include a control header field CH and a control message. The control message may be injected before any audio data in the telephony packet. The control header field may precede the control message, and may specify properties of the control message. For example, the control header field CH preferably includes a control length field CL to indicate the length of the control message. In one alternative embodiment, the control message may have an invariant length. Thus, control length field CL or control header field CH may not be included in the alternative embodiment.

To ensure reliable transmission of the control message, a telephony transceiver (e.g. telephony client 91 or telephony gateway 123) may retransmit the control message in successive telephony packets until the telephony transceiver receives an acknowledgement of the control message from the complementary telephony transceiver, i.e. the telephony transceiver at the other end. Thus, the control header CH may also include a control sequence number CS for indicating whether the control message is being retransmitted or transmitted for the first time. Preferably, the control sequence number CS is a one bit field that is simply toggled when a new control message is transmitted. Furthermore, the telephony transceiver may compute a cyclic redundancy checksum (CRC) value for the telephony packet, and embed the CRC value in the telephony packet.

The telephony packet header may also include a control acknowledge field CA, preferably a one bit field, for acknowledging a successfully received control message from the other end. In other words, telephony transceiver A continues to retransmit a given control message in successive telephony packets to telephony transceiver B until A receives from B a telephony packet with the control acknowledge field CA set. After successful acknowledgement of a first control message, telephony transceiver A may transmit a second control message. If audio data is not available for transmission, telephony packets containing only control messages may be transmitted on a periodic (or pseudo-periodic) basis.

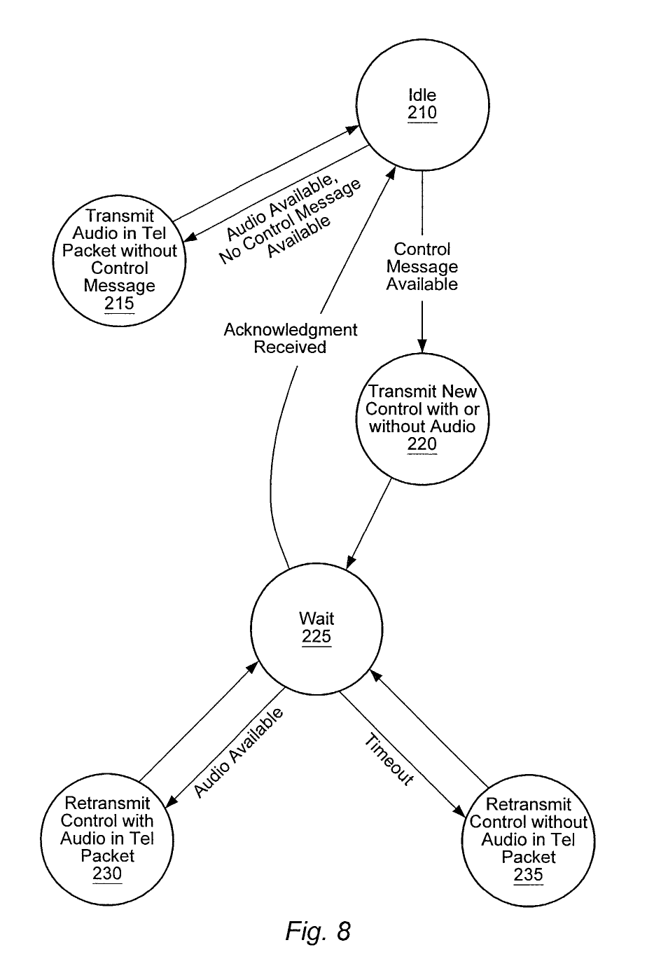

FIG. 8 illustrates the transmission side of the telephony transfer protocol according to one embodiment. A telephony transceiver may initially reside in idle state 210. The telephony transceiver may remain in idle state 210 until audio data and/or a control message becomes available for transfer. For example, the telephony transceiver may include an audio buffer and a control message buffer. Audio data to be transmitted may be stored in the audio buffer, and control messages to be transmitted may be stored in the control message buffer. The telephony transceiver may monitor the empty/nonempty status of the buffers to determine if audio data and/or control message(s) are available for transfer. If audio data is available for transfer, and there are no control messages available for transfer, the telephony transceiver may move to state 215. In state 215, the telephony transceiver may compose and transmit a telephony packet containing audio data without any control message data. After transmitting the telephony packet, the telephony transceiver may return to idle state 210.

From idle state 210, the telephony transceiver may move to state 220 if a control message is available for transfer. In state 220, the telephony transceiver reads a control message from the control buffer, and generates a telephony packet including the control message. The telephony transceiver sets the control sequence bit CS to indicate that this telephony packet contains a new control message (i.e. the control message that has not previously been transmitted). The telephony transceiver may also embed one or more audio data frames in the current telephony packet if such frames are available for transmission. After transmitting the current telephony packet, the telephony transceiver may move to state 225.

In state 225, the telephony transceiver waits to receive a telephony packet containing a control message acknowledgement (i.e. a telephony packet whose control acknowledge bit CA is set) from the complementary telephony transceiver at the other end of telephony connection Cₜ. When the acknowledgement is received, the telephony transceiver may move to idle state 210.

If audio data becomes available for transfer during wait state 225, the telephony transceiver may move to state 230. In state 230, the telephony transceiver may generate a telephony packet containing: one or more available audio data frames from the audio buffer, and the same control message that was transmitted in state 220. The telephony transmitter may set the control sequence bit CS to indicate that the current telephony packet contains an old control message (i.e. a control message which has already been transmitted at least once). After transmitting the current telephony packet, the telephony transceiver may return to wait state 225.

In wait state 225, the telephony transceiver may maintain a timer which measures the amount of time since the last transmission of a telephony packet. (The telephony transceiver may initialize this time value to zero upon entering wait state 225 from any other state.) If this elapsed time exceeds a predetermined limit, the telephony transceiver may move to state 235. In state 235, the telephony transceiver may generate a telephony packet containing the same control message that was transmitted in state 220 and not containing any audio data. The telephony transmitter may set the control sequence bit CS to indicate that the current telephony packet contains an old control message. After transmitting the current telephony packet, the telephony transceiver may return to state 225.

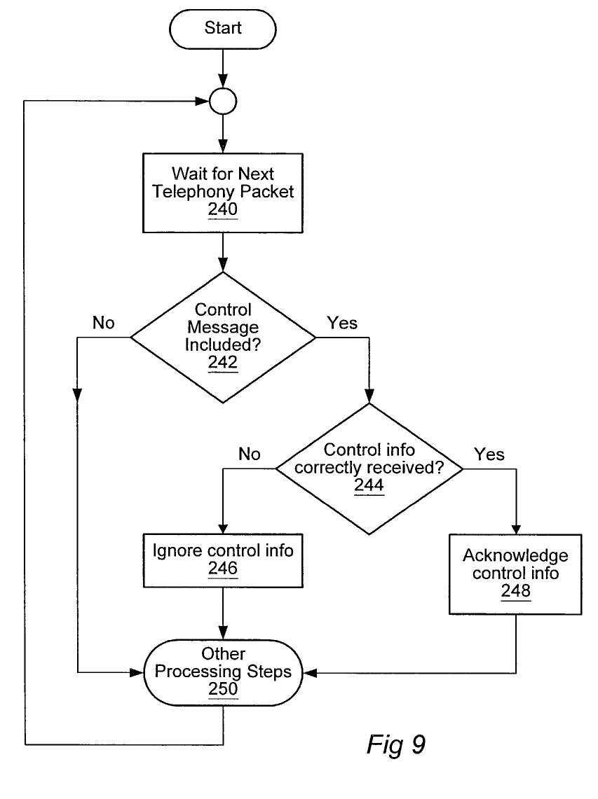

As described above, a telephony transceiver repeatedly transmits a control message in successive telephony packets until an acknowledgement is received. Thus, the telephony transfer protocol includes a mechanism for acknowledging the correct reception of control messages. FIG. 9 illustrates one embodiment of such as mechanism. In step 240, a telephony transceiver may wait to receive a telephony packet. In response to receiving a telephony packet, the telephony transceiver may perform step 242. In step 242, the telephony transceiver may examine the control indicator bit CIO of the telephony packet to determine if the telephony packet contains a control message. If the telephony packet does not contain a control message, the telephony transceiver may perform additional processing steps 250 (e.g. the telephony transceiver may recover any audio data embedded in the telephony packet, and may process the audio data).

If the examination of step 242 indicates that the telephony packet contains a control message, the telephony transceiver may perform step 244. In step 244, the telephony transceiver recovers the control message from the telephony packet, and determines if the control message has been correctly received. For example, the telephony transceiver may compute a cyclic redundancy checksum (CRC) for the received telephony packet, and compare the computed CRC with the value of the CRC field of the telephony packet. If the control message has not been received correctly then the control message may be ignored as indicated in step 246. After step 246, the telephony transceiver may perform additional processing steps 246.

If the control message has been received correctly, the telephony transceiver will acknowledge the control message, as indicated in step 248. The telephony transceiver may acknowledge the control message by transmitting a telephony packet TP to the complementary telephony transceiver (i.e. the device that originated the control message). The telephony transceiver may set a control acknowledgement field CA in the header of the telephony packet TP to indicate that the telephony packet TP includes a control message acknowledgement. After step 248, the telephony transceiver may perform additional processing steps 250. As described above in regard to FIG. 8, the complimentary telephony transceiver will continue to retransmit the control message until this acknowledgement is received. In this manner, reliable transfer of control messages may be achieved.

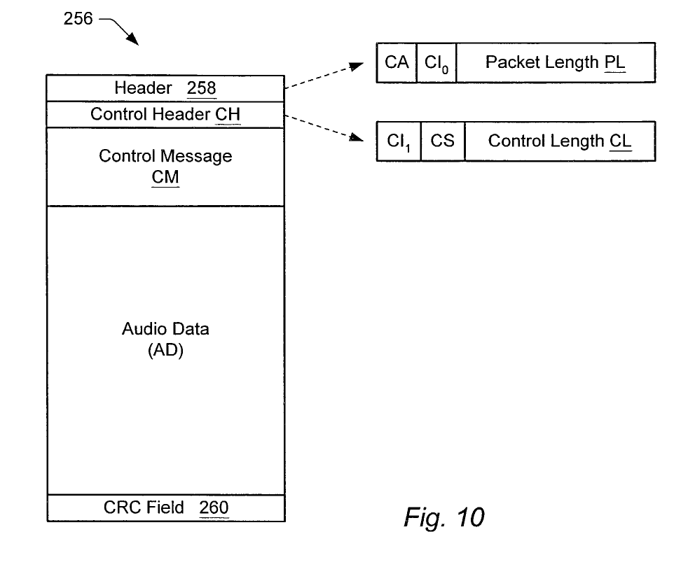

FIG. 10 illustrates one possible format for the encapsulation of audio data and control message data in a generic telephony packet 256 (e.g. an RTP packet). However, it is noted that any format consistent with the above disclosed telephony transfer protocol may be utilized. The exact formatting of bits in generic telephony packet 256 is not critical. Telephony packet 256 may begin with a header 258. For example, telephony packet 256 may be a real-time transfer protocol (RTP) packet, in which case header 258 comprises an RTP packet header. Header 258 may include a control acknowledgement field CA, a control indicator field CIO, and a packet length field PL. Control acknowledgment field CA is used to acknowledge correct reception of a control message as described above. Control indicator field CIO indicates whether or not telephony packet 256 contains control information. Packet length field PL may be used to indicate the length of telephony packet 256. Alternatively, the length of telephony packets may be predetermined between the transmitting and receiving devices.

As described above, control indicator field CI₀ indicates whether or not telephony packet 256 contains control information. Control information comprises a control header field CH and a control message field CM. Control header field CH may include an additional control indicator field CI₁, a control sequence field CS, and a control length field CL. Control indicator field CI₁ may be used to indicate if further control information is present. Control sequence field CS indicates whether the control message residing in control message field CM is newly transmitted or retransmitted. Control length field CL in the control header CH may be used to indicate the length of the control information. Control message field CM may follow control header field CH. Control message field CM may contain one or more control messages.

Telephony packet 256 may also include an audio data field AD for storing audio data. The audio data may correspond to encoded voice data, encoded DTMF tones, etc. Telephony packet 256 may conclude with an error check field 260. A cyclic redundancy checksum may be stored into error check field 260 by a telephony packet transmitter.

As indicated in FIG. 10, telephony packet 256 may include both control information and audio data. Alternatively, telephony packet 256 may include only control information or only audio data.

FIG. 11 depicts a modem-to-modem based system 1000 for expediting the transfer of real-time data (e.g. voice data and telephony control data) relative to non-real-time data through switching network 115. Switching network 115 may be the Public Switched Telephone Network (PSTN). Modem-to-modem based system 1000 operates under the assumption that the remote user, equipped with client computer 112, desires to simultaneously transfer real-time data and non-real-time data to/from data network 1119, and is constrained to connect to data network 1119 through switching network 115. Modem-to-modem based system 1000 includes a pair of modems, i.e. a client modem 1113 coupled to client computer 112, and a server modem 1117 coupled to remote access server 118. Client modem 1113 and server modem 1117 transfer real-time data and non-real-time across switching network 115 according to a protocol which prioritizes the transfer the real-time data. Thus, real-time data experiences minimal latency (i.e. time-delay) in transit between client computer 112 and RAS 118. Modem 1112 represents one embodiment for modem 112 of FIG. 3, and modem 1113 represents one embodiment for modem 113 of FIG. 3.

Modem 1113 couples to a client computer 112 through any of a variety of interconnection technologies such as, e.g., an RS-232 serial port. Modem 1113 may be configured for insertion into an expansion slot of client computer 112. In an alternate embodiment, modem 1113 may be considered part of client computer 112 as, e.g., when modem 1113 is incorporated on the motherboard of client computer 112. Modem 1113 is also configured for coupling to switching network 115 through a subscriber connection SC#1. Subscriber connection SC#1 may be an analog or digital telephone line. It is noted that subscriber connection SC#1 is not necessarily a wired connection. For example, subscriber connection SC#1 may be achieved by a radio link.

Modem 1117 is configured for coupling to switching network 115 through a subscriber connection SC#2. The subscriber connection SC#2 may also be an analog or digital telephone line. Modem 1117 is additionally configured for coupling to remote access server (RAS) 118. As mentioned above, RAS 118 may be a conventional remote access server product such as those typically employed at Internet service providers. RAS 118 provides remote clients such as client computer 112 with access to data network 1119. RAS 118 is generally coupled to a bank of server modems to support a plurality of remote clients. For the sake of simplicity, only one server modem (i.e. modem 1117) is shown. RAS 118 couples to data network 1119. Data network 1119 comprises a system of interconnected computers or computer networks such as the Internet 125.

Client computer 112 may be coupled to a telephony device 1110. Telephony device 1110 may comprise a physical phone such as physical user phone 90 and/or a virtual phone such as virtual phone 94.

As discussed above, client computer 112 may execute one or more non-real-time applications such as non-real-time applications 92 and VPN client 93 of FIG. 6. Furthermore, client computer 112 may execute one or more real-time applications. Telephony client 91 is an example of a real-time application. The real-time applications generate real-time data frames addressed for one or more real-time IP nodes. The real-time IP nodes may be situated on local area network 160 and/or at arbitrary locations on the Internet 125. Telephony gateway 123 is an example of a real-time IP node. Similarly, the non-real-time applications generate non-real-time data frames addressed for one or more non-real-time IP nodes. The non-real-time nodes also may be situated on local area network 160 and/or at arbitrary locations on the Internet 125. Data servers 161 and VPN server 122 of FIG. 6 exemplify non-real-time IP nodes.

Modem 1113 receives from client computer 112 a first data stream including the real-time data frames and non-real-time data frames. (The non-real-time data frames will be referred to herein as “regular” data frames.) The first data stream may comprise a PPP stream. However, the principles of the present invention do not rely on the specific features of the Point-to-Point Protocol, and thus are broadly applicable to any stream of multiplexed real-time and regular data.

Modem 1113 receives the first data stream, and forwards real-time data ahead of regular data in order to generate an output stream which is transmitted onto subscriber connection SC#1. In other words, modem 1113 injects real-time data into the transmitted output stream with priority over regular data. Thus, a regular data transmission may be temporarily interrupted in order to transmit real-time data newly arrived from client computer 112. When the real-time data has been transmitted, the regular data transmission may be resumed. The injection of real-time data transmissions into the output stream occurs according to a protocol which is known by modem 1117. Regular data is transmitted only if no real-time data is available for transmission. Thus, real-time data experiences a minimal wait-time in modem 1113. It is noted that real-time data may be injected at locations which correspond to the interior of regular data packets.

The output data stream generated by modem 1113 is transmitted through switching network 115 to modem 1117. Modem 1117 receives the output data stream from subscriber connection SC#2, demultiplexes real-time data and regular data from the output data stream, and forwards the real-time data to RAS 118 with priority over the regular data. In other words, real-time data is transmitted to RAS 118 as soon as it becomes available, while regular data is transmitted to RAS 118 only if real-time data is not available. RAS 118 transmits the real-time data frames and regular data frames onto data network 1119. Normal IP routing mechanisms are responsible for delivering the real-time data frames and regular data frames to their respective IP destinations, i.e. the real-time IP nodes and non-real-time IP nodes.

In the opposite direction, the real-time IP nodes generate real-time frames addressed for the real-time applications running on client computer 112. Similarly, the non-real-time IP nodes generate non-real-time frames addressed for the non-real-time applications running on client computer 112. The real-time IP nodes and non-real-time IP nodes transmit the real-time frames and non-real-time frames respectively onto data network 1119, and normal IP routing mechanisms are responsible for delivering the real-time frames and non-real-time frames to remote access server 118.

RAS 118 passes the real-time frames and non-real-time frames to modem 1117 in a second data stream (e.g. a PPP stream). Modem 1117 receives the second data stream, and forwards real-time data ahead of regular data when preparing a second output stream for transmission onto subscriber connection SC#2. In other words, real-time data is transmitted onto subscriber connection SC#2 as soon as it becomes available, while regular data is transmitted only if real-time data is not available. Furthermore, if real-time data becomes available during a regular data transmission, the regular data transmission is temporarily interrupted so that the real-time data may be injected. When real-time data is no longer available, the regular data transmission may be resumed. The real-time data is injected according to a protocol which is recognized by modem 1113. The injection protocol deposits information in the second output stream which allows modem 1113 to detect the location and length of real-time injections in the second output stream. Modem 1117 transmits the second output stream onto the subscriber connection SC#2.

Modem 1113 receives the second output stream from the switching network 115 through subscriber connection SC#1. Modem 1113 may forward real-time data ahead of regular data in transmissions to client computer 112. Real-time data may be transmitted to client computer 112 as soon as it becomes available. In contrast, regular data may be transmitted to client computer 112 only if real-time data is not available.

An Internet protocol stack running on client computer 112 receives the real-time data and regular data from modem 1113, passes the real-time data to the one or more real-time applications, and passes the regular data to the one or more non-real-time applications. In particular, a telephony client application may receive real-time telephony data which is used to drive telephony device 1110.

Since modems 1113 and 1117 forward real-time data ahead of regular data, real-time latency in transmission is minimized. With regard to transmissions onto the subscriber connection SC#1 or SC#2, large regular data packets do not contribute to real-time latency since real-time data transmission is given priority over regular data transmission. The injection of real-time data into the transmitted stream is not constrained to respect regular data packet-boundaries.

As described above, telephony client 91 exchanges telephony data with telephony gateway 123 through the telephony connection Cₜ, and VPN client 93 exchanges regular data with VPN server 122 through the VPN connection Cᵥ. Modem 1113 and modem 1117 provide a means for transferring the telephony data and regular data through switching network 115 in a manner which minimizes the transfer latency of the telephony data.

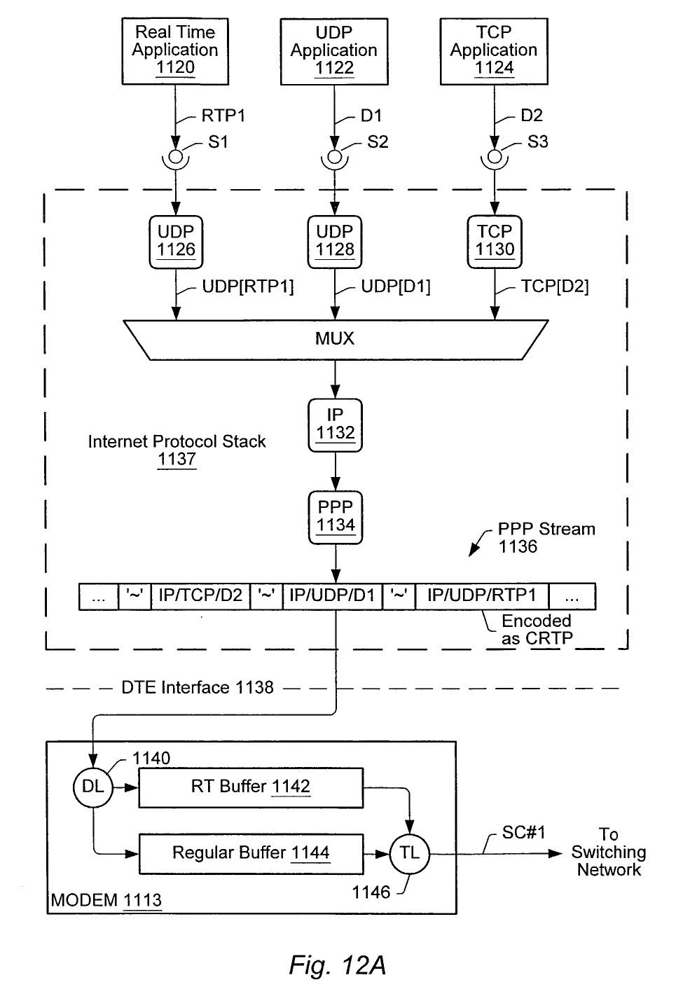

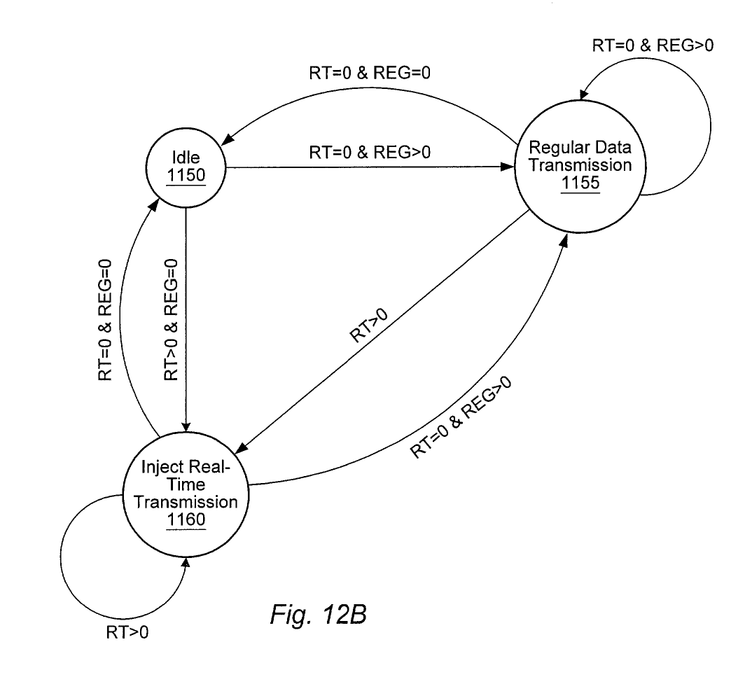

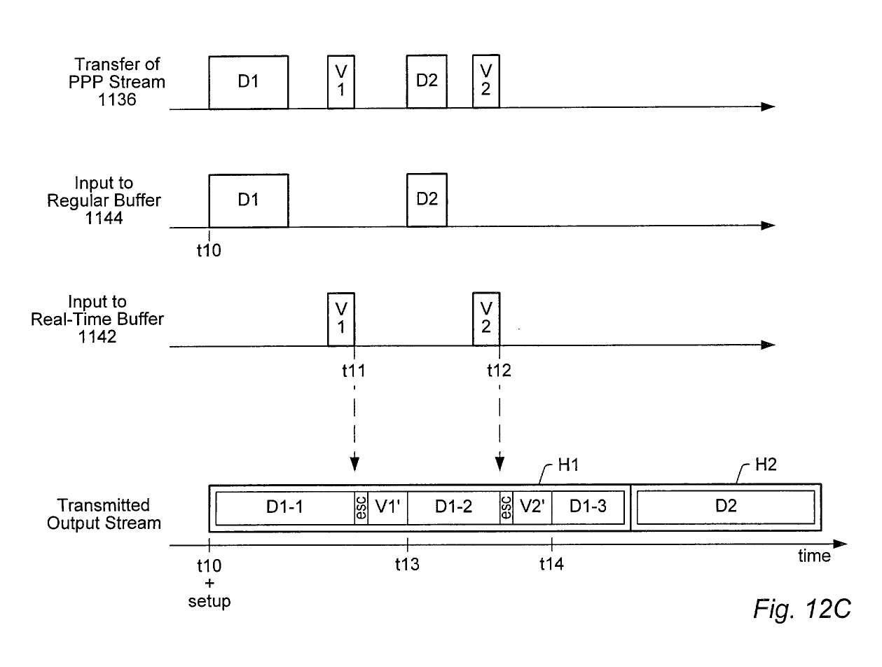

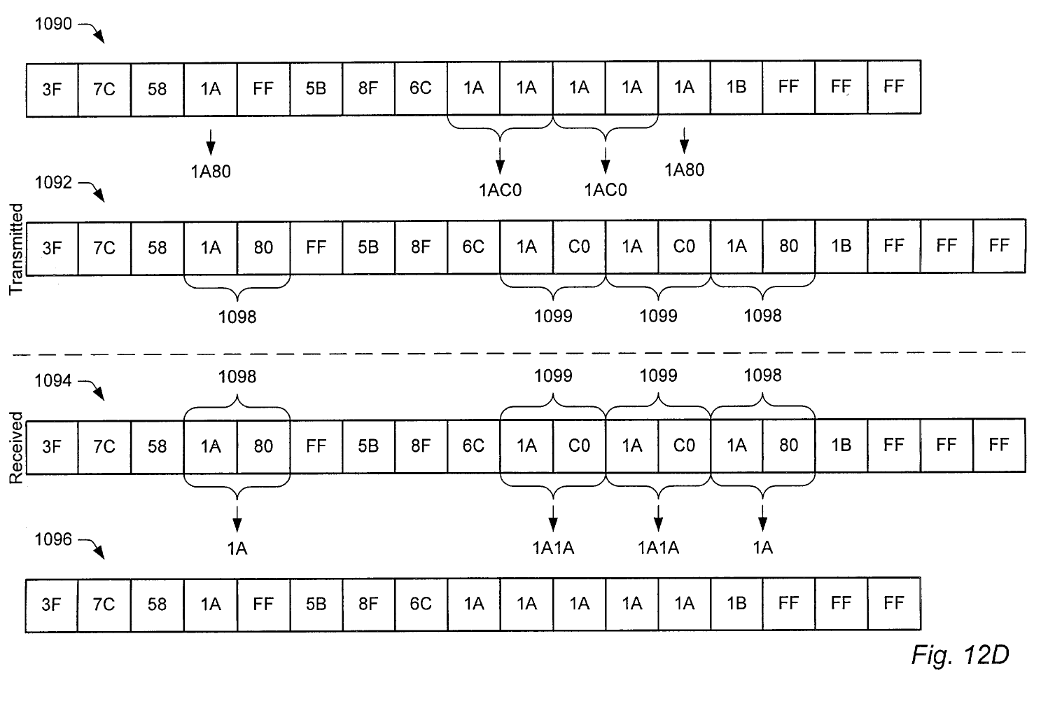

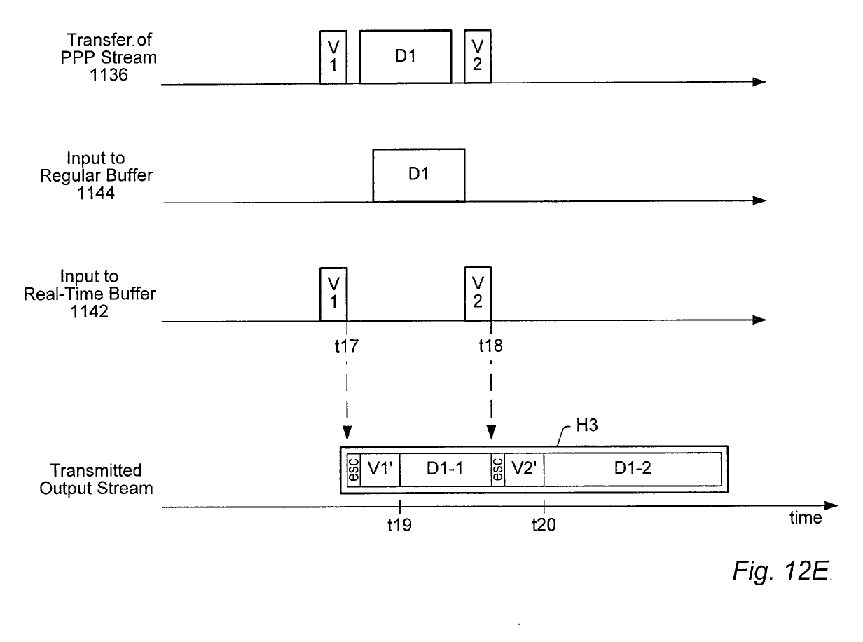

FIG. 12A illustrates a preferred embodiment for the transmission architecture of modem 1113 and a typical software arrangement for client computer 112. The elements depicted in FIG. 12A above the dotted line labeled DTE interface 1138 are software modules which execute on client computer 112.

Client computer 112 includes a processor and a memory which provide for the execution of an arbitrary number of software applications. For example, client computer 112 may execute real-time applications, UDP applications, TCP applications, etc. Telephony client 91 comprises a real-time application. Non-real-time application 92 may include UDP applications and TCP applications. VPN client 93 may be a TCP application.

Real-time application 1120 generates a stream of RTP packets. One of these packets RTP1 is especially denoted in passage to socket S1. UDP application 1122 is meant to represent UDP applications which are non-real-time in nature. UDP application 1122 is shown passing a data packet D1 to socket S2. TCP application 1124 generates a bit stream D2. The bit stream D2 is shown in transit to socket S3. TCP application 1124 is meant to represent TCP applications which are non-real-time in nature.

An Internet Protocol Stack 1137 also executes on client computer 112. The Internet Protocol Stack 1137 comprises a multi-layer system of protocol modules. The Internet Protocol Stack 1137 may be part of a conventional operating system running on client computer 112. The Internet Protocol Stack mediates data transfers for software applications running on client computer 112.

UDP module 1126 encapsulates the RTP packet RTP1 received from socket S1 according to the User Datagram Protocol. UDP module 1128 encapsulates the packet D1 received from socket S2 according to the User Datagram Protocol. (Real-time data such as voice data is typically encapsulated in UDP.) TCP module 1130 encapsulates the data D2 received from socket S3 according to the Transfer Control Protocol. The UDP and TCP encapsulated packets generated by the transport layer modules including modules 1126-1130 are multiplexed and provided to IP module 1132. IP module 1132 encapsulates the UDP and TCP packets as IP packets. The resulting stream of IP packets are provided to PPP module 1134. PPP module 1134 encodes the IP packets stream as a stream of PPP frames. A portion of the PPP stream 1136 is shown. Observe that frames in the PPP stream are separated by a tilde character, i.e. 0x7E.

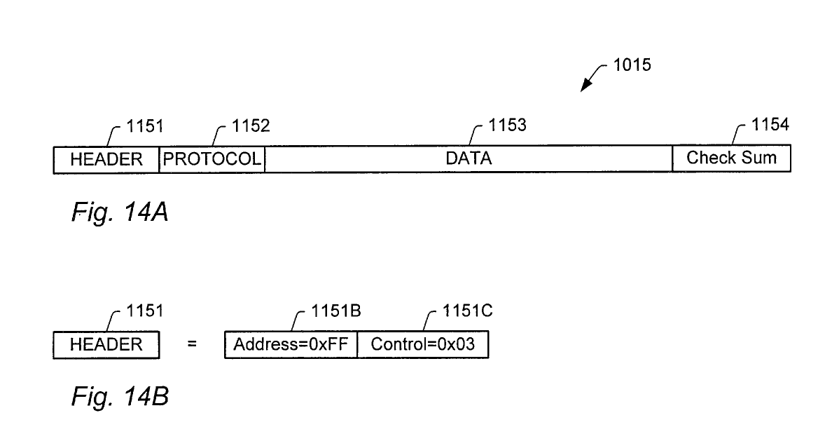

FIG. 14A depicts the frame format for the Point-to-Point protocol. The generic PPP frame 1015 includes a header field 1151, a protocol field 1152, a data field 1153 and a check sum 1154. FIG. 14B depicts the format of header field 1151. Header field 1151 includes an address byte 1151B and a control byte 1151C. The address byte 1151B may take the value 0xFF. The control byte 1151C may take the value 0x03. Check sum 1154 provides for error detection at the PPP receiver. The protocol field 1152 defines the protocol(s) used to generate data field 1153. Data field 153 contains the data payload of the PPP frame 1015.

The PPP stream 1136 generated by the PPP module may include IP/TCP encapsulated data. One such frame denoted IP/TCP/D2 encapsulates data D2 which originated from TCP application 1124. The PPP stream 1136 may also include IP/UDP encapsulated data. One such frame denoted IP/UDP/D1 encapsulates data D1 which originated from the UDP application 1122. The PPP stream may additionally include IP/UDP/RTP encapsulated data. One such frame denoted IP/UDP/RTP1 encapsulates RTP packet RTP1 which originated from real-time application 1120.

The PPP module may compress the redundant header information of IP/UDP/RTP encapsulated frames using a protocol such as, e.g., the Compressed Real Time protocol (CRTP). The PPP module provides the PPP stream 1136 to modem 1113 through DTE interface 1138.

Modem 1113 comprises demultiplexing logic 1140, real-time buffer 1142, regular buffer 1144, and transmit logic 1146. It is noted that the functions performed by demultiplexing logic 1140 and transmit logic 1146 may be implemented by a microcontroller (or processor) situated within modem 1113.

Demultiplexing logic 1140 receives the PPP stream 1136 from the PPP module 1134, and demultiplexes the PPP stream in real time. Demultiplexing logic 1140 scans the PPP stream for the header field 1151 to determine the beginning of each PPP frame. Once a header field has been detected, the subsequent protocol field 1152 is examined. If the protocol field indicates that the newly detected PPP frame encapsulates real-time data (such as RTP or CRTP data), the PPP frame is stored into the real-time buffer 1142. If the protocol field indicates an encapsulation corresponding to non-real-time data protocol(s), i.e. protocols other than RTP or CRTP, the newly detected PPP frame is stored into regular buffer 1144. It is noted that characters which make up the PPP stream 1136 are received by demultiplexing logic 1140 and very quickly stored in either real-time buffer 1142 or regular buffer 1144.

Real-time buffer 1142 may comprise Random Access Memory (RAM) such as Dynamic RAM (DRAM). Regular buffer 1144 may also comprise RAM. Real-time buffer 1142 and regular buffer 1144 may comprise distinct sections of a common memory space accessible by a microcontroller.

Transmit logic 1146 generates and transmits an output character stream (see item 1092 of FIG. 12D) based on the state of real-time buffer 1142 and regular buffer 1144. FIG. 12B illustrates a state diagram for transmit logic 1146. In an idle state 1150, transmit logic 1146 is not engaged in active transmission.

In response to real-time buffer 1142 being empty and regular buffer 1144 attaining a non-empty condition, transmit logic 1146 moves into the “regular data transmission” state 1155. In this state 1155, transmit logic 1146 transmits regular data from regular buffer 1144 until regular buffer 1144 is exhausted, i.e. attains the empty state, or until the real-time buffer attains the non-empty state. If real-time buffer 1142 remains empty and regular buffer 1144 attains the empty state due to the transmission activity of transmit logic 1146, transmit logic 1146 returns to the idle state 1150.

In the preferred embodiment, real-time buffer 1142 is said to be empty or nonempty with respect to complete real-time frames. Thus, real-time buffer 1142 is said to be empty when it contains no complete real-time frames, and non-empty when it contains one or more complete real-time frames. In contrast, regular buffer 1144 is declared to be non-empty when the number of bytes stored in regular buffer 1144 exceeds a threshold value, and declared to be empty when the number bytes in regular buffer 1144 reaches zero. The threshold value is chosen to be a small integer such as two or three to guarantee that transmit logic 1146 does not run out of regular data to transmit. If regular data is queued in client computer 112 awaiting transfer to modem 1113, two or three byte transmission times at the low transmission rate of the subscriber connection SC#1 is generally enough time for the regular data to be transferred across the DTE interface 1138 and into real-time buffer 1142.

If the real-time buffer attains the non-empty condition during a regular data transmission (i.e. state 1155), transmit logic 1146 temporarily interrupts the regular data transmission, and moves to the “inject real-time data transmission” state 1160. In state 1160, transmit logic 1146 transmits real-time data (e.g. RTP or CRTP frames) from real-time buffer 1142 until real-time buffer 1142 attains the empty state, i.e. is exhausted of complete real-time frames. It is noted that demultiplexing logic 1140 may store real-time frame data into real-time buffer 1142 while transmit logic 1146 concurrently reads real-time frame data from the real-time buffer 1142 for transmission onto subscriber line SC#1. The functions of demultiplexing logic 1140 and transmit logic 1146 may be implemented in software on a processor (e.g. a microcontroller) situated within modem 1113.

Transmit logic 1146 accesses real-time data from real-time buffer 1142 and injects the real-time data into the output character stream. In the preferred embodiment, the real-time data stored in real-time buffer 1142 is organized into frames (such as PPP frames). In this case, transmit logic 1146 may repackage the contents of a real-time frame into a more efficient form referred to herein as a real-time capsule. For example, when forming a real-time capsule from a real-time PPP frame, transmit logic 1146 may throw away the header field 1151, the protocol field 1152, and the checksum field 1154 of a real-time PPP frame. See FIGS. 14A & 14B for the format of a PPP frame. The real-time capsule includes the data field 1153 of the real-time PPP frame and a length field which defines the length of the data field. The length field may precede the data field in the real-time capsule so that a receiving device (e.g. modem 1117) may discern the length of the data field prior to its arrival in the output character stream.

Transmit logic 1146 generates the real-time capsule on-the-fly, i.e. with minimal buffering. It is noted that demultiplexing logic 1140 may compute the length field for the real-time capsules as it is writing a corresponding real-time data frame into real-time buffer 1142. Thus, transmit logic 1146 may avoid additional buffering of the real-time data to compute the length field.

When the real-time buffer 1142 attains the empty condition, i.e. when no more complete real-time frames reside in real-time buffer 1142, transmit logic 1146 (a) moves to the idle state 1150 if regular data buffer 144 is empty, or (b) moves to the “regular data transmission” state 1155 if regular data buffer 1144 is non-empty.

As noted above, the transmission of regular data may be interrupted in order to inject real-time data into the output data stream. In the state diagram this interruption corresponds to the transition from state 1155 to state 1160 in response to the real-time buffer 1142 attaining a non-empty condition. When the real-time data injection is complete, transmit logic 1146 resumes regular data transmission, i.e. returns to state 1155.

It is noted that transmit logic 1146 transmits an output data stream to modem 11117 (of FIG. 11) through the switching network 115. The data transfer protocol between transmit logic 1146 and modem 1117 may be a synchronous or an asynchronous protocol.

When real-time buffer 1142 is full, demultiplexing logic 1140 may be configured to discard one or more real-time frames previously stored in real-time buffer 1142 to make room for newly arriving real-time frames. A newly arriving real-time frame from the PPP stream 1136 may overwrite the old real-time frames previously stored in the real-time buffer 1142. Preferably the discarded real-time frames are the ones which are oldest chronologically, i.e. the ones which are resided in real-time buffer for the longest duration.

In contrast, demultiplexing logic 1140 is configured to discard any regular frames arriving in the PPP stream 1136 when regular buffer 1144 is full. Regular frames previously stored in regular buffer 1144 are retained.

FIG. 12C depicts an escape sequence protocol for injecting real-time data into the transmitted output stream. FIG. 12C includes several graphs. The topmost graph illustrates the arrival of PPP stream 1136 across the DTE interface 1138. PPP stream 1136 is illustrated with four frames in succession, i.e. regular frame D1, real-time frame V1, regular frame D2 and real-time frame V2. The second graph illustrates the arrival of regular data frames into regular buffer 1144. The third graph illustrates the arrival of real-time frames into real-time buffer 1142. Recall that demultiplexing logic 1140 scans the PPP stream so as to separate the real-time data frames and regular data frames.

For simplicity, it is assumed that real-time buffer 1142 and regular buffer 1144 are empty prior to time t₁₀ when the first bytes of regular frame D1 are stored into regular buffer 1144. After a threshold number of bytes of regular data frame D1 have been stored into regular buffer 1144, transmit logic 1146 moves into the “regular data transmission” state 1155 and starts to transmit regular data frame D1. The setup time is defined as the time required for the threshold number of bytes to arrive into regular buffer 1144. Transmit logic 1146 may create an HDLC frame Hi in order to contain the regular data frame D1. It is noted the choice of HDCL as a data transport protocol is arbitrary, and a variety of transport protocols are contemplated.

The transmission of regular frame D1 is interrupted at times t₁₁ and t₁₂ when real-time frames V1 and V2 respectively become available for transmission. Thus, regular frame D1 is transmitted as three disjoint components D1-1, D1-2, D1-3 which are separated by injected real-time capsules V1′ and V2′. At time t₁₁, demultiplexing logic 1140 completes the storage of real-time frame V1 into real-time buffer 1142. In response to real-time buffer 1142 now being non-empty, transmit logic 1146 injects real-time capsule V1′ corresponding to real-time frame V1 into the transmitted output stream. In order to signal the introduction of real-time data to the receiver (i.e. modem 1117), transmit logic 1146 inserts an escape character into the output stream. The escape character defines the position of the real-time injection to the receiver. The real-time capsule V1′ which includes a length field and the real-time payload data is inserted into the output stream after the escape character. The length field defines the length of the real-time payload data. Thus, the length field allows the receiver to detect the position in the transmitted output stream where regular data transmission resumes.

For more information concerning the escape sequence protocol, please refer to U.S. patent application Ser. No. 09/238,819 entitled “Escape Sequence Protocol for Multiplexing Real-Time Data with Non-Real-Time Data”, filed on Jan. 28, 1999, invented by David C. Oliver, assigned to Data Race, Inc., which is hereby incorporated by reference.

After the insertion of real-time capsule V1′ into the output stream has been completed at time t₁₃, real-time buffer 1142 is empty, i.e. contains no real-time frames. Thus, transmit logic 1146 returns to the “regular data transmission” state 1155, and thus, resumes transmission of regular frame D1. At time t₁₂, demultiplexing logic 1140 completes the storage of real-time frame V2 into real-time buffer 1142. In response to real-time buffer 1142 again being non-empty, transmit logic 1146 injects real-time capsule V2′ corresponding to real-time frame V2 into the transmitted output stream. The escape character is inserted prior to real-time capsule V2′ and after the interruption of regular data at time t₁₂. After transmit logic 1146 completes insertion of real-time capsule V2′ into the output stream at time t₁₄, real-time buffer 1142 once again attains the empty condition, and thus, transmit logic 1146 resumes transmission of regular data.

When transmission of regular data frame D1 is completed at time t₁₅, real-time buffer 1142 is empty and regular buffer 1144 is non-empty. Thus, transmit logic 1146 remains in the “regular data transmission” state 1155, and immediately begins to transmit regular frame D2 onto the communication medium (i.e. subscriber connection SC#1). Transmit logic 1146 may generate a new HDLC frame H2 for regular data frame D2. In general, transmit logic 1146 may generate a new HDLC frame for each regular data frame transmitted. As mentioned above, the HDLC frame may contain any number of real-time data injections according to the escape sequence protocol.

Note that other protocols for multiplexing real-time data and regular data into the output data stream may be used. For more information on one such multiplexing scheme, please refer to U.S. patent application Ser. No. 09/100,778 entitled “System and Method for Low Overhead Multiplexing of Real-Time and Non-Real-Time Data”, filed on Jun. 10, 1998, invented by David C. Oliver, and assigned to Data Race, Inc., which is hereby incorporated by reference.

Transmit logic 1146 is further configured to scan the characters comprising regular data frames prior to transmission. The scanning operation treats the regular frames as a character stream, and injects a secondary character after solo occurrences of the escape character in the character stream. The secondary character is different from the escape character. The scanning operation further includes detecting adjacent occurrences of the escape character in the character stream, and replacing the second of the adjacent occurrences of the escape character in the character stream with a tertiary character. The tertiary character is different from the escape character and the secondary character.

Turning now to FIG. 12D, data streams are provided illustrating the replacement of regular data characters according to the mechanism described above. A regular data stream is shown at 1090. The regular data stream 1090 includes characters equal in value to the primary escape sequence hex 1A. Note that while the value hex 1A is shown for the primary escape sequence (the ASCII SUB character), any value may be used as the escape character as long as the value is known to the transmitting and receiving devices. As shown in data stream 1092, the regular data sequences equal to the primary escape sequences are replaced with the second or third type of escape sequence before the data stream is transmitted. Single occurrences of the escape character are replaced with the second escape sequence hex 1A80, and double occurrences of the escape character are replaced with the third escape sequence hex 1AC0. The receiving device (i.e. modem 1117) receives the data stream 1094 containing the substituted second and third escape sequences. The receiving device replaces the second escape sequence with a data value equal to the escape character hex 1A and replaces the third escape sequence with a data value equal to a pair of the escape characters, i.e. hex 1A1A, as shown in the data stream 1096. Data stream 1096 is then used as the received data stream.

FIG. 12E illustrates the situation where one or more real-time frames become available for transmission while regular buffer 1144 is empty. The topmost graph in FIG. 12E illustrates the transfer of PPP stream 1136 across DTE interface 1138. PPP stream 1136 includes a succession of frames, i.e. real-time frame V1, regular frame D1 and real-time frame V2. Demultiplexing logic 1140 separates the PPP stream 1136 so that regular frames as sent to regular buffer 1144 and real-time frames are sent to the real-time buffer 1142. The second graph depicts the arrival of regular frames in regular buffer 1144. The third graph depicts the arrival of real-time frames in the real-time buffer 1142. The fourth graph depicts the transmitted output stream generated by transmit logic 1146.

It is noted that real-time frames V1 and V2 become available for transmission at times t₁₇ and t₁₈ respectively, i.e. as soon as demultiplexing logic 1140 completes storage of the respective real-time frame into real-time buffer 1142. In FIG. 12E, it is assumed that transmit logic 1146 is in the idle state 1150 prior to the arrival of real-time frame V1. This implies that real-time buffer 1142 is empty, i.e. devoid of real-time frames, and regular buffer 1144 is empty. At time t₁₇ real-time frame V1 becomes available for transmission, and transmit logic 1146 enters the “inject real-time data transmission” state 1160. In order to support the injection of real-time data, transmit logic 1146 generates an initial portion (not shown) of a containing frame H3. The contents of the initial portion may be defined by the data transport protocol. The containing frame H3 may be an HDLC frame if HDLC is being used as the data transport protocol. Transmit logic 1146 inserts the initial portion of the containing frame into the transmitted output stream. After the initial portion, transmit logic 1146 transmits the primary escape sequence, and then transmits real-time capsules until real-time buffer 1142 attains the empty condition, i.e. is devoid of complete real-time frames. In this case, real-time buffer 1142 is exhausted after real-time capsule V1′ corresponding to real-time frame V1 is transmitted.

At time t₁₉ real-time buffer 1142 is again empty. However, in the time interval between time t₁₇ and t₁₉, regular buffer 1144 has become non-empty due to the arrival of regular frame D1. Thus, at time t₁₉ transmit logic 1146 enters the “regular data transmission” state 1155. Regular data transmission is interrupted at time t₁₈ in order to inject real-time capsule V2′ corresponding to newly arrived real-time frame V2. After real-time capsule V2′ is transmitted using the escape sequence protocol, transmit logic 1146 may resume transmission of the remaining portion D1-2 of regular frame D1 from regular buffer 1144. When regular buffer 1144 is exhausted, transmit logic 1146 may transmit a terminating portion (not shown) of the containing frame if real-time buffer 1144 is concurrently in the empty state, i.e. if real-time buffer 1144 contains no complete real-time frames.

It is noted that the terminating portion of containing frame H3 may be transmitted from the “inject real-time data transmission” state 1160. Namely, when the real-time buffer 1142 attains the empty state, i.e. is exhausted of complete real-time frames, the terminal portion of a containing frame will be transmitted if the regular buffer is also empty.

In summary, modem 1113 comprises a first real-time buffer 1142, a first regular buffer 1144, and control logic. The control logic comprises demultiplexing logic 1140 and transmit logic 1146. The control logic may be physically realized by a microcontroller. In this case, demultiplexing logic 1140 and transmit logic 1146 are software processes which execute on the microcontroller. Alternatively, demultiplexing logic 1140 and transmit logic 1146 may be implemented as separate hardware devices optimized for their respective functions. Demultiplexing logic 1140 is configured:

(a) to receive a first stream of frames from a first data interface,

(b) to demultiplex the first stream of frames into a second stream of real-time frames and a third stream of regular frames, and

(c) to store the second stream of real-time frames into the first real-time buffer and third stream of regular frames into the first regular buffer.

Transmit logic 1146 is configured:

(d) to initiate transmission of a first regular frame from the first regular buffer onto a communication medium,

(e) to temporarily interrupt transmission of the first regular frame in response to the real-time buffer attaining a first non-empty condition,

(f) to transmit one or more real-time capsules (which are generated from real-time frames stored in the first real-time buffer) onto the communication medium until the first real-time buffer attains a first empty condition,

(g) to resume transmission of the first regular frame in response to the first real-time buffer attaining the first empty condition.

In one embodiment, the following mechanism is employed to manage the empty or non-empty status of the real-time buffer. Demultiplexing logic 1142 is configured to increment a real-time frame count in response to completing storage of a real-time frame into real-time buffer 1142. Demultiplexing logic 1142 may scan the PPP stream 1136 for the PPP header bytes, and thereby detect the end of one frame and the beginning of the next frame. Thus, demultiplexing logic 1142 is able to detect the end of a real-time frame. The real-time frame count increases by one for each real-time frame stored into the real-time buffer 1142. In addition, transmit logic 1146 is configured to decrement the real-time frame count in response to completing transmission of a real-time frame from the real-time buffer 1142. Real-time buffer 1142 is said to attain a non-empty condition when the real-time frame count attains a value greater than zero. Transmit logic 1146 monitors the value of the real-time buffer count, and moves into the “inject real-time data transmission” state 1160 when the real-time frame count attains a value greater than zero. Correspondingly, the real-time buffer 1142 is said to attain the empty condition when the real-time frame count attains the value of zero.

In a second embodiment, demultiplexing logic 1142 maintains an real-time input count by incrementing the real-time input count in response to completing storage of a real-time frame into the real-time buffer 1142. Transmit logic 1146 maintains a real-time output count by incrementing the real-time output count in response to completing transmission of a real-time frame from real-time buffer 1142. Transmit logic 1146 determines the empty or non-empty condition of real-time buffer 142 by subtracting the real-time output count from the real-time input count. A positive resultant value indicates that the real-time buffer 1142 contains one or more complete real-time frames. A resultant value of zero indicates that real-time buffer 1142 contains no complete real-time frames.

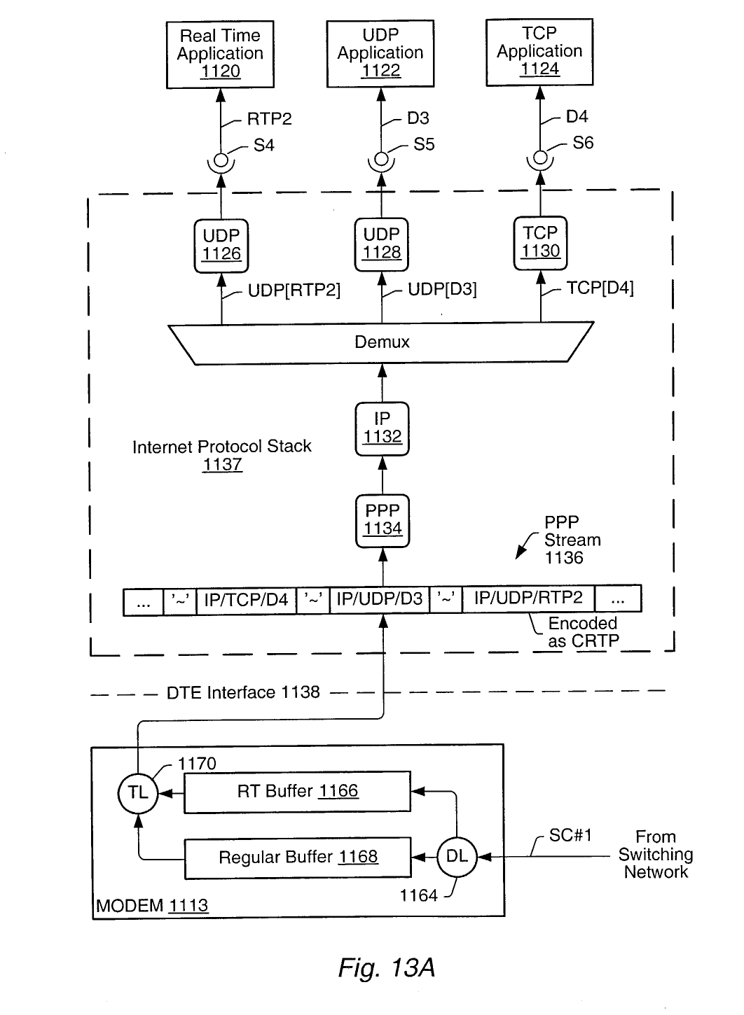

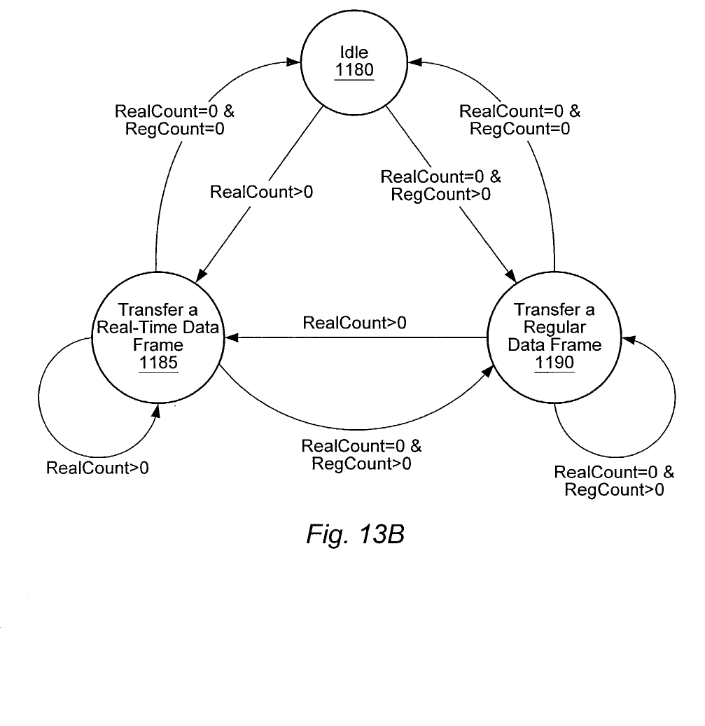

In the preferred embodiment, modem 1113 is further configured for data reception as shown in FIG. 13A. Modem 1113 includes a second real-time buffer 1166, a second regular buffer 1168, demultiplexing logic 1164 and transmit logic 1170. The functions of demultiplexing logic 1164 and transmit logic 1170 may implemented in software on an embedded microcontroller.

Demultiplexing logic 1164 is configured to receive a fourth data stream from the communication medium (i.e. subscriber connection SC#1). The fourth data stream is transmitted from modem 1117 through the switching network 115. Demultiplexing logic 1164 demultiplexes the fourth data stream into a fifth stream of real-time data and a sixth stream of regular data. Demultiplexing logic 1164 stores the fifth stream of real-time data into real-time buffer 1166 and the sixth stream of regular data into regular buffer 1168.

Demultiplexing logic 1164 may scan the fourth data stream for the primary escape sequence to detect the initiation of a real-time capsule in the fourth data stream. When the primary escape sequence is detected, demultiplexing logic 1164 receives the real-time capsule which follows the primary escape sequence in the fourth data stream. The real-time capsule includes a real-time length field and real-time payload data as described above. The real-time length field specifies the length of the real-time data following the length field in the fourth data stream. Demultiplexing logic 1164 may repackage the real-time payload data in a frame format such as the PPP frame format before storage into real-time buffer 1166. For example, the real-time payload data may be prefixed with a header field and a protocol field, and postfixed with a checksum as defined by PPP, in order to generate a real-time PPP frame.

Demultiplexing logic 1164 is also configured to scan the sixth stream of regular data, and to replace each occurrence of the second escape sequence in the sixth stream with the escape character, and each occurrence of the third escape sequence in the sixth stream with a pair of escape characters, i.e. hex 1A1A. These replacement operations may be performed before the regular data is written into regular buffer 1168.

Transmit logic 1170 transmits data to client computer 112 from real-time buffer 1166 and regular buffer 1168. FIG. 13B depicts a state diagram for transmit logic 1170. In an idle state 1180 transmit logic 1170 is inactive. Transmit logic 1170 stays in the idle state until either real-time buffer 1166 or regular buffer 1168 becomes non-empty. Real-time buffer 1166 is said to be empty when it contains no complete real-time frames, and non-empty when it contains one or more complete real-time frames. Similarly, regular buffer 1168 is said to be empty when the number of complete regular frames stored in regular buffer 1168 equals zero, and non-empty when this number is greater than zero.

Demultiplexing logic 1164 and transmit logic 1170 implement a mechanism for indicating the number of complete real-time frames stored in real-time buffer 1166, and the number of complete regular frames stored in regular buffer 1168. In FIG. 13B these numbers are denoted RealCount and RegCount respectively.

Transmit logic 1170 transitions from the idle state 1180 to the “transfer a regular data frame” state 1190 in response to regular buffer 1168 attaining a non-empty condition (i.e. RegCount>0) while real-time buffer 1166 remains empty (RealCount=0). In state 1190, transmit logic 1170 transfers a regular data frame from regular buffer 1168 to client computer 112 across DTE interface 1138. Upon completing transfer of the current regular data frame, transmit logic 1170 decrements the regular frame count RegCount, examines the empty/non-empty condition of real-time buffer 1166 and regular buffer 1168, and transitions to one of states 1180, 1185 or 1190 depending on the empty/nonempty condition of these buffers. In particular, transmit logic 1170

(a) returns to state 1190, and thus, transfers another regular data frame from regular buffer 1168 to client computer 112, if real-time buffer 1166 is still empty (i.e. RealCount is zero) and regular buffer 1168 is still nonempty (i.e. RegCount is positive);

(b) moves to the “transfer a real-time data frame” state 1185 in response to real-time buffer 1166 being non-empty (i.e. RealCount>0); or

(c) moves to idle state 1180 if both buffers are found to be empty (i.e. RealCount=0 and RegCount=0).

In the “transfer a real-time data frame” state 1185, transmit logic 1170 transfers a real-time data frame from real-time buffer 1166 to client computer 112 through DTE interface 1138, and decrements the real-time frame count RealCount. Transmit logic 1170 repeatedly transfers real-time data frames from real-time buffer 1166 until real-time buffer 1166 is emptied (i.e. RealCount=0). When real-time buffer 1166 has been emptied, transmit logic returns to the idle state 1180 if regular buffer 1168 is empty (RegCount=0), and transitions to the “transfer a regular data frame” state 1190 if regular buffer 1168 is non-empty (i.e. RegCount>0).

When real-time buffer 1166 is full, demultiplexing logic 1164 is further configured to discard one or more real-time frames previously stored in real-time buffer 1166 to make room for the storage of a current real-time frame (i.e. one that is just arriving) from the fourth stream. The discarded real-time frames are preferably the oldest real-time frames residing in real-time buffer 1166. In contrast, when regular buffer 1168 is full, demultiplexing logic 1164 is configured to discard any arriving regular data frames, and to retain regular frames already stored in regular buffer 1168.

The above description of client modem 1113 serves as a description of at least one embodiment of server modem 1117. However, it is noted that server modem 1117 connects to an Internet Protocol Stack running on remote access server 118. Furthermore, server modem 1117 connects to switching network 115 through subscriber connection SC#2.

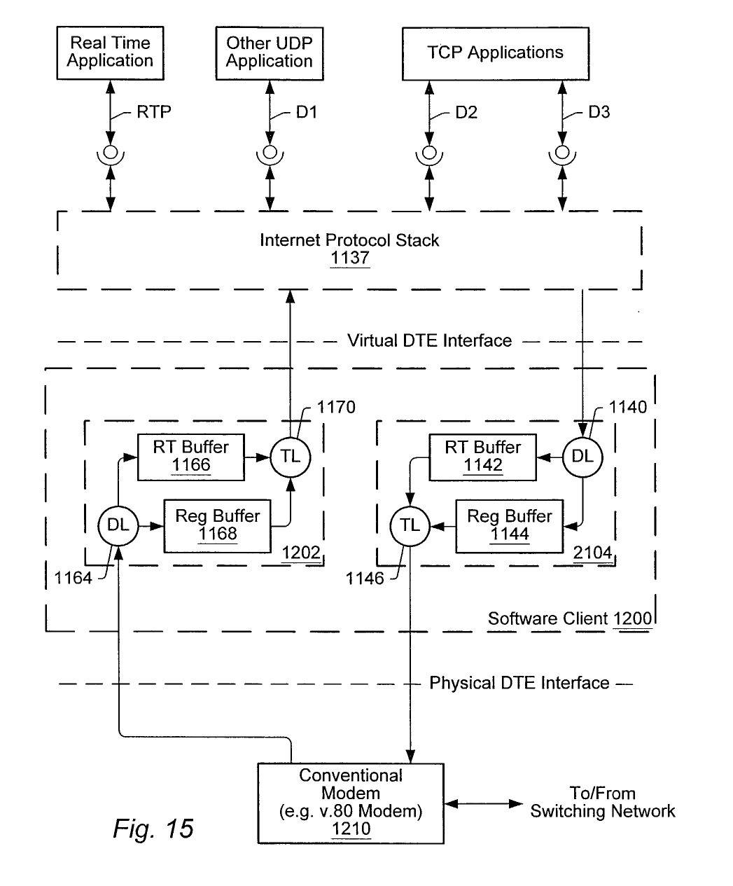

As shown in FIG. 15, the functions associated with transmission elements 11401146 and reception elements 1164-1170 of modem 1113 may be implemented as a system of software modules which execute on client computer 112. This system of software modules is referred to herein as software client 1200. Software client 1200 may include transmission module 1204 and reception module 1202. Software client 1200 communicates with Internet Protocol Stack 1137 through a virtual DTE interface. Internet Protocol Stack 1137 communicates with software client 1200 as if software client 1200 were a physical modem. In other words, the virtual DTE interface behaves like a physical modem interface so far as Internet Protocol Stack 1137 is concerned.

Software Client 1200 transmits and receives data from conventional modem 1210. Conventional modem 1210 may be any of a variety of existing modems such as, e.g., a v.80 modem (i.e. a modem conforming to the v.80 standard).

For more information on implementing special protocols using host software in conjunction with a conventional modem, please refer to U.S. patent application Ser. No. 09/238,820 entitled “Implementing Standard Protocols Using Standard Modems”, filed on Jan. 28, 1999, invented by David C. Oliver, and assigned to Data Race, Inc., which is hereby incorporated by reference.

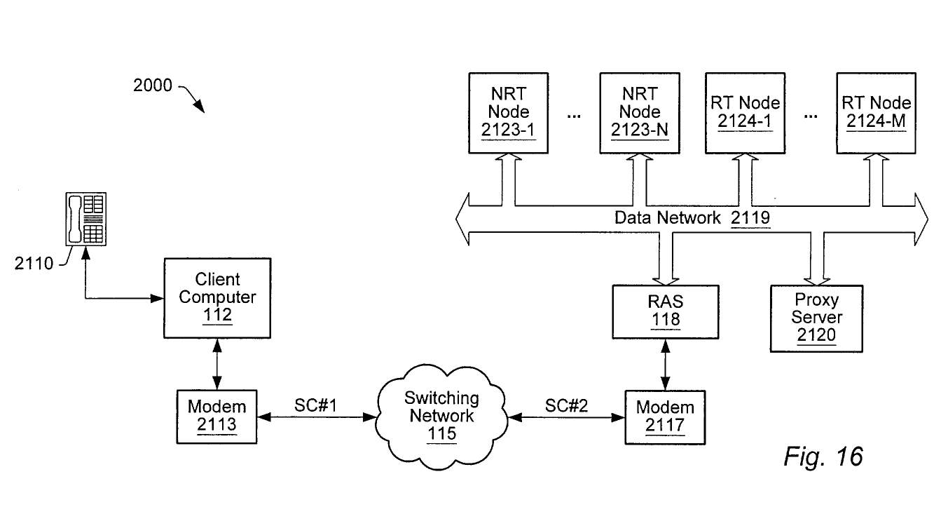

FIG. 16 depicts a hybrid modem-server system 2000 for expediting the transfer of real-time data, relative to non-real-time data transfers, between client computer 112 and a data network 2119. Hybrid system 2000 employs a client modem 2113 and a proxy server 2120 to transfer real-time data with priority over non-real-time data between client computer 112 and data network 2119. Client modem 2113 couples to client computer 112, and proxy server 2120 couples to data network 2119. Hybrid system 2000 advantageously operates with a conventional modem 2117 at remote access server 118. Thus, the operation of hybrid system 2000 does not require any special support by Internet Service Providers so far modem hardware is concerned.

It is noted that hybrid modem-server system 2000 may be used to expedite the transfer of telephony data, relative to non-real-time data transfers, between client computer 112 and local area network 160 of FIG. 3. Thus, in one embodiment of communication system 100, client modem 2113 represents client modem 113; conventional modem 2117 represents server modem 117; and server system 120 of FIG. 3 additionally includes proxy server 2120.

Non-real-time IP nodes 2123-1 through 2123-N (collectively referred to herein as non-real-time IP nodes 2123) couple to data network 2119, and are representative of a collection of servers such as file servers, print servers, email servers, database servers, etc. which perform non-real-time data communication. Data servers 161 and VPN server 122 of FIG. 6 are examples of non-real-time IP nodes.

Real-time nodes 2124-1 through 2124-M (collectively referred to herein are real-time nodes 2124) couple to data network 2119, and are representative of devices which source and/or sink real-time data. Telephony gateway 123 is an example of a real-time node. Real-time nodes also include devices such as VoIP terminals which interface with a human being, and VoIP gateways which interface with the PSTN. A VoIP terminal may comprise a computer loaded with a VoIP software application, and coupled to a microphone and speaker.

As discussed above, client computer 112 may execute one or more non-real-time applications such as non-real-time applications 92 and VPN client 93 of FIG. 6. Furthermore, client computer 112 may execute one or more real-time applications. Telephony client 91 is an example of a real-time application. The real-time applications generate real-time data frames addressed for one or more of real-time IP nodes 2124. Similarly, the non-real-time applications generate non-real-time data frames addressed for one or more non-real-time IP nodes 2123 on data network.

Modem 2113 receives from client computer 112 a first data stream including the real-time data frames and non-real-time data frames. (The non-real-time data frames will be referred to herein as “regular” data frames.) The first data stream may comprise a PPP stream. However, the principles of the present invention do not rely on the specific features of the Point-to-Point Protocol, and thus are broadly applicable to any stream of multiplexed real-time and regular data.

Modem 2113 multiplexes the real-time data frames and non-real-time data frames into a stream of transmission units referred to herein as tinygrams, and transmits the stream of tinygrams to proxy server 2120 through a remote access connection Cₚ. Proxy server 2120 demultiplexes the real-time frames and non-real-time frames from the stream of tinygrams, and transmits the real-time frames and non-real-time frames onto data network 2119. Normal IP routing mechanisms are responsible for delivering the real-time frames and non-real-time frames to their respective Internet-Protocol (IP) destinations, i.e. to real-time nodes 2124 and non-real-time nodes 2123.

In the reverse direction, the real-time nodes 2124 generate real-time frames addressed for the real-time applications running on client computer 112. Similarly, the non-real-time nodes 2123 generate non-real-time frames addressed for the non-real-time applications running on client computer 112. The real-time nodes 2124 and non-real-time nodes 2123 transmit the real-time frames and non-real-time frames respectively onto data network 2119. Again, normal IP routing mechanisms are responsible for delivering the real-time frames and non-real-time frames to proxy server 2120.

Proxy server 2120 receives the real-time frames and the non-real-time frames (destined for client computer 112) from data network 2119. Proxy server 2120 multiplexes the real-time frames and non-real-time frames into a second stream of tinygrams. Proxy server 2120 transmits the second stream of tinygrams to modem 2113 through the remote access connection Cₚ. Modem 2113 demultiplexes the second stream of tinygrams, and presents the reconstructed real-time frames and non-real-time frames to client computer 112. The remote access connection Cₚ stretches across subscriber connection SC#1, switching network 115 (e.g. the PSTN), subscriber connection SC#2, conventional modem 2117, remote access server (RAS) 118, and perhaps a portion of data network 2119. It is noted that remote access server 118 and proxy server 2120 may be co-located on a common host computer. In this case, the remote access connection Cₚ to proxy server 2120 may not involve data network 2119.

Modem 2113 and proxy server 2120 together implement a tinygram communication protocol for the simultaneous exchange of real-time data and non-real-time data between client computer 112 and data network 2119. Thus, the remote access connection Cₚ may be referred to herein as the tinygram protocol connection Cₚ. The tinygram communication protocol is advantageously configured to minimize real-time latency, i.e. the time-delay experienced by real-time frames in transmission (a) from client computer 112 to real-time nodes 2124 on data network 2119, and (b) from real-time nodes 2124 on data network 2119 to client computer 112. For example, modem 2113 performs minimal buffering of real-time data, and embeds the real-time data into tinygrams with priority over non-real-time data. In the reverse direction, modem 2113 presents real-time frames to client computer 112 with priority over non-real-time frames. Proxy server 2120 employs similar real-time data prioritizing mechanisms. Thus, the user of client computer 112 may experience improved real-time communication performance in a concurrent real-time and non-real-time data communication session as compared to prior art remote access technologies. Proxy server 2120 is configured to support a number of client computers of which client computer 112 is a representative.

In one embodiment, modem 2113 presents to client computer 112 a conventional modem interface. Thus, client computer 112 may use a conventional device driver to communicate with modem 2113. In another embodiment, modem 2113 may comprise a conventional modem (e.g. a v.80 modem) controlled by a specialized software device driver.

Modem 2113 is coupled to a client computer 112 through any of a variety of interconnection technologies such as an RS-232 serial port. Modem 2113 may be configured for insertion into an expansion slot of client computer 112. In an alternate embodiment, modem 2113 may be considered part of client computer 112 as, e.g., when modem 2113 is incorporated on the motherboard of client computer 112.

Client computer 112 may be represented by any of a variety of computing devices such as a personal computer, a notebook computer, a workstation, etc. Client computer 112 may be coupled to a real-time device 2110. Real-time device 2110 may comprise a physical phone such as physical user phone 90 and/or a virtual phone such as virtual phone 94.

Modem 2113 is also configured for coupling to switching network 115 through a subscriber connection SC#1. Switching network 115 may be the Public Switched Telephone Network (PSTN). Subscriber connection SC#1 may be an analog or digital telephone line. It is noted that the subscriber connection SC#1 is not necessarily a wired connection. For example, the subscriber connection SC#1 may be achieved by a radio link.

Modem 2117 may be any of a variety of conventional modems such as, e.g., a 28.8K modem, a 56.6K modem, a v.80 modem, etc. Modem 2117 is configured for coupling to switching network 115 through a subscriber connection SC#2. The subscriber connection SC#2 may be an analog or digital telephone line. Modem 2117 and client modem 2113 communicate across the switching network 115 using a conventional data transfer protocol. The data transfer protocol may be synchronous or asynchronous. Synch PPP is one example of a synchronous data transfer protocol.

Modem 2117 also couples to remote access server (RAS) 118. RAS 118 may be a conventional remote access server such as those which are typically located at an Internet Service Provider's Point-of-Presence (POP). RAS 118 provides remote client computers with access to data network 2119. Thus, RAS 118 typically supports a whole bank of modems. However, only one modem, i.e. modem 2117, is depicted for the sake of simplicity. RAS 118 couples to data network 2119. Data network 2119 comprises a system of interconnected computers or computer networks such as the Internet 125.

Proxy server 2120 also couples to data network 2119, and performs multiplexing/demultiplexing which is logically complementary to the demultiplexing/multiplexing performed by modem 2113. Proxy server 2120 represents the client computer 112 to data network 2119. Data frames (i.e. real-time frames and non-real-time frames) generated by client computer 112 and destined for data network 2119 are embedded into a first stream of tinygrams, and transmitted to proxy server 2120 by modem 2113. Proxy server 2120 reconstructs the data frames and transmits them onto data network 2119. Thus, data network 2119 sees proxy server 2120 as the physical network source of data transmissions from client computer 112. Therefore, any response communications (i.e. non-real-time frames generated by non-real-time nodes 2123 and/or real-time frames generated by real-time nodes 2124) destined for client computer 112 may be automatically directed to proxy server 2120 by ordinary IP routing mechanisms. Proxy server 2120 multiplexes the returning real-time frames and non-real-time frames into a second stream of tinygrams, and transmits the second stream of tinygrams to client modem 2113 through the remote access connection. The multiplexing scheme employed by proxy server 2120 forwards real-time data ahead of non-real-time data when generating tinygrams, and thus, advantageously contributes to the minimization of real-time latency in the return path to client computer 112.

It is noted that a VoIP terminal (e.g. real-time node 2124-1) may initiate a real-time dialog with client computer 112 through proxy server 2120. For example, the VoIP terminal may attempt to connect to client computer 112, and the connection may be intercepted by proxy server 2120. Proxy server 2120 may maintain a record of client computers that are currently connected to proxy server 2120. Proxy server 2120 may forward the connection request to client computer 112. The VoIP terminal may then initiate transmission of real-time frames, which are addressed for client computer 112, via proxy server 2120. As described above, proxy server 2120 multiplexes the real-time frames with non-real-time frames into a second stream of tinygrams.

Client computer 112 may perform simultaneous real-time communication with real-time nodes 2124 and regular data communication with non-real-time nodes 2123 using proxy server 2120 as an intermediary.

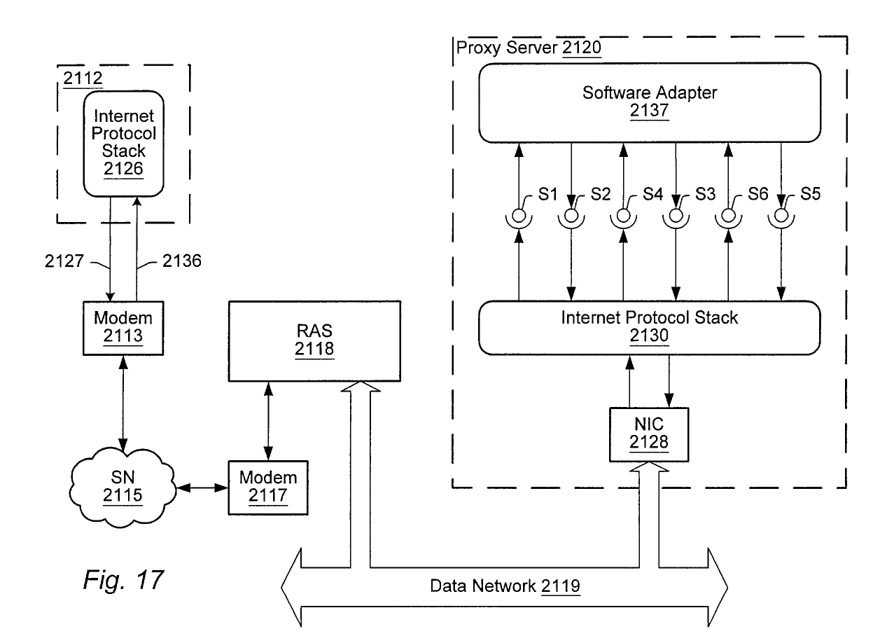

According to a first embodiment shown in FIG. 17, proxy server 2120 comprises a host computer coupled to data network 2119 through a network interface card 2128, and configured to execute software including an Internet Protocol Stack 2130 and software adapter 2137. Network interface card 2128 may be a conventional network interface device such as an Ethernet card. Internet Protocol Stack 2130 may be a conventional system of protocol modules which handle IP-based communications for software adapter 2137. Internet Protocol Stack 2130 may be part of an operating system which executes on the host computer. The host computer derives its “proxy” functionality from software adapter 2137. Any sufficiently powerful computer may be loaded with software adapter 2137, and thereby, operate as proxy server 2120.

Software adapter 2137 is logically complementary to client modem 2113, i.e. software adapter 2137 performs multiplexing which is complementary to the demultiplexing performed by client modem 2113, and vice versa.

Modem 2113 receives a first PPP stream 2127 from client computer 112, i.e. from an Internet Protocol Stack 2126 running on client computer 112. The first PPP stream 2127 may include real-time frames (i.e. RTP and/or CRTP frames) and non-real-time frames. The non-real-time frames will be referred to herein as regular data frames. The real-time frames and the regular data frames comprising the first PPP stream 2127 may be addressed to arbitrary IP destinations. For example, the destination IP addresses of the real-time frames may correspond to one or more of the real-time nodes 2124, and the destination IP addresses of the regular data frames may correspond to one or more of the non-real-time nodes 2123.

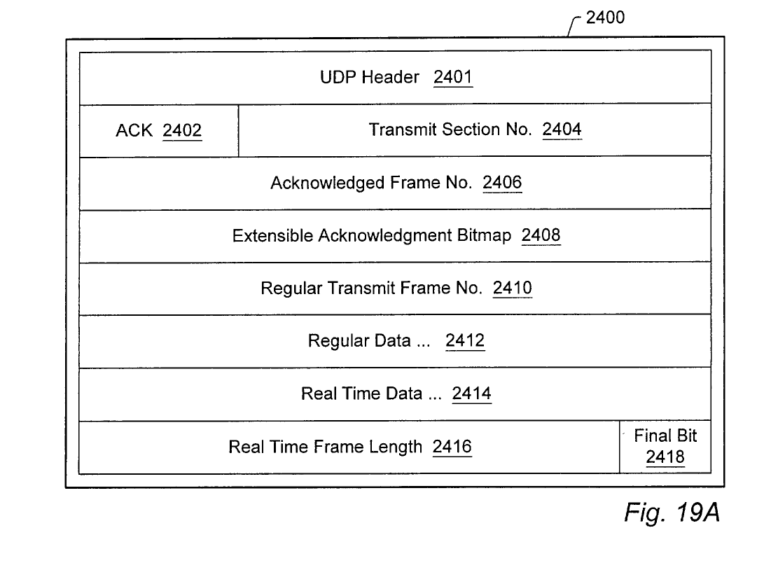

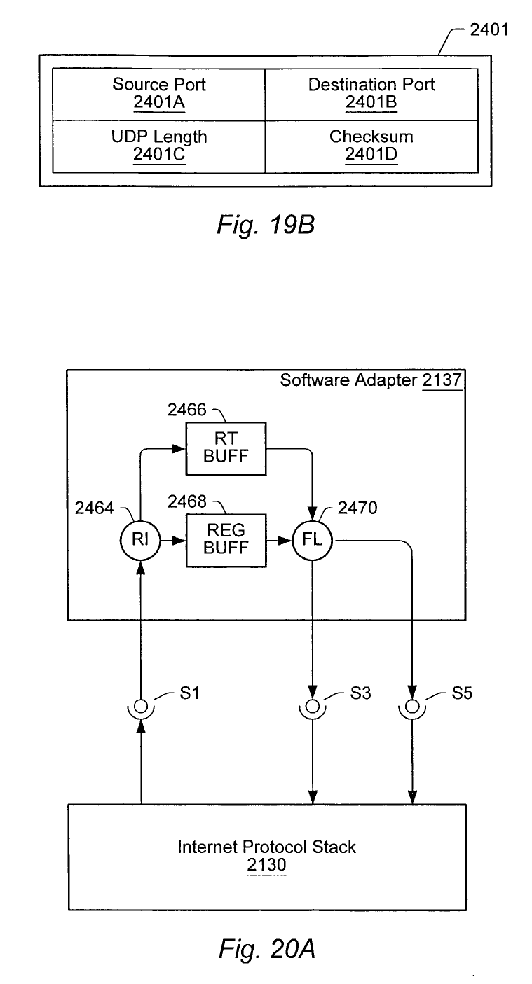

Modem 2113 multiplexes real-time data from the real-time frames and regular data from the regular data frames into a first stream of UDP tinygrams, i.e. tinygrams formatted according to User Datagram Protocol. Modem 2113 transmits the first stream of UDP tinygrams to software adapter 2137 through a connection comprising subscriber connection SC#1, switching network 115, subscriber connection SC#2, modem 2117, RAS 118, data network 2119, network interface card 2128 and Internet Protocol Stack 2130. (See FIGS. 19A & 19B for the format of a generic UDP tinygram according to one embodiment.) Modem 2113 may internally store the IP address and port number of proxy server 2120 and software adapter 2137 respectively. A user of client computer 112 may supply this information to modem 2113. For example, the user may issue a v.80 command line operation to supply modem 2113 with the IP address and/or port number of the proxy server 2120. Modem 2113 uses the stored IP address and port number to address the first stream of UDP tinygrams to software adapter 2137. Thus, normal IP routing mechanisms are responsible for delivering the first stream of UDP tinygrams from RAS 118 to software adapter 2137 through data network 2119. The first stream of UDP tinygrams may be delivered to software adapter 2137 through a UDP socket S1.

Software adapter 2137 demultiplexes the real-time data and regular data from the first stream of UDP tinygrams, and thereby recovers the same real-time frames and regular data frames which were supplied to modem 2113 in first PPP stream 2127. After recovering the real-time frames and the regular data frames from the UDP tinygrams, software adapter 2137 sends the real-time frames and regular data frames to their respective IP destinations using Internet Protocol Stack 2130.

The real-time frames may be provided to Internet Protocol Stack 2130 through UDP socket S3 for transmission to one or more of the real-time nodes 2124 (e.g. telephony gateway 123). The real-time frames may be transmitted to the one or more real-time nodes 2124 through data network 2119 using standard IP routing mechanisms. The regular data frames recovered by software adapter 2137 may be provided to Internet Protocol Stack 2130 through one or more sockets S5 for transmission to one or more of non-real-time nodes 2123 (e.g. VPN server 122). Since the regular data frames may include UDP frames and/or TCP frames, sockets S5 may include UDP sockets and/or TCP sockets. Again, the regular data frames may be transmitted to non-real-time nodes 2123 through data network 2119 using standard IP routing mechanisms.

It is noted that modem 2113 and software adapter 2137 implement mechanisms for forwarding real-time data ahead of regular data. Thus, software adapter 2137 may regenerate the real-time frames and regular data frames in an order different from the order in which they were presented to modem 2113 in first PPP stream 2127. In the reverse direction, one or more of the real-time nodes 2124 may transmit real-time frames (destined for client computer 112) onto data network 2119. Normal IP routing mechanisms are responsible for delivering the real-time frames to software adapter 2137 in proxy server 2120. The real-time frames may be presented to software adapter 2137 through UDP socket S4. In addition, one or more of non-real-time nodes 2123 connected to data network 2119 may transmit regular (e.g. UDP and/or TCP) frames (destined for client computer 112) onto data network 2119. Again, normal IP routing mechanisms are responsible for delivering the non-real-time frames to software adapter 2137. These regular data frames may be presented to software adapter 2137 through one or more sockets S6.

Software adapter 2137 multiplexes real-time data from the real-time frames and regular data from the regular data frames into a second stream of UDP tinygrams. The second stream of UDP tinygrams may be presented to Internet Protocol Stack 2130 through UDP socket S2 for transmission to modem 2113. The second stream of UDP tinygrams are addressed to client modem 2113. Thus, normal IP routing mechanisms are responsible for delivering the second stream of UDP frames from software adapter 2137 to RAS 118 through data network 2119. RAS 118 passes the second stream of UDP tinygrams to modem 2117 for transmission to modem 2113 through switching network 115.

Modem 2113 demultiplexes the real-time data and the regular data from the second stream of UDP tinygrams, and regenerates the same real-time frames and regular data frames which were presented to software adapter 2137 through sockets S4 and S6. These real-time frames and regular data frames are provided in a second PPP stream 2136 to client computer 112, i.e. to Internet Protocol Stack 2126 running on client computer 112. Again, it is noted that software adapter 2137 and modem 2113 implement mechanisms for forwarding real-time data ahead of regular data. Therefore, modem 2113 may present the real-time frames and regular data frames to client computer 112 in an order different from the order in which these frames were presented to software adapter 2137 through sockets S4 and S6.

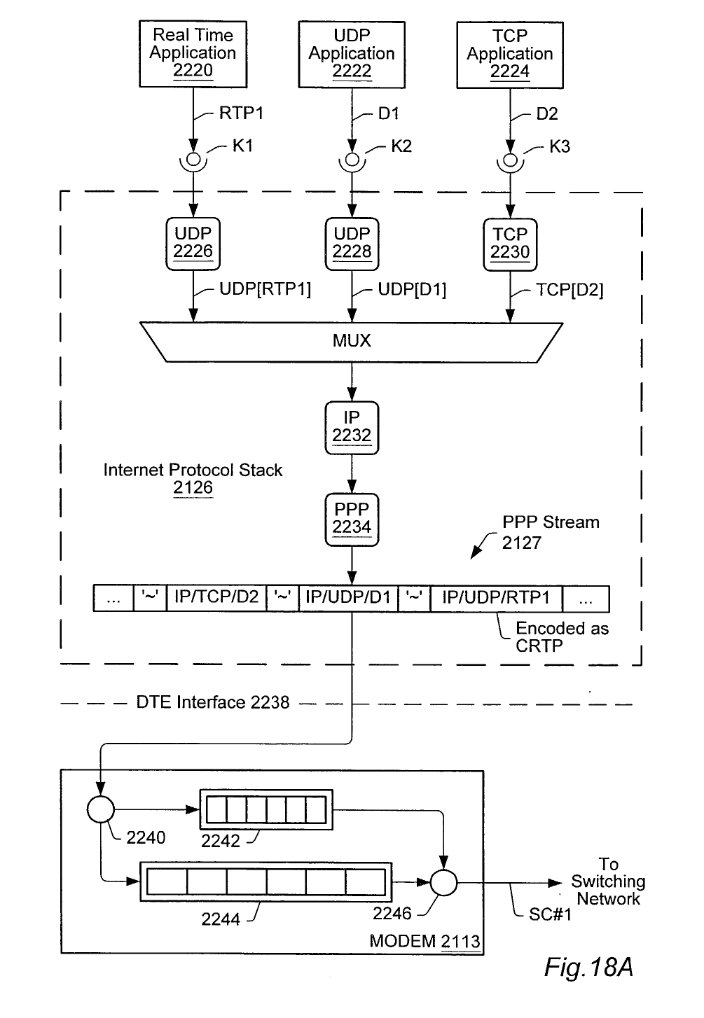

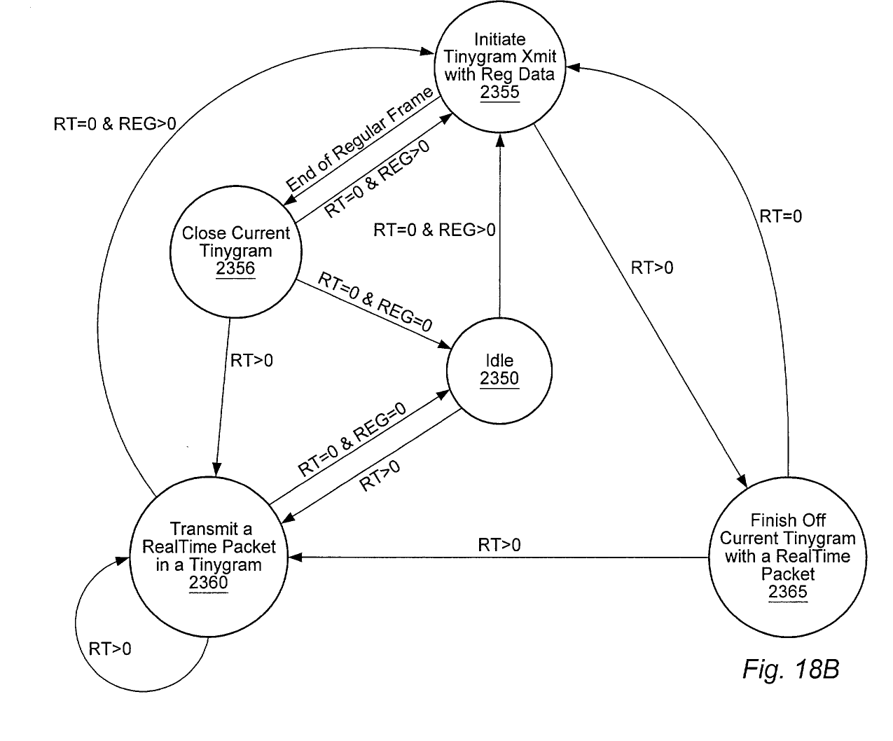

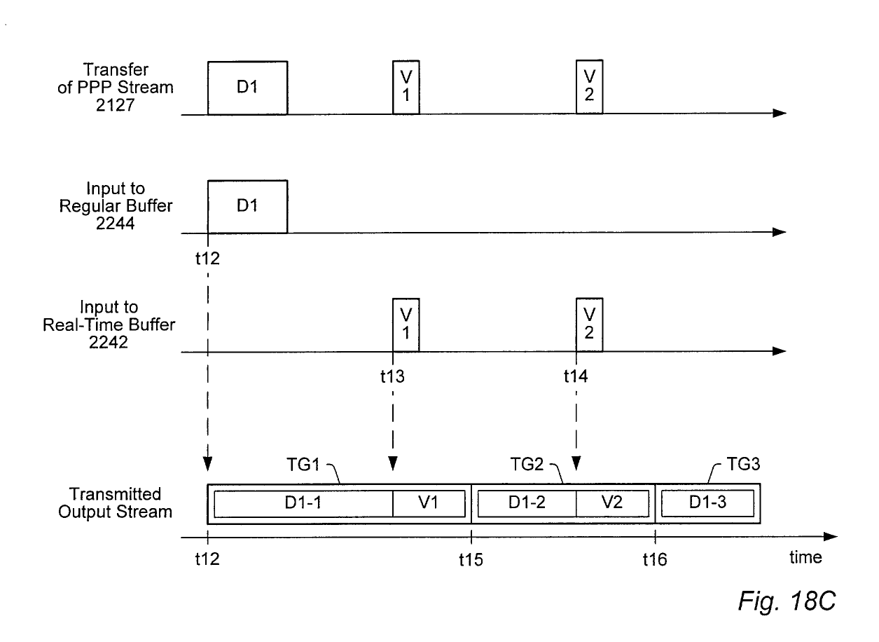

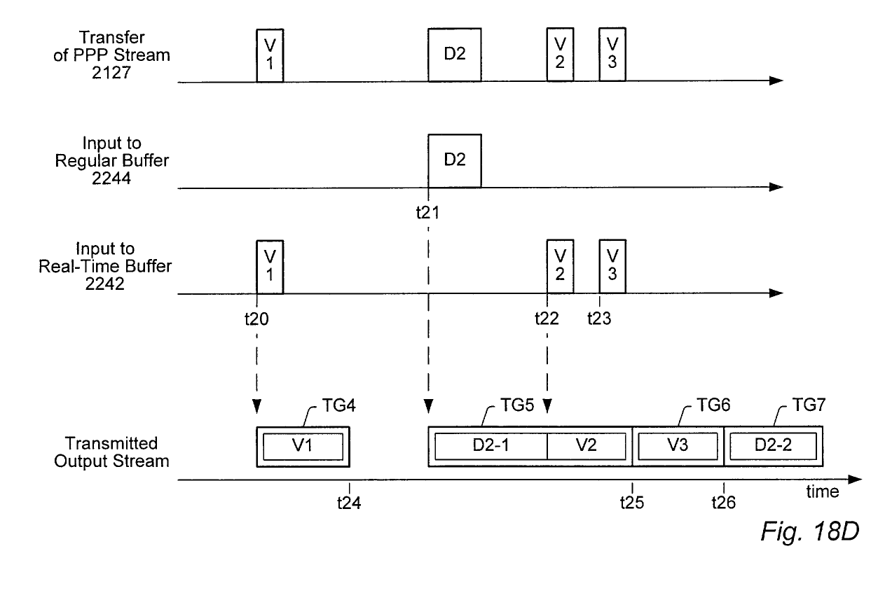

FIG. 18A: Client Modem Transmission

FIG. 18A illustrates a preferred embodiment for the transmission architecture of modem 2113 and a typical software arrangement for client computer 112. The elements depicted in FIG. 18A above the dotted line labeled DTE interface 2238 are software modules which execute on client computer 112.

Client computer 112 includes a processor and a memory which provide for the execution of an arbitrary number of software applications. For example, client computer 112 may execute real-time applications, UDP applications, TCP applications, etc. Telephony client 91 is a real-time application. Non-real-time application 92 of FIG. 6 may include UDP applications and TCP applications. VPN client 93 may be a TCP application.

Real-time application 2220 generates a stream of RTP packets. One of these packets RTP1 is especially denoted in passage to socket K1. UDP application 2222 is illustrative of UDP applications which are non-real-time in nature. UDP application 2222 is shown passing a data packet D1 to socket K2. TCP application 2224 generates a bit stream. A portion D2 of this bit stream is shown in transit to socket K3.

Internet Protocol Stack 2126 also executes on client computer 112. Internet Protocol Stack 2126 comprises a multi-layer system of protocol modules. Internet Protocol Stack 2126 may be part of a conventional operating system running on client computer 112. The Internet Protocol Stack mediates data transfers for software applications running on client computer 112.

UDP module 2226 encapsulates the RTP packet RTP1 received from socket K1. UDP module 2228 encapsulates the packet D1 received from socket K2. TCP module 2230 encapsulates the data D2 received from socket K3. The UDP and TCP encapsulated packets generated by the transport layer modules including modules 2226-2230 are multiplexed and provided to IP module 2232. IP module 2232 encapsulates the UDP and TCP packets as IP packets. The resulting stream of EP packets are provided to PPP module 2234. PPP module 2234 encodes the IP packet stream as a stream of PPP frames. A portion of the PPP stream 2127 is shown. Observe that frames in the PPP stream are separated by the ASCII tilde character, i.e. 0x7E.

FIG. 14A depicts the frame format for the Point-to-Point protocol. The generic PPP frame 1015 includes a header field 1151, a protocol field 1152, a data field 1153 and a check sum 1154. FIG. 14B depicts the format of header field 1151. Header field 1151 includes an address byte 1151B and a control byte 1151C. The address byte 1151B may take the value 0xFF. The control byte 1151C may take the value 0x03. Check sum 1154 provides for error detection at the PPP receiver. The protocol field 1152 defines the protocol(s) used to generate data field 1153. Data field 1153 contains the data payload of the PPP frame 1015.

The PPP stream 2127 generated by the PPP module may include TCP/IP encapsulated data. One such frame denoted IP/TCP/D2 encapsulates data D2 which originated from TCP application 2224. The PPP stream 2127 may also include IP/UDP encapsulated data. One such frame denoted IP/UDP/D1 encapsulates data D1 which originated from the UDP application 2222. The PPP stream may additionally include IP/UDP/RTP encapsulated data. One such frame denoted IP/UDP/RTP1 encapsulates RTP packet RTP1 which originated from real-time application 2220.

The PPP module may compress the redundant header information of IP/UDP/RTP encapsulated frames using a protocol such as, e.g., the Compressed Real-Time Protocol (CRTP). The PPP module provides the PPP stream 2127 to modem 2113 through DTE interface 2238.

Modem 2113 comprises demultiplexing logic 2240, real-time buffer 2242, regular buffer 2244, and transmit logic 2246. It is noted that the functions performed by demultiplexing logic 2240 and transmit logic 2246 may be implemented by a microcontroller (or processor) situated within modem 2113.

Demultiplexing logic 2240 receives the PPP stream 2127 from the PPP module 2234, and demultiplexes the PPP stream in real time. Demultiplexing logic 2240 scans the PPP stream for the header field 1151 to determine the beginning of a new PPP frame. Once a header field has been detected, the subsequent protocol field 1152 is examined. If the protocol field indicates that the newly detected PPP frame encapsulates real-time data (i.e. RTP or CRTP data), demultiplexing logic 2240 stores the PPP frame into the real-time buffer 2242. If the protocol field indicates an encapsulation corresponding to non-real-time data protocol(s), i.e. protocols other than RTP or CRTP, demultiplexing logic 2240 stores the newly detected PPP frame into regular buffer 2244. It is noted that characters which make up the PPP stream 2127 are received by demultiplexing logic 2240 and very quickly stored in either real-time buffer 2242 or regular buffer 2244.

When real-time buffer 2242 is full, demultiplexing logic 2240 may be configured to discard one or more real-time frames previously stored in real-time buffer 2242 to make room for newly arriving real-time frames. In other words, a newly arriving real-time frame from the first PPP stream 2127 may overwrite one or more old real-time frames previously stored in the real-time buffer 2242. Preferably, the discarded real-time frames are the ones which are oldest chronologically, i.e. the ones which have resided in real-time buffer for the longest duration.

In contrast, demultiplexing logic 2240 is preferably configured to discard any regular data frames arriving in the PPP stream 2127 when regular buffer 2244 is full. Regular frames previously stored in regular buffer 2244 are retained until they may be transmitted by transmit logic 2246.

In alternate embodiments of demultiplexing logic 2240, other strategies are contemplated for handling (a) newly arriving real-time frames when real-time buffer 2242 is full, and/or (b) newly arriving regular data frames when regular buffer 2244 is full.

Real-time buffer 2242 and regular buffer 2244 may comprise Random Access Memory (RAM) such as Dynamic RAM (DRAM), or more specialized memory such as First-In-First-Out Buffers (FIFOs). Real-time buffer 2242 and regular buffer 2244 may comprise distinct sections of a common memory space accessible by a microcontroller.

Transmit logic 2246 accesses real-time data and regular data from the real-time buffer 2242 and regular buffer 2244 respectively, and multiplexes the real-time data and regular data into UDP tinygrams. Transmit logic 2246 transmits the UDP tinygrams onto subscriber connection SC#1.

FIG. 19A illustrates one possible format for a generic UDP tinygram 2400 according to the present invention. The generic UDP tinygram 2400 comprises a UDP header field 2401, an acknowledgement type field (ACK) 2402, a transmit section number (TSN) field 2404, an acknowledged frame number (AFN) field 2406, an extensible acknowledgement bitmap (EAB) 2408, a regular transmit frame number (TFN) field 2410, a regular data field 2412, a real-time data field 2414, a real-time frame length (RTLEN) field 2416 and a final bit 2418.

FIG. 19B illustrates the format of UDP header field 2401. UDP header field 2401 comprises a source port field 2401A, a destination port field 2401B, a UDP length field 2401C and a checksum field 2401D. Transmit logic 2246 sets the value of destination port field 2401B to correspond to the port number of software adapter 2137 on proxy server 2120.

FIG. 18B illustrates a state diagram for transmit logic 2246. Transmit logic 2246 may initially occupy idle state 2350 while waiting for the arrival of data (real-time or regular data). In addition, transmit logic 2246 may enter idle state 2350 from various other states in response to various conditions which will be described in detail below. In response to real-time buffer 2242 being empty and regular buffer 2244 attaining a nonempty condition, transmit logic 2246 moves from idle state 2350 to state 2355. In state 2355, transmit logic 2246 initiates transmission of regular data onto subscriber connection SC#1 according to the tinygram format shown in FIG. 19A. Transmit logic 2246 transmits a tinygram header followed by regular data accessed from regular buffer 2244. The tinygram header may include UDP header 2401, acknowledgement type field 2402, transmit section number field 2404, and may also include acknowledged frame number 2406 and extensible acknowledgment bitmap 2408. The transmitted regular data makes up regular data field 2412 of the tinygram.

Transmit logic 2246 scans the regular-data received from regular buffer 2244 for a frame separator flag (e.g. the PPP frame separator byte) indicating the end of a regular data frame. Assuming that real-time buffer 2242 remains empty, transmit logic 2246 continues to transmit regular data bytes accessed from regular buffer 2244 until the frame separator flag is detected. When transmit logic 2246 detects the frame separator flag, transmit logic 2246 moves to state 2356. In state 2356, transmit logic 2246 closes the current tinygram by (a) transmitting a zero value for real-time frame length field 2416 and (b) transmitting a one value for the final bit 2418. The real-time frame length being set equal to zero indicates to a tinygram receiver (e.g. software adapter 2137) that real-time data field 2414 is not present in the current tinygram. The final bit 2418 being set equal to one indicates to the tinygram receiver that the current tinygram contains the concluding portion of a regular data frame.

After closing transmission of the current tinygram in state 2356, transmit logic 2246 determines if real-time buffer 2242 is still empty. If real-time buffer 2242 is still empty, transmit logic 2246 moves either to idle state 2350 or state 2355 depending on the empty/non-empty condition of regular buffer 2244. If regular buffer 2244 is empty, transmit logic 2246 moves to idle state 2350. If regular buffer 2244 is non-empty, transmit logic 2246 moves to state 2355 to transmit additional regular data in another tinygram.

After closing transmission of the current tinygram in state 2356, transmit logic 2246 may find that real-time buffer 2242 is non-empty. In this case, transmit logic 2246 moves to state 2360. In state 2360, transmit logic 2246 transmits a single real-time frame from real-time buffer 2242 onto subscriber connection SC#1 according to the tinygram format shown in FIG. 19A. In a preferred embodiment, transmit logic 2246 transmits:

(a) an acknowledge type value in acknowledgement type field 2402 indicating a full acknowledgement, a partial acknowledgment, or no acknowledgement;

(b) the value 31 decimal in transmit section number field 2404;

(c) an acknowledge frame number 2406 in the cases where the acknowledge type field 2402 indicates full or partial acknowledgement;

(d) an extensible acknowledgement bitmap 2408 in the case that the acknowledge type field 2402 indicates a partial acknowledgement;

(e) one complete real-time frame comprising real-time data field 2414, and

(f) the byte length of the real-time frame transmitted in real-time data field 2414.

The value 31 decimal for transmit section number field 2404 indicates to the tinygram receiver that the current tinygram does not contain regular transmit frame number field 2410 or regular data field 2412. Thus, the current tinygram is dedicated for the transmission of a single real-time frame from real-time buffer 2242 onto subscriber connection SC#1.

After transmitting a “real-time” tinygram in state 2360, transmit logic 2246 determines whether real-time buffer 2242 is empty or non-empty. If real-time buffer 2242 is non-empty, transmit logic 2246 returns to state 2360 to transmit another real-time frame in another tinygram. Transmit logic 2246 may repeatedly visit state 2360 transmitting a stream of real-time tinygrams where each real-time tinygram contains a single real-time frame.

After transmitting a real-time tinygram in state 2360, transmit logic 2246 may find that real-time buffer 2242 is empty. In this case, transmit logic 2246 moves into idle state 2350 or state 2355 depending on the empty or non-empty condition of regular buffer 2244. If regular buffer 2244 is empty, transmit logic 2246 moves to idle state 2350. If regular buffer 2244 is non-empty, transmit logic 2246 moves to state 2355 to transmit more regular data in a new tinygram.

In the preferred embodiment, regular buffer 2244 is declared to be non-empty when the number of bytes stored in regular buffer 2244 exceeds a first threshold value, and declared to be empty when the number of bytes in regular buffer 2244 reaches zero. The threshold value may be chosen to be a small integer such as two or three to guarantee that transmit logic 2246 does not run out of regular data to transmit. Two or three byte transmission times at the low subscriber connection rate allows time for more data to be provided by client computer 112 (since the DTE interface 2238 has a much higher data rate). Often the delay between the first and second bytes of a frame delivered across the DTE interface 2238 may be larger than the delay between any other pair of successive bytes.

Similarly, real-time buffer 2242 is declared to be non-empty when the number of bytes stored in real-time buffer 2242 exceeds a second threshold value, and declared to be empty when the number of bytes in real-time buffer 2242 reaches zero. Again, the second threshold value may be a small integer value such as two or three.

If real-time buffer 2242 becomes non-empty while transmit logic 2246 resides in idle state 2350, transmit logic 2246 moves to state 2360. The operation of state 2360 has already been described above.

If real-time buffer 2242 becomes non-empty while transmit logic resides in state 2355, transmit logic 2246 discontinues transmission of regular data for a current tinygram, and moves into state 2365. In state 2365, transmit logic 2246 completes transmission of the current tinygram by transmitting a single real-time frame from real-time buffer 2242 onto subscriber connection SC#1. In particular, transmit logic 2246 transmits (a) a single real-time frame which defines real-time data field 2414 for the current tinygram, (b) the length of the real-time data field 2414, and (c) a binary zero value for final bit 2418. The binary zero value for final bit 2418 indicates to the tinygram receiver that the current tinygram does not contain the concluding portion of a regular data frame. In response to receiving the zero final bit of the current tinygram, the tinygram receiver may wait for succeeding tinygram(s) to deliver remaining portions of the regular data frame. Preferably, the transition from state 2355 to state 2365 is so fast that no discontinuity is observed in the output character stream (transmitted by transmit logic 2246) between regular data field 2412 and real-time data field 2414.

Observe that the current tinygram transmitted in states 2355 and 2365 contains both regular data and a whole real-time frame and thus may referred to as a “hybrid” tinygram. The regular data comprises regular data field 2412, and the whole real-time frame comprises real-time field 2414.

After completing transmission of a current tinygram in state 2365, transmit logic determines whether real-time buffer 2242 is empty or non-empty. If real-time buffer 2242 is found to be non-empty, transmit logic 2246 moves to state 2360 which has been described earlier. If real-time buffer 2242 is found to be empty, transmit logic 2246 returns to state 2355 to initiate transmission of another tinygram containing more regular data.

In summary, it is observed that transmit logic 2246 advantageously minimizes real-time latency (i.e. the time-delay experienced by real-time data) in modem 2113 by transmitting real-time data (a) as soon as it becomes available in real-time buffer 2242, and (b) with priority over any regular data which may be available in regular buffer 2244. For example, if real-time data becomes available (i.e. real-time buffer 2242 becomes nonempty) during a transmission of regular data, the regular data transmission is interrupted and the current tinygram is concluded by transmitting a real-time frame as shown in states 2355 and 2365. In addition, after finishing transmission of a tinygram in any of states 2356, 2360 or 2365, transmit logic 2246 determines if real-time data is available for transmission (i.e. if real-time buffer 2242 is non-empty). If real-time buffer 2242 is non-empty, transmit logic 2246 moves to state 2360 to transmit a “real-time” tinygram, i.e. a tinygram containing a real-time frame and no regular data. Regular data may be transmitted in a tinygram only if real-time data is not available.

Thus, transmit logic 2246 implements a tinygram transmission channel (to software adapter 2137) with a real-time subchannel and a regular data subchannel. The bandwidth allocated to the real-time subchannel may expand immediately in response to the availability of real-time data. Also, the bandwidth of the real-time subchannel may advantageously expand to consume the entire bandwidth of the subscriber connection SC#1 minus tinygram overhead bandwidth, since real-time transmissions take priority over regular data transmissions.

It is noted that transmit logic 2246 employs a conventional protocol for data exchange with modem 2117. For example, a synchronous protocol such as Synch PPP may be used as the data exchange protocol. Asynchronous protocols may be used as well.

FIG. 18C illustrates the multiplexing performed by transmit logic 2246 with a typical example. FIG. 1 SC includes several graphs. The topmost graph illustrates the instantaneous rate of transfer of the first PPP stream 2127 across the DTE interface 2238. PPP stream 2127 is illustrated with three frames in succession, i.e. regular frame D1, real-time frame V1, and real-time frame V2. Demultiplexing logic 2240 dispatches the regular frame D1 to regular buffer 2244 as shown in the second graph, and dispatches real-time frames V1 and V2 to real-time buffer 2242 as shown in the third graph.

For simplicity, it is assumed that real-time buffer 2242 and regular buffer 2244 are empty prior to time t₁₂ when the first byte of regular frame D1 is stored into regular buffer 2244. After a threshold number of bytes of regular data frame D1 have been stored into regular buffer 2244, transmit logic 2246 moves into state 2355 and starts to transmit regular data frame D1 in a first tinygram TG1. The fourth graph illustrates the transmitted output stream generated by transmit logic 2246.

When real-time buffer 2242 becomes non-empty due to the arrival of the initial bytes of real-time frame V1 at time t₁₃, transmit logic 2246 discontinues transmission of regular data and completes the first tinygram TG1 by transmitting the real-time frame V1, the real-time length field 2416 (not shown) and final bit 2418 (not shown). Recall that real-time buffer 2242 is declared to be non-empty when a small number (e.g. two or three) bytes have accumulated in real-time buffer 2242. Since transmission of a real-time frame is initiated when the small number of bytes have accumulated, the real-time frame experiences a minimal delay due to buffering in modem 2113. Transmit logic 2246 determines the value of real-time length field 2416 by counting the number of bytes in the real-time frame V1. The positioning of real-time length field 2416 after real-time data field 2414 in the tinygram format advantageously allows transmit logic 2246 to inject real-time data into the transmitted output stream as soon as it becomes available (i.e. as soon as real-time buffer 2242 becomes non-empty). The computation of the real-time length field 2414 does not delay transmission of the real-time data. Final bit 2418 is set to zero to indicate to the tinygram receiver that the first tinygram TG1 does not contain the concluding portion of regular data frame D1.

When transmission of the first tinygram TG1 is completed at time t₁₅, transmit logic 2246 detects that real-time buffer 2242 is empty and regular buffer 2244 is nonempty. Thus, transmit logic 2246 resumes transmission of regular data frame D1. Transmit logic 2246 transmits a second portion D1-2 of regular data frame D1 in a second tinygram TG2. In response to real-time buffer 2242 becoming non-empty at time t₁₄ (due to the arrival of the first few bytes of real-time frame V2 into real-time buffer 2242), transmit logic 2246 again interrupts transmission of regular data frame D1 and transmits real-time frame V2, real-time length field 2416 and final bit 2418 to close out the second tinygram TG2.

When transmission of the second tinygram TG2 is completed at time t₁₆, transmit logic 2246 again detects that real-time buffer 2242 is empty and regular buffer 2244 is non-empty. Thus, transmit logic 2246 resumes transmission of regular data frame D1. Transmit logic 2246 transmits a third portion D1-3 of regular data frame D1 in a third tinygram TG3. It is assumed that transmit logic 2246 reaches the end of the regular data frame D1 as indicated by a frame separator flag before (not shown) any additional real-time frames arrive. Thus, transmit logic 2246 closes the transmission of tinygram TG3 with a zero real-time length field 2416 and a final bit set to one. The zero real-time length field 2416 indicates the real-time data field 2414 is not present in tinygram TG3. The final bit set to one indicates that tinygram TG3 contains the concluding portion of regular data frame D1.

In the current example, regular frame D1 is fragmented into three sections, i.e. D1-1, D1-2 and D1-3, which are each transmitted in a separate tinygram. Because the tinygrams TG1, TG2 and TG3 which deliver the sections of regular frame D1 may not arrive at the tinygram receiver (e.g. software adapter 2137) in the order they are transmitted, a mechanism must be provided for the tinygram receiver to reorder the received tinygrams. Furthermore, suppose that another regular data frame D2 (not shown) is similarly fragmented into multiple sections D2-1, D2-2, D2-3 which are transmitted in corresponding tinygrams TG4, TG5, TG6. While tinygrams TG4-TG6 may be transmitted after tinygrams TG1-TG3, they may be reordered in transit to the tinygram receiver. Thus, a mechanism must be provided for the tinygram receiver to correctly associate received tinygrams into groups, where each group corresponds to a transmitted regular data frame. Transmit logic 2246 uses transmit section number field 2404 and the regular transmit packet number field 2410 in the tinygram format to implement the requisite mechanisms.

As described above, in state 2355 transmit logic 2246 initiates transmission of a tinygram containing regular data. As part of the tinygram transmission in state 2355, transmit logic 2246 sets the transmit section number field 2404 and regular transmit frame number field 2410. Transmit logic 2246 sets the value of the transmit section number field 2404 based on the value of an internal variable SecNum, and sets the value of the regular transmit frame number field 2410 based on the value of another internal variable RegFormNum.

When transmit logic 2246 completes transmission of a tinygram in state 2356, transmit logic 2246 increments the variable RegFormNum, and sets the variable SecNum equal to zero. Recall that the tinygram transmitted from state 2356 contains the concluding section of a regular data frame.

When transmit logic 2246 completes transmission of a tinygram in state 2365, transmit logic 2246 increments the variable SecNum. This is because the tinygram transmitted from state 2365 does not contain the concluding section of a regular data frame, and thus, there remains at least one more tinygram to be transmitted with the current regular frame number (i.e. with the current value of the variable RegFormNum). In idle state 2350, transmit logic 2246 sets variable SecNum to zero.

In the preferred embodiment, regular transmit frame number field 2410 comprises eight bits. Thus, regular transmit frame number field 2410 cycles through the values 0x00 through 0xFF. The transmit section number field 2404 preferably comprises five bits. Thus, transmit section number field 2404 may take any value in the range 0 to 31 decimal. However, the value 31 decimal is reserved and indicates a “real-time” tinygram that contains no regular data. Thus, a regular data frame may be fragmented into up to 31 tinygram sections with transmit section numbers ranging from zero to 30 decimal.

FIG. 18D further illustrates the multiplexing performed by transmit logic 2246 by means of another example. The topmost graph in FIG. 18D illustrates the instantaneous rate of transfer of PPP stream 2127 as it is received by demultiplexing logic 2240. PPP stream 2127 includes a succession of frames, i.e. real-time frame V1, regular frame D2, real-time frame V2 and real-time frame V3. Demultiplexing logic 2240 scans the first PPP stream 2127 so that regular frames are sent to regular buffer 2244 and real-time frames are sent to the real-time buffer 2242. The second graph depicts the arrival of regular frames in regular buffer 2244. The third graph depicts the arrival of real-time frames in real-time buffer 2242. The fourth graph depicts the transmitted output stream generated by transmit logic 2246.

It is noted that real-time frames V1, V2 and V3 become available for transmission at times t₂₀, t₂₂ and t₂₃ respectively, i.e. as soon as demultiplexing logic 2240 completes storage of an initial number of bytes of the respective real-time frame into real-time buffer 2242. In FIG. 18D, it is assumed that transmit logic 2246 is in idle state 2350 prior to the arrival of real-time frame V1 at time t₂₀. This implies that real-time buffer 2242 and regular buffer 2244 are empty.

In response to real-time buffer 2242 becoming non-empty at time t₂₀, transmit logic 2246 moves into state 2360. In state 2360 transmit logic 2246 transmits real-time frame V1 in its own tinygram, i.e. tinygram TG4. The transmit section number field 2404 of tinygram TG4 is set to 31 decimal to indicate that tinygram TG4 contains no regular data. Upon completing transmission of tinygram TG4 at time t₂₄, transmit logic 2246 moves to idle state 2350 in response to the real-time buffer 2242 and regular buffer 2244 both being empty.

Regular data becomes available for transmission at time t₂₁ (due to the arrival of the first few bytes of regular data frame D2 into regular buffer 2244). Thus, transmit logic 2246 moves from idle state 2350 to state 2355. In state 2355, transmit logic 2246 initiates transmission of regular data frame D2 in a tinygram TG5. In response to real-time frame V2 becoming available for transmission at time t₂₂, transmit logic 2246 stops transmission of regular data frame D2 and moves to state 2365. In state 2365 transmit logic 2246 completes transmission of tinygram TG5 by transmitting real-time frame V2. Thus, tinygram TG5 contains a first portion D2-1 of regular data frame D2 and real-time frame V2.

After the arrival of real-time frame V2 and before the end of transmission of tinygram TG5, a third real-time frame V3 arrives in real-time buffer 2242 at time t₂₃. Thus, upon completing transmission of tinygram TG5 at time t₂₅, transmit logic 2246 detects the non-empty condition of real-time buffer 2242 and moves into state 2360. In state 2360, transmit logic 2246 immediately transmits real-time frame V3 in its own tinygram, i.e. tinygram TG6. Thus, real-time frame V3 experiences a minimal delay waiting for transmission of real-time frame V2 within tinygram TG5 to finish.

After completing transmission of tinygram TG6 at time t₂₆, transmit logic 2246 detects that real-time buffer 2242 is empty and regular buffer 2244 is non-empty. Thus, transmit logic 2246 returns to state 2355. In state 2355 transmit logic 2246 transmits a second portion D2-2 of regular data frame D2 in tinygram TG7. Transmit logic 2246 reaches the end of regular data frame D2, and closes tinygram transmission by setting the real-time length field 2416 equal to zero and setting the final bit 2418 equal to one. The real-time length field 2416 being set equal to zero indicates that tinygram TG7 does not contain real-time data. The final bit 2418 being set equal to one indicates that tinygram TG7 contains the concluding portion of a regular data frame, i.e. regular data frame D2.

Software adapter 2137 receives the first stream of tinygrams transmitted by modem 2113. Transmit logic 2246 preferably encapsulates the tinygrams in UDP datagrams. Thus, Internet Protocol Stack 2130 delivers the UDP tinygrams to software adapter 2137 without performing error correction. As described above, the tinygram transmission channel between modem 2113 and proxy server 2120 includes a real-time subchannel and regular data subchannel. The regular data subchannel may carry one or more TCP connections between client computer 112 and one or more of non-real-time nodes 2123. In this case, TCP processing modules in client computer 112 and the one or more non-real-time nodes 2123 perform error correction on the TCP connections. It is noted that the regular data subchannel may also carry UDP transmissions between client computer 112 and one or more of non-real-time nodes 2123.

It is noted that the real-time subchannel may carry the telephony traffic corresponding to the telephony connection Cₜ between telephony client 91 and telephony gateway 123, and the regular data subchannel may carry the regular data traffic corresponding to the VPN connection Cᵥ between VPN client 93 and VPN server 122. The VPN connection Cᵥ itself may carry one or more IP connections between non-real-time applications 92 and data servers 161. (See the description of FIG. 6 above.)

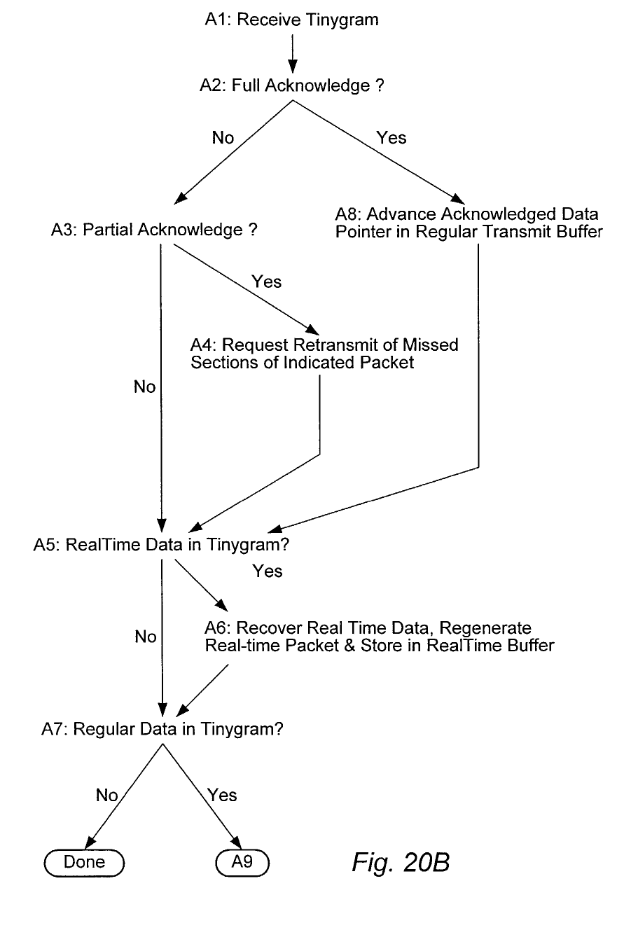

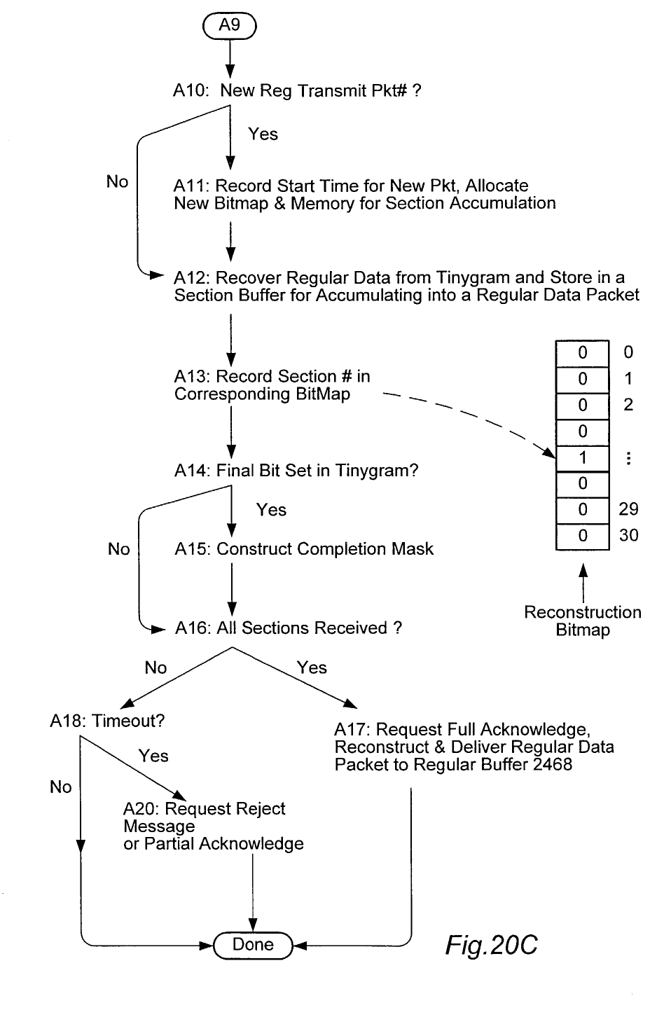

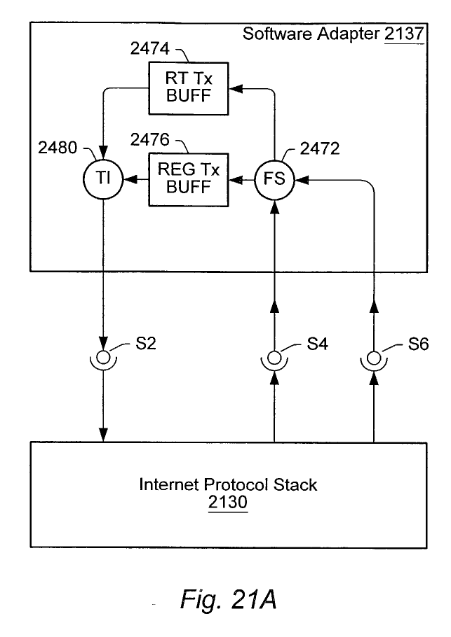

FIG. 20A illustrates how tinygrams are received, demultiplexed, and forwarded by software adapter 2137. Software adapter 2137 includes reception interface 2464, real-time buffer 2466, regular buffer 2468 and forwarding logic 2470. It is noted that the functions performed by reception interface 2464 and forwarding logic 2470 are preferably implemented as one or more processes running on proxy server 2120.

Reception interface 2464 receives the first stream of tinygrams transmitted by modem 2113, and recovers the regular data frames and real-time frames which have been embedded in the first stream of tinygrams. Reception interface 2464 may receive the first stream of tinygrams from Internet Protocol Stack 2130 through socket S1. Reception interface 2464 stores the real-time frames in real-time buffer 2466, and regular data frames in regular buffer 2468.

Forwarding logic 2470 accesses real-time frames from real-time buffer 2466 and forwards the real-time frames to their respective IP destinations through UDP socket S3. Furthermore, forwarding logic 2470 accesses regular data frames from regular buffer 2468 and forwards the regular data frames to their respective IP destinations through one or more sockets denoted S5. Forwarding logic 2470 forwards real-time frames with priority over regular data frames. In other words, forwarding logic 2470 services real-time buffer 2466 (i.e. accesses real-time frames from real-time buffer 2466 and forwards them to their respective destinations) whenever real-time buffer 2466 is non-empty, and services regular data buffer 2468 (i.e. accesses regular data frames from regular data buffer 2468 and forwards them on to their respective destinations) only if real-time buffer 2466 is empty. Thus, real-time frames advantageously experience a minimal wait time in real-time buffer 2466.

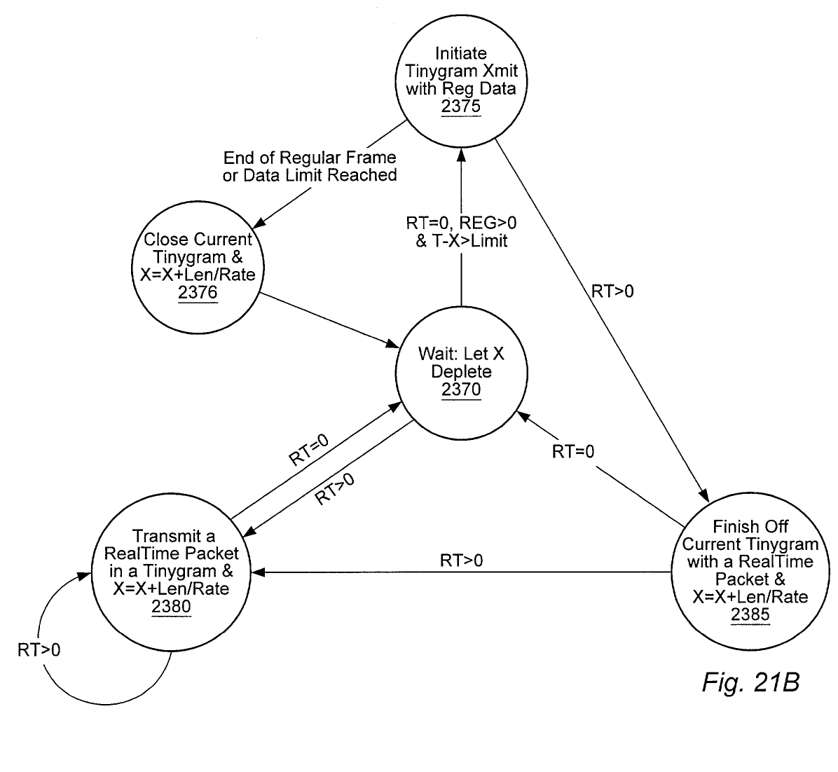

FIG. 21A illustrates the transmission architecture of software adapter 2137. Software adapter 2137 further comprises a frame separator 2472, a real-time transmit buffer 2474, a regular transmit buffer 2476 and a transmission interface 2480.

Frame separator 2472 receives real-time frames from UDP socket S4 and regular data frames from one or more sockets denoted S6. Frame separator 2472 stores the real-time frames in real-time transmit buffer 2474 and stores the regular data frames in regular transmit buffer 2476.

Transmission interface 2480 accesses real-time frames from real-time transmit buffer 2474 and regular data frames from regular transmit buffer 2476, and multiplexes the real-time frames and regular data frames into a second stream of tinygrams which are transmitted to modem 2113 through UDP socket S2. The operation of transmission interface 2480 will be described in more detail later.

FIGS. 20B & 20C illustrate one possible embodiment for the processing of tinygrams performed by reception interface 2464 (of FIG. 20A) in software adapter 2137. It is noted that modem 2113 also receives a second stream of tinygrams transmitted by software adapter 2137. Thus, the following discussion of tinygram reception processing applies equally to modem 2113.

In step A1, reception interface 2464 receives a tinygram from UDP socket S1. In steps A2 and A3, reception interface 2464 examines acknowledgement type field (ACK) 2402 of the tinygram to determine what type of acknowledgement, if any, is included in the current tinygram.

ACK=‘00’ binary indicates that the current tinygram contains no acknowledgement information, i.e. acknowledgement packet no. field 2406 and extensible acknowledgement bitmap 2408 are not present in the current tinygram.

ACK=‘01’ binary indicates that the present tinygram contains a full acknowledgement of a regular data frame previously transmitted by software adapter 2137. In this case, acknowledged frame number field 2406 is present and identifies the previously transmitted regular data frame which is being fully acknowledged. However, extensible acknowledgement bitmap 2408 is not present in this case.

ACK=‘10’ or ‘11’ binary indicates that the present tinygram contains a partial acknowledgement of a regular data frame previously transmitted by software adapter 2137. Partial acknowledgement implies that the other end (e.g. modem 2113) has not received all the tinygram sections comprising a regular data frame within a predetermined timeout period. In this case, the current tinygram preferably includes acknowledged frame number field 2406 and extensible acknowledgement bitmap 2408.

ACK=‘10’ binary indicates that extensible acknowledgement bitmap 2408 comprises 8 bits. ACK=‘11’ binary indicates that extensible acknowledgement bitmap 2408 comprises 16 bits or 32 bits. A reserved bit in the first 16 bits is used to distinguish between the 16 bit or 32 bit cases. If the reserved bit is zero, extensible acknowledgement bitmap 2408 comprises 16 bits. If the reserved bit is one, extensible acknowledgement bitmap 2408 comprises 32 bits. In the preferred embodiment, a regular data frame may be fragmented into any number of tinygram sections ranging from one to 31. The tinygram transmitter (e.g. modem 2113) may choose a size for extensible acknowledgement bitmap 2408 that efficiently contains the actual bitmap of the partially acknowledged regular data frame. This minimizes waste of transmission bandwidth.

In step A2, reception interface 2464 determines if the current tinygram contains a full acknowledgement, i.e. ACK=‘01’. If the current tinygram contains a full acknowledgement, reception interface 2464 executes step A8. It is noted that reception interface 2464 maintains an acknowledged data pointer to regular transmit buffer 2476. Regular data in regular transmit buffer 2476 preceding the location pointed to by acknowledged data pointer is assumed to have been previously acknowledged, and thus, is not subject to retransmission. In step A8, reception interface 2464 reads the acknowledged frame number field 2406, and advances an acknowledged data pointer based on the acknowledged frame number. It is noted that acknowledged data point may advance by more than one regular data frame because, in the case of a full acknowledgment, the acknowledged frame number is to be interpreted as a “last acknowledged frame number”, implying that all regular data frames with smaller frame numbers are also acknowledged implicitly. After step A8, processing resumes with step A5.

If the current tinygram does not contain a full acknowledgment, reception interface 2464 performs step A3. In step A3, reception interface 2464 determines if the current tinygram contains a partial acknowledgement, i.e. ACK=‘10’ or ‘11’. If the current tinygram contains a partial acknowledgement, reception interface 2464 performs step A4.

In step A4, reception interface 2464 reads acknowledged frame number field 2406 and extensible acknowledgement bitmap 2408, and requests retransmission of the missed sections of the indicted regular data frame. Transmission interface 2480 is responsible for handling retransmission of the missed sections, and will be described more fully later. After step A4, processing continues with step A5.

If the current tinygram does not contain a partial acknowledgment or full acknowledgement, i.e. ACK=‘00’, reception interface 2464 executes step A5. In step A5, reception interface 2464 determines if the current tinygram contains real-time data by examining real-time frame length field 2416. If the real-time frame length is greater than zero, reception interface 2464 performs step A6.

In step A6, reception interface 2464 recovers the real-time data embedded in the current tinygram, regenerates a real-time (i.e. RTP or CRTP) frame from the recovered real-time data, and stores the real-time frame in real-time buffer 2466. The real-time frame length specifies the number of bytes in the real-time data field 2412. After step A6, processing continues with step A7.

If the current tinygram does not contain real-time data, reception interface 2464 performs step A7. In step A7, reception interface 2464 examines transmit section number field 2404 to determine if the current tinygram contains regular data. A tinygram section number of 31 decimal indicates that the current tinygram does not contain regular data. Any other value for the tinygram section number indicates that the current tinygram does contain regular data. The portion of a regular data frame carried in a tinygram with tinygram section number different from 31 decimal is referred to herein as a section or a regular data section.

If the current tinygram does not contain regular data, processing of the current tinygram may be considered complete, and reception logic 2464 may wait for the arrival of the next tinygram. If the current tinygram contains regular data, processing continues with step A10 of FIG. 20C. Node A9 is merely a notational device to indicate the connection between FIGS. 20B & 20C.

In step A10, reception interface 2464 examines regular transmit frame number field 2410 to determine if the regular transmit frame number is new. Reception interface 2464 maintains a list of active regular frame numbers. Regular frame numbers that are on the active list correspond to regular data frames that are under reconstruction. If the regular transmit frame number of the current tinygram is not on the active list, it is considered new, and immediately added to the active list. A regular frame number is cleared from the active list when the corresponding frame has been completely reconstructed. If reception interface 2464 determines that the regular transmit frame number of the current tinygram is not new, then step A12 is performed.

If the regular transmit frame number of the current tinygram is new, step A11 is performed. In step A11, reception interface 2464 records a start time for the regular transmit frame number, allocates a new bitmap, and allocates memory for accumulating sections of a regular data frame corresponding to the new regular transmit frame number. The start time is used to determine when a timeout condition has occurred for reconstructing the corresponding regular data frame. After step A11, step A12 is performed.

A bitmap preferably comprises a 32-bit word since regular data frames may be fragmented into up to 31 sections. Each tinygram contains a transmit section number field 2404. Each time a regular data section is received in a tinygram, the corresponding bit is marked in the bitmap based on the transmit section number. The bitmap allows reception interface 2464 to measure its progress towards completing reconstruction of a regular data frame. Initially, all bit positions of the bitmap are equal to zero. One bitmap is maintained for each active regular frame number.

Reception interface 2464 stores each of the sections corresponding to a given regular transmit frame number in a separate section buffer. When all the sections for the given regular transmit frame number have arrived, the sections stored in the section buffers may be concatenated to regenerate the regular data frame. Reception interface 2464 maintains a set of section buffers for each of the active regular frame numbers. The section buffers are preferably ordered. When a tinygram containing a regular data section is received, its regular data contents (i.e. the section) is stored in a section buffer based on the transmit section number of the tinygram. The section is stored in the correspondingly numbered section buffer.

In step A12, reception interface 2464 recovers regular data from the current tinygram, and stores the regular data in one of the section buffers corresponding to the transmit section number 2404 of the current tinygram.

In step A13, reception interface 2464 marks a bit in the bitmap for the current regular transmit frame number, i.e. the bit that corresponds to transmit section number 2404 of the current tinygram.

In step A14, reception interface 2464 determines if the final bit of the current tinygram is set to one. If reception interface 2464 determines that the final bit of the current tinygram is not equal to one, step A16 is performed. In contrast, if the final bit is set to one, reception interface 2464 performs step A15.

In step A15, reception interface 2464 sets a completion mask corresponding to the transmit section number of current tinygram. If transmit section number of the current tinygram equals N, then the completion mask is set so that the completion mask has ones in bit positions zero through N inclusive, and zeros in bit positions N+1 and beyond. It is noted that the completion mask may be set to zero (i.e. all bits zero) as part of step A11 when new data structures are being initialized for a new regular data frame number. After step A15, step A16 is performed.

In step A16, reception interface 2464 determines if all sections for the current regular data frame number have been received. In one embodiment of step A16, reception interface 2464 computes a bit-wise exclusive OR of the bitmap and the completion mask for the current regular data frame number. If the bitmap and the completion mask disagree in any bit position, the result of the exclusive OR will be non-zero. By comparing the resultant of the exclusive OR operation to zero, reception interface 2464 may determine if all sections have been received. (It is noted that the determination of step A16 may be performed in a variety of ways other than the bitwise OR followed by comparison to zero.)

If all sections have been received as determined in step A16, step A17 is performed. In step A17, reception interface 2464 requests transmission of a “full acknowledgement” message to client modem 2113. The full acknowledgement message informs client modem 2113 that software adapter 2137 has received all sections of the current regular data frame. Step A17 further comprises reconstructing a regular data frame by concatenating the sections stored in the corresponding section buffers. The regular data frame is stored into regular buffer 2468. Furthermore, the current regular data frame number is cleared from the active list. After step A17, processing of the current tinygram may be considered complete, and reception interface 2464 may wait for arrival of another tinygram.

As discussed above in conjunction with FIG. 21A, software adapter 2137 may include a transmission interface 2480 which transmits a second stream of tinygrams to client modem 2113. Transmission interface 2480 may generate and transmit tinygrams of the second stream in response to the availability of real-time data and/or regular data in real-time transmit buffer 2474 and regular transmit buffer 2476 respectively. Transmission interface 2480 may service the request for full acknowledgement (asserted by reception interface 2464 in step A17) by loading a full acknowledgment bit pattern, e.g. ‘01’ binary, in acknowledgment field 2402 in one of the second stream tinygrams. Transmission interface 2480 loads the frame number of the regular data frame being fully acknowledged into acknowledged frame number field 2406.

Transmission interface 2480 may buffer multiple full acknowledgement requests while it waits for an opportunity to transmit a tinygram, i.e. until real-time data or regular data arrive in real-time transmit buffer 2474 or regular transmit buffer 2476 respectively. According to one embodiment of the tinygram protocol, transmission interface 2480 may explicitly transmit a single full acknowledgement and implicitly give full acknowledgement for regular data frames with smaller frame numbers.

Please refer once again to FIG. 20C. If all sections have not been received as determined in step A16, step A18 is performed. In step A18, reception interface 2464 determines if a predetermined time limit for reconstructing a regular data frame for the current regular frame number has been exceeded. If the time limit has not been exceeded, reception interface 2464 may wait for the arrival of the next tinygram, whereupon processing restarts with step A1.

If the time limit has been exceeded, reception interface 2464 may request the transmission of a regular frame reject message or a partial acknowledgement message for the current regular frame number. A regular frame reject message is identical to a full acknowledgement message. The other end (i.e. modem 2113) is led to believe the current regular data frame has been received correctly. Thus, some higher level protocol in Internet Protocol Stack 2126 or one of the software applications running on client computer 112 may assume responsibility for error correction if necessary. After step A20, reception interface 2464 may wait for the arrival of the next tinygram.

It is noted that alternative methods for handling acknowledgement of regular data frame transmission are contemplated. For example, instead of sending acknowledgement information (full or partial) for a regular data frame in a single tinygram, the acknowledgement information may be spread out over a plurality of tinygrams.

Transmission interface 2480 may service a request for partial acknowledgement by loading a partial acknowledgment bit pattern, e.g. ‘10’ or ‘11’ binary, in acknowledgment field 2402 in a tinygram to be transmitted to modem 2113. Furthermore, transmission interface 2480 loads (a) the frame number of the regular data frame being partially acknowledged into acknowledged frame number field 2406 of the tinygram, and (b) the reconstruction bitmap of the regular data frame into extensible acknowledgement bitmap field 2408. As described above, extensible acknowledgement bitmap field 2408 may comprise 8 bits, 16 bits, or 32 bits. Transmission interface 2480 uses the smallest of these three sizes which will accommodate the reconstruction bitmap.

FIG. 21B illustrates one possible state diagram for the processing performed by transmission interface 2480 of software adapter 2137. Transmission interface 2480 maintains an estimate X of the amount of time required for the modem 2117 to clear its internal buffer (not shown), i.e. to transmit the contents of its internal buffer onto subscriber connection SC#2. Thus, estimate X will be referred to herein as the clearing time. The clearing time X may be computed based on the amount N of data in the internal buffer of modem 2117 and the line rate R of subscriber connection SC#2, i.e. X=N/R. Transmission interface 2480 increases the clearing time X each time it transmits a tinygram to modem 2117 according to the expression X=X+LEN/R, where LEN is the length of the tinygram.

By maintaining an estimate of the clearing time X, transmission interface 2480 may control the transmission of tinygrams to modem 2117 so that the regular data embedded in tinygrams will induce no more than a predetermined time delay T in the transmitted stream. Transmission interface 2480 may impose a waiting period to allow X to deplete to a sufficiently small value relative to the predetermined time delay T before allowing regular data to be transmitted in the output stream of tinygrams. This advantageously limits the amount of delay the real-time data will encounter due to regular data in the transmitted stream.

In general, transmission interface 2480 arrives in wait state 2370 after having transmitted a tinygram, and thus, the clearing time will have a positive value. In wait state 2370, transmission interface 2480 implements a mechanism for depleting (i.e. decreasing) the value of the clearing time X with respect to time. For example, after K milliseconds in wait state 2370 the clearing time X may be decreased by an amount that represents K milliseconds. When the clearing time X reaches zero, the depletion mechanism is turned off. Transmission interface 2480 is initialized in wait state 2370 with the clearing time X set to zero.

When real-time transmit buffer 2474 becomes non-empty (RT>0), transmission interface 2480 moves to state 2380. In state 2380, transmission interface 2480 transmits a “real-time” tinygram, i.e. a tinygram containing a single real-time frame with no regular data. After transmitting the real-time tinygram, transmission interface 2480 updates the clearing time according to the rule X=X+LEN/R, where LEN is the data length of the real-time tinygram, and determines if real-time transmit buffer 2474 is still non-empty. If real-time transmit buffer 2474 is still non-empty, transmission interface 2480 returns to state 2380. If real-time transmit buffer 2474 is empty, transmission interface 2480 returns to wait state 2370.

Transmission interface 2480 moves from wait state 2370 to state 2375 only if (a) regular transmit buffer 2476 is non-empty, (b) real-time transmit buffer 2474 is empty, and (c) the clearing time X obeys the condition T-X>Limit, where T and Limit are predetermined positive constants. For example, T may correspond to 30 milliseconds. Limit may be chosen to be some fraction of T such as T/2, T/4, etc. A wide variety of choices for the variable Limit are contemplated.

In state 2375, transmission interface 2480 initiates transmission of a tinygram containing regular data from regular transmit buffer 2476. Transmission interface 2480 moves to state 2376 if transmission interface 2480 reaches the end of a regular data frame (i.e. detects a frame separator flag), or if the current tinygram reaches a length of R(T−X), where R is the line rate of subscriber connection SC#2.

In state 2376, transmission interface 2480 closes the current tinygram, and updates the clearing time X according to the relation X=X+LEN/R, where LEN is the data length of the currently transmitted tinygram. When state 2376 is concluded, transmission interface 2480 returns to wait state 2370.

If real-time data becomes available while transmission interface 2480 is in state 2375, transmission interface 2480 moves to state 2385. In state 2385, transmission interface 2480 completes transmission of the current tinygram with a real-time frame from real-time transmit buffer 2474. After completing transmission of the current tinygram (which includes both regular data and real-time data), transmission interface 2480 updates the clearing time X according to the rule X=X+LEN/R, where LEN is the data length of the current tinygram. When the processing of state 2385 is concluded, transmission interface 2480 determines whether or not real time transmit buffer 2474 is still non-empty. If real-time transmit buffer 2474 is non-empty, transmission interface 2480 moves to state 2380. Otherwise, transmission interface 2480 returns to wait state 2370.

It is noted that transmission interface 2480 may employ other methods for controlling the flow of regular data to modem 2117.

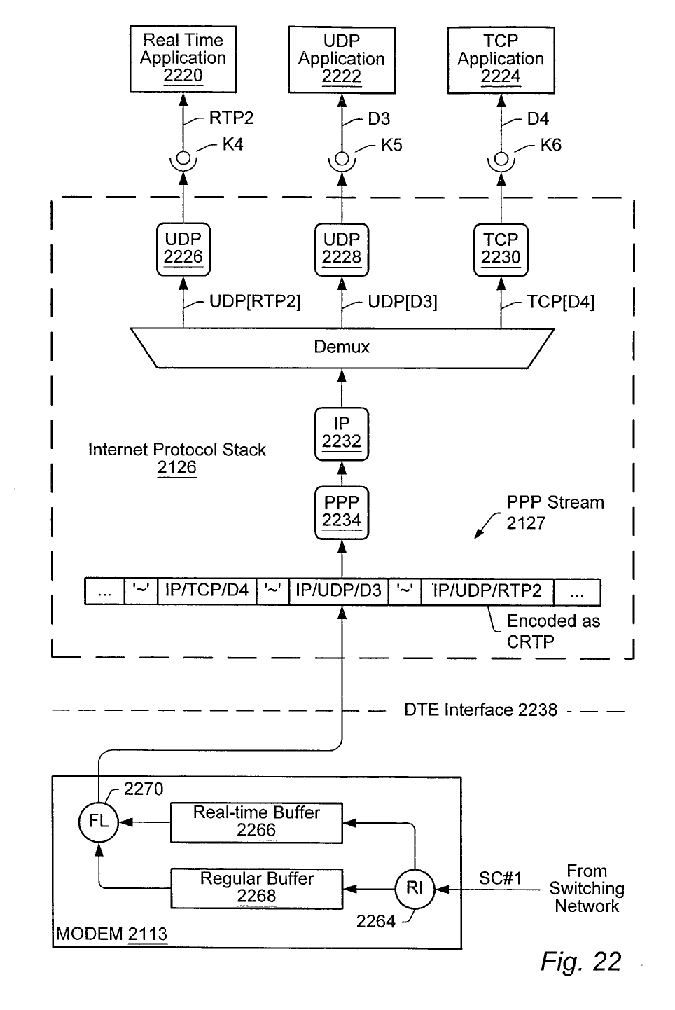

FIG. 22 illustrates a reception architecture for client modem 2113. Client modem 2113 includes reception interface 2264, real-time buffer 2266, regular buffer 2268, and forwarding logic 2270. It is noted that the functions of reception interface 2264 and forwarding logic 2270 may be implemented by one or more processes running on a processor embedded in modem 2113, preferably the same processor that implements the functions of transmit logic 2246 and demultiplexing logic 2240.

Reception interface 2264 receives a second stream of tinygrams from subscriber connection SC#1. The second stream of tinygrams is generated and transmitted by software adapter 2137. Reception interface 2264 demultiplexes the real-time data and regular data embedded in the second stream of tinygrams, and stores reconstructed real-time frames and regular data frames into real-time buffer 2266 and regular data buffer 2268 respectively. So far as the processing of tinygrams is concerned, reception interface 2264 may behave like reception interface 2464 in software adapter 2137. Thus, FIGS. 20B & 20C and the attendant discussion may be interpreted as a description of one embodiment of reception interface 2264.

Forwarding logic 2270 forwards real-time frames and regular data frames from real-time buffer 2266 and regular buffer 2268 respectively to Internet Protocol Stack 2126 through DTE interface 2238. Forwarding logic 2270 forwards real-time frames with priority over regular data frames. In other words, regular data frames are required to wait in regular buffer 2268 until real-time buffer 2266 has been exhausted.

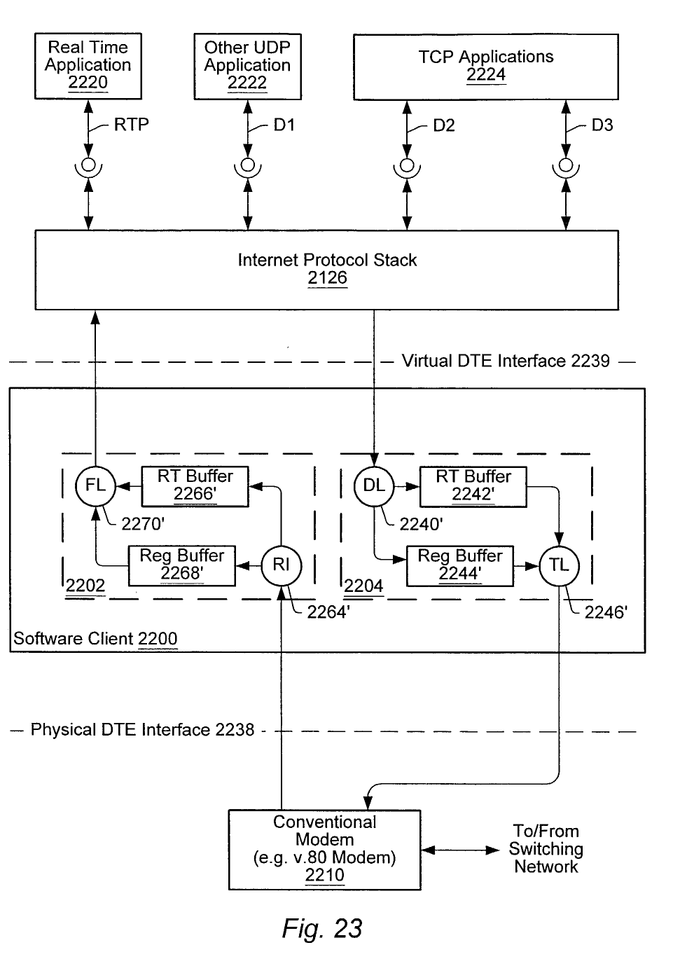

FIGS. 17, 18A & 22 illustrate client modem 2113 as a separate physical device. However, in an alternate embodiment shown in FIG. 23, the functionality of client modem 2113 may be implemented with a conventional modem 2210 and a software client 2200 which runs on client computer 112. Software client 2200 may include a reception module 2202 and a transmission module 2204. Reception module 2202 may include reception interface 2264′, real-time buffer 2266′, regular buffer 2268′ and forwarding logic 2270′. These processing elements may operate similarly to reception interface 2264, real-time buffer 2266, regular buffer 2268 and forwarding logic 2270 respectively, which have already been described. Transmission module 2204 may include demultiplexing logic 2240′, real-time buffer 2242′, regular buffer 2244′ and transmit logic 2246′. These processing elements may operate similarly to demultiplexing logic 2240, real-time buffer 2242, regular buffer 2244 and transmit logic 2246 respectively, which have already been described.

Software client 2200 communicates with Internet Protocol Stack 2126 through a virtual DTE interface 2239. Internet Protocol Stack 2126 communicates with software client 2200 as if software client 2200 were a physical modem. In other words, the virtual DTE interface 2239 behaves like a physical modem interface so far as Internet Protocol Stack 2126 is concerned.

Software client 2200 transmits and receives data from conventional modem 2210. Conventional modem 2210 may be any of a variety of existing modems such as a v.80 modem (i.e. a modem conforming to the v.80 standard).

For more information on implementing special protocols using host software in conjunction with a conventional modem, please refer to U.S. patent application Ser. No. 09/2238,820 entitled “Implementing Standard Protocols Using Standard Modems”, filed on Jan. 28, 1999, invented by David C. Oliver, and assigned to Data Race, Inc., which is hereby incorporated by reference.

Pseudo TCP Tinygrams

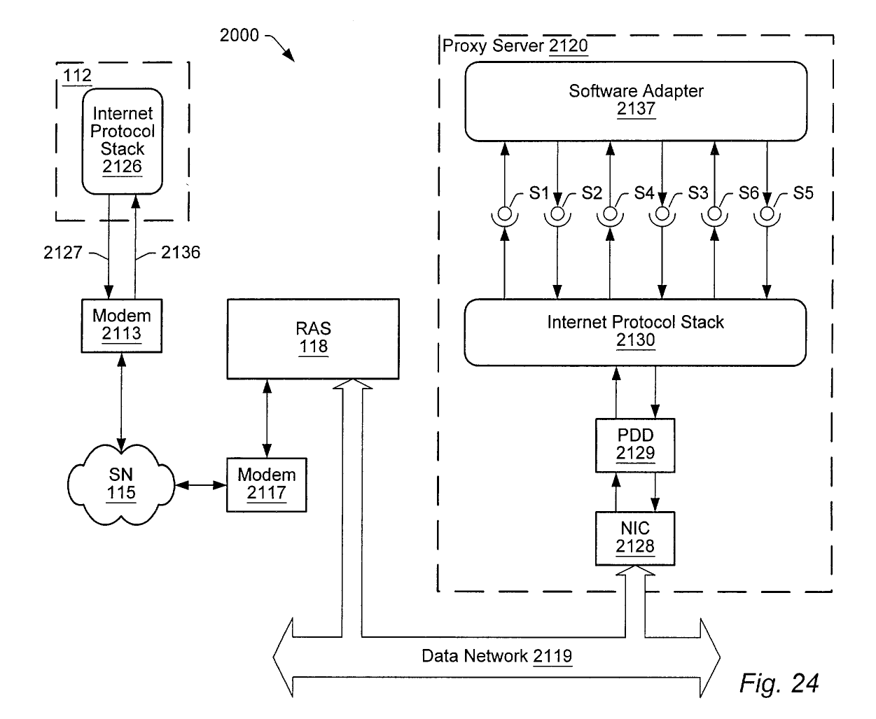

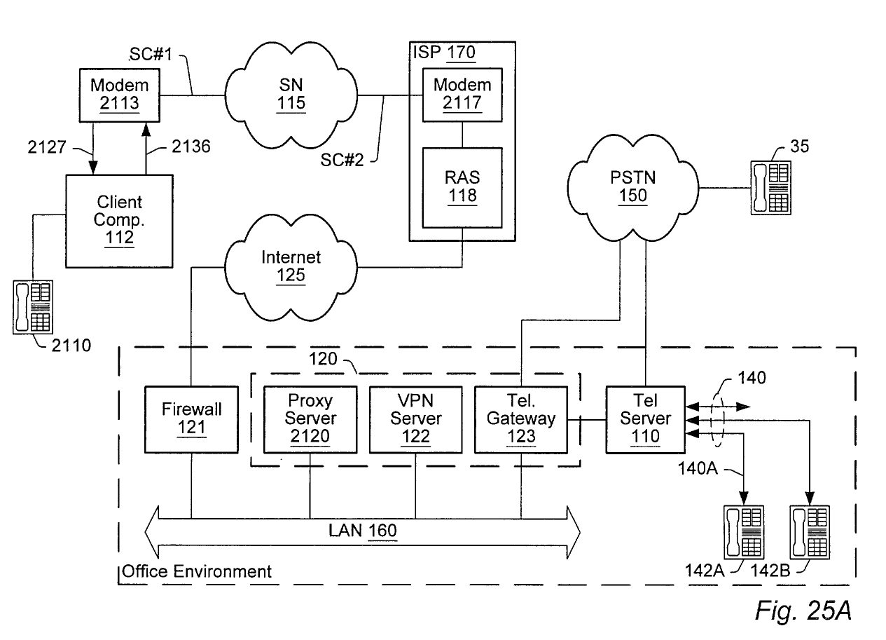

FIG. 24 illustrates an alternative embodiment for the physical transfer of tinygrams across the Internet backbone. In this alternate embodiment, client modem 2113 may send TCP-format tinygrams to proxy server 2120 instead of UDP-format tinygrams. TCP-format tinygrams conform to the frame syntax of the Transfer Control Protocol. FIG. 19A may be interpreted as the format for a TCP-format tinygram if the UDP header field 2401 is replaced by a corresponding TCP header. Client modem 2113 may perform header compression (e.g. Van Jacobsen compression) on the TCP-format tinygrams prior to transmitting them onto the subscriber connection SC#1. RAS server 118 may automatically perform header decompression on the TCP-format tinygrams. (It is noted that many RAS servers currently support header compression/decompression for TCP frames. However, some RAS servers may not support header compression/decompression for UDP frames.) Thus, the TCP-format tinygrams may be efficiently expedited across subscriber connection SC#1. The TCP-format tinygrams arrive at network interface card 2128 because client modem 2113 addresses the TCP-format tinygrams to proxy server 2120. Network interface card 2128 forwards the TCP-format tinygrams to a pseudo device driver 2129. Pseudo device driver 2129 may be a program which executes on the proxy server host computer. Pseudo device driver 2129 translates (i.e. reformats) the TCP-format tinygrams into UDP-format tinygrams. Pseudo device driver 2129 may interact with IP stack 2130 as if it were a network interface. Pseudo device driver 2129 may be logically configured between the network interface card (NIC) device driver (not shown) and IP stack 2130. Pseudo device driver 2129 provides the UDP-format tinygrams to IP stack 2130. IP stack 2130 passes the UDP-format tinygrams up to software adapter 2137. Software adapter 2137 demultiplexes the UDP-format tinygrams, and forwards the resulting real-time frames and non-real-time frames to their respective IP destinations.

Conversely, software adapter 2137 receives real-time frames and non-real-time frames from various sources, and multiplexes these real-time frames and non-real-time frames into UDP-format tinygrams. Software adapter 2137 passes the UDP-format tinygrams to IP stack 2130, e.g., through UDP socket S2. IP stack 2130 provides the UDP-format tinygrams to pseudo device driver 2129. Pseudo device driver 2129 translates (i.e. reformats) the UDP-format tinygrams into TCP-format tinygrams, and forwards the TCP-format tinygrams to network interface card 2128 for transmission to client modem 2113 through the tinygram protocol connection Cₚ. Because client modem 2113 and pseudo device driver 2129 exchange TCP-format tinygrams, header compression/decompression may be performed at client modem 2113 and RAS server 118. In addition, because of the format translation performed by pseudo device driver 2129, IP stack 2130 sees only UDP-format tinygrams, and thus, the reliability and flow control mechanisms associated with TCP are advantageously avoided. The real-time data (e.g. telephony data) carried within the tinygram protocol connection Cₚ would not be benefited by the retransmission of tinygrams for error correction, and error connection is already performed end-to-end by any TCP connections riding on top of the tinygram protocol connection Cₚ as mentioned above.

It is desirable to compress the headers of UDP packets to minimize packet overhead in transmission across switching network 115. This is especially true for the UDP tinygrams which may carry a small data payload during periods of real-time transfer activity. While some servers, such as some CISCO servers, provide UDP header compression, this feature is not generally available for the personal computers which typically connect to the servers. Thus, UDP-format tinygrams may suffer from a lower effective transmission bandwidth because of the large uncompressed UDP headers.

The present invention contemplates the use of a protocol which behaves like TCP so far as the Internet backbone and header compression (e.g. Van Jacobsen compression) are concerned. However, in contrast to standard TCP, the protocol is used to perform unreliable data transfer. At the client side, client modem 2113 (or a modem driver running on client computer 112) originates a PPP data stream, i.e. the multiplexed stream of tinygrams. Client modem 2113 performs the multiplexing of real-time data and non-real-time data as described above. Client modem 2113 may format the tinygrams so that they conform to the frame syntax of the Transmission Control Protocol.

The TCP-format tinygrams are routed to proxy server 2120 because the client modem (or modem driver) addresses the TCP-format tinygrams to proxy server 2120. A pseudo network interface card driver, at proxy server 2120, is situated between the network interface card 2128 and IP stack 2130. Because the pseudo NIC driver is situated below the IP stack 2130, i.e. in the device driver area, it resides in an area where it is generally possible to add components to operating systems.

When the TCP-format tinygrams arrive from the client, they arrive at a recognized port address. The pseudo NIC driver assumes any packet arriving at that port address is intended for software adapter 2137. The pseudo NIC driver reformats the tinygrams according to the User Datagram Protocol. IP stack 2130 receives and forwards the stream of UDP tinygrams to the appropriate UDP socket. Note that the IP stack 2130 does not invoke any of the sequencing, retransmission, and flow control mechanisms associated with TCP, because the tinygrams (having been reformatted) comprise a UDP stream.

Software adapter 2137 also generates UDP tinygrams which are addressed to the client. The pseudo NIC device driver will recognize these UDP tinygrams, reformat them as TCP tinygrams, and forward them to NIC 2128 for transmission to the client modem 2113. The pseudo NIC device driver maintains a table of client addresses. When it receives a stream of TCP tinygrams from a new client, the client's address is added to the table. Thus, when the pseudo NIC driver receives UDP packets from IP stack 2130, the pseudo NIC driver is able to differentiate UDP tinygrams (which are destined for a client) from ordinary UDP traffic. UDP tinygrams destined for a client will have an address entry in the table. Before sending the UDP tinygrams out to NIC 2128, the pseudo device driver may reformat the UDP tinygrams as TCP tinygrams, i.e. change the formatting of the tinygrams from UDP to TCP. In this fashion, software adapter 2137 may be completely unaware that the tinygrams are being transported across the Internet backbone as TCP frames. Alternatively, when UDP tinygrams are sent up to software adapter 2137, they can be tagged as coming from TCP tinygrams by translation. Software adapter 2137 can then tag the return stream of UDP tinygrams prior to sending them down the IP stack 2130.

Header compression may have a significant impact on performance when subscriber connection SC#1 has a restricted bandwidth and when tinygrams have a small data payload. Van Jacobsen compression may be applied to a TCP tinygram before it is transmitted onto subscriber connection SC#1. Van Jacobsen decompression may be performed in RAS server 118, i.e. after the TCP tinygram leaves conventional modem 2117 at the other end of subscriber connection SC#1.

In one embodiment, the multiplexing/demultiplexing of real-time data and non-real-time data at the client side is performed by a software layer which is situated between IP stack 2126 and client modem 2113. The software layer may behave like a modem in its interaction with IP stack 2126. In this embodiment, the software layer receives a PPP stream comprising real-time UDP frames and non-real-time frames (e.g. TCP and/or UDP frames) from IP stack 2126. The software layer multiplexes the real-time UDP frames and non-real-time frames into a stream of TCP tinygrams. The software layer may apply header compression (e.g. Van Jacobsen compression) to the TCP tinygrams prior to sending them to client modem 2113. Because tinygrams are sent across the Internet in TCP format, Van Jacobsen compression/decompression may be applied at the software layer and RAS server 118. Typically, RAS server 118 may not be configured to perform Van Jacobsen compression for UDP packets.

The present invention also contemplates a method for transmitting UDP data (e.g. real-time UDP data) between a client computer and a server computer. The method involves a client protocol stack and a modem driver which execute on the client computer. The client computer couples to a physical modem. The method comprises:

(a) the modem driver receiving a first stream of frames (including UDP frames) from the client protocol stack;

(b) the modem driver multiplexing the first stream of frames into a second stream of TCP packets;

(c) the modem driver providing the second stream of TCP packets to the physical modem for transmission to a second modem across a modem link.

The modem driver may perform header compression (e.g. Van Jacobsen compression) on the second stream of TCP packets prior to providing the second stream of TCP packets to the first modem. The method also involves a server computer which is coupled to a computer network with a network interface. A network interface driver is configured to execute on the server computer. The network interface receives the second stream of TCP packets from the second modem through the computer network. The network interface passes the second stream of TCP packets to the network interface driver. The network interface driver recovers the first stream of frames (which includes UDP frames) from the second stream of TCP packets, and provides the first stream of frames to a second protocol stack also running on the server computer.

In addition, the network interface driver receives a third stream of frames from the second protocol stack. The third stream of frames also includes UDP frames. The network interface driver multiplexes the third stream of frames into a fourth stream of TCP packets. The network interface driver provides the fourth stream of TCP packets to the network interface for transmission to the first modem via the computer network, the second modem and the modem link.

As described above in conjunction with FIG. 16, hybrid modem-server system 2000 allows client computer 112 to concurrently transfer real-time data and non-real-time data to/from arbitrary real-time IP nodes and non-real-time IP nodes through a tinygram protocol connection Cₚ between client modem 2113 and proxy server 2120. Modem 2113 and proxy server 2120 implement mechanisms which guarantee the low-latency transfer of the real-time data through switching network 115. In particular, the tinygram protocol connection Cₚ may carry (a) the telephony connection Cₜ between telephony client 91 and telephony gateway 123, and (b) the VPN connection CV between VPN client 93 and VPN server 122. In other words, the tinygram protocol connection Cₚ may be used to exchange telephony data between telephony client 91 and telephony gateway 123, and to exchange regular data between VPN client 93 and VPN server 123. The remote user gains access to the resources of telephony server 110 (e.g. a PBX) and local area network 160 through the respective connections.

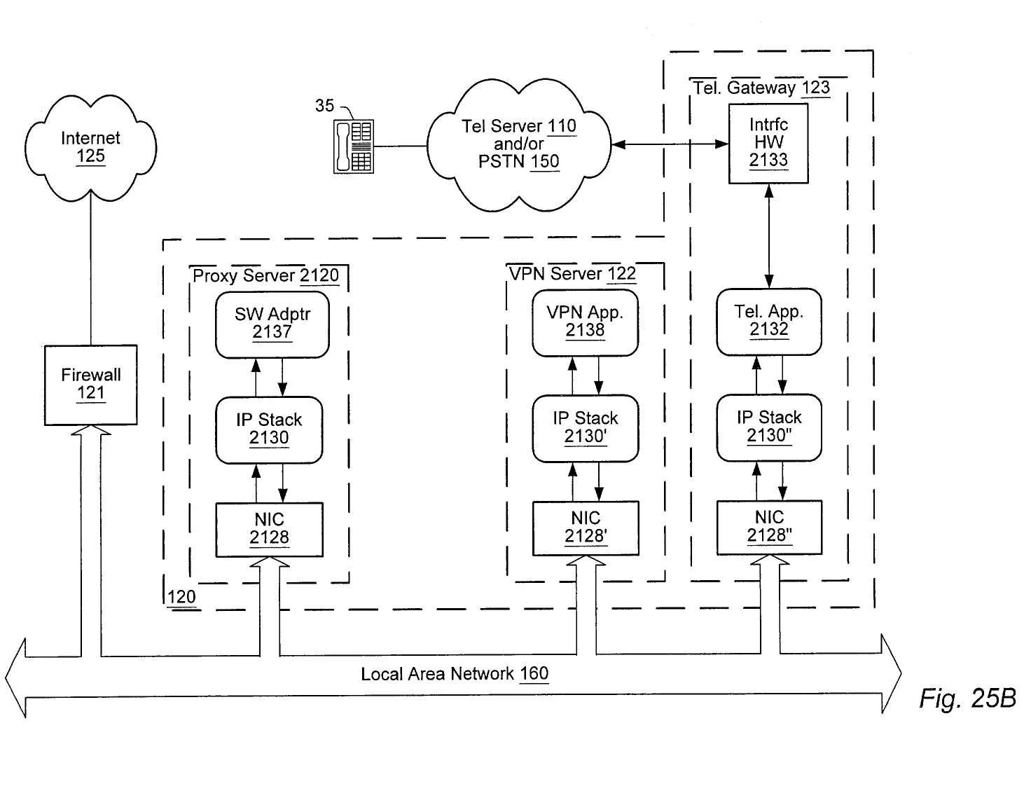

Conventional modem 2117 and RAS 118 may be located on the premises of an Internet Service Provider (ISP) 170, and proxy server 2120 may be comprised within server system 120 in the office environment as shown in FIG. 25A. Server system 120 may also include virtual private network (VPN) server 122, and telephony gateway 123 as described above. FIG. 25B shows a more detailed view of proxy server 2120, VPN server 122, and telephony gateway 123 comprised within server system 120. Proxy server 2120, telephony gateway 123 and VPN server 122 couple to local area network (LAN) 160. Firewall 121 provides LAN 160 with a controlled connection to the Internet 125. Firewall 121 may be a conventional firewall product. ISP 170 provides the client computer 112 with access to the Internet 125.

In one alternative embodiment, proxy server 2120 is coupled to the ISP's internal data network with RAS 118. In this embodiment, RAS 118 exchanges tinygrams with proxy server 2120 through the ISP's internal network, and proxy server 2120 exchanges real-time data and regular data with telephony gateway 123 and VPN server 122 respectively through the Internet 125.

In a second alternative embodiment, the role of the ISP 170 is taken by a branch office of the same organization which controls/maintains the office environment. In other words, conventional modem 2117 and remote access server 118 reside in the branch office. In this second embodiment, proxy server 2120 may be comprised within server system 120, or coupled to RAS 118 through an internal data network at the branch office.

One or more real-time applications running on client computer 112 may generate real-time frames addressed for one or more of real-time IP nodes 2124. In particular, telephony client 91 running on client computer 112 generates real-time telephony frames addressed to telephony gateway 123. The real-time telephony frames comprise encoded voice data (representing the remote user's voice) and telephony control information (representing control events such as a pressing of the call transfer button on remote phone 2110). Also, one or more non-real-time applications running on client computer 112 may generate non-real-time frames addressed to one or more of non-real-time nodes 2123. Non-real-time nodes 2123 may reside on local area network 160 or at arbitrary locations on the Internet 125. The non-real-time frames are referred to herein as regular data frames.

A VPN client application running on client computer 112 intercepts the regular data frames (as shown in FIG. 6), encrypts the regular data frames, and embeds the encrypted regular data in frames Tᵢ addressed for VPN server 122. These VPN-addressed frames Tᵢ will be referred to herein as tunnel frames because they “tunnel” through the secure VPN connection CV generated by VPN client 93 and VPN server 122. Client computer 112 supplies the real-time frames (i.e. RTP and/or CRTP frames) and the tunnel frames to client modem 2113 in a first PPP stream 2127.

Modem 2113 multiplexes the real-time frames and tunnel frames into a first stream of tinygrams as shown in the state diagram of FIG. 18B. The tunnel frames are treated as regular data (i.e. non-real-time data). Modem 2113 transmits the first stream of tinygrams to proxy server 2120 through the tinygram protocol connection. In transit from modem 2113 to proxy server 2120, the first stream of tinygrams may flow through subscriber connection SC#1, switching network 115, subscriber connection SC#2, modem 2117, RAS 118, Internet 125, firewall 121, and a portion of local area network 160. In particular, the first stream of tinygrams are addressed to software adapter 2137 which runs on proxy server 2120 as shown in FIG. 25B.

Software adapter 2137 receives the first stream of tinygrams, and demultiplexes the real-time frames and the tunnel frames from the first stream of tinygrams. Software adapter 2137 transmits the real-time frames and tunnel frames onto local area network 160. Normal IP routing mechanisms are responsible for delivering the real-time frames and tunnel frames to their respective IP destinations through local area network 160. In particular, real-time telephony frames generated by the telephony client 91 are delivered to telephony gateway 123, and the tunnel frames are delivered to VPN server 122.

Telephony gateway 123 receives the real-time telephony frames transmitted by software adapter 2137. The telephony frames comprise voice data and telephony control data. Telephony gateway 123 recovers any voice data which may be present in the real-time frames, and converts the voice data into a voice signal which is then forwarded to a voice correspondent 35 through telephony server 110 (e.g. a PBX) or the PSTN 150. In addition, telephony gateway 123 recovers any telephony control data which may be present in the real-time telephony frames, and transmits corresponding control signals to telephony server 110 and/or the PSTN 150. For example, telephony gateway 123 may receive a hook-flash message transmitted from the telephony client 91. In response to the hook-flash message, telephony gateway 123 may transmit a hook-flash signal to telephony server 110 and/or the PSTN 150. Thus, telephony gateway 123 may advantageously provide remote clients with access to telephony services through their respective tinygram protocol connections Cₚ to proxy server 2120.

VPN server 122 may perform authentication of remote clients with respect to data resources available on local area network 160. VPN server 122 receives the tunnel frames transmitted by software adapter 2137, applies decryption and recovers the regular data frames embedded in the tunnel frames. VPN server 122 transmits the regular data frames onto local area network 160. Normal IP routing mechanisms are responsible for delivering the regular data frames to their respective IP destinations, i.e. non-real-time nodes 2123, through local area network 160. VPN server 122 may advantageously provide data security for local area network 160.

In the reverse direction, telephony gateway 123 receives a voice signal from the voice correspondent 35 through telephony server 110 or the PSTN 150. Telephony gateway 123 converts the voice signal into voice data. Telephony gateway 123 also receives any control signals asserted by telephony server 110 and/or the PSTN 150, and translates the control signals into corresponding telephony control messages. Telephony gateway 123 embeds the voice data and telephony control messages into real-time telephony frames (addressed for the telephony client 91), and transmits the real-time telephony frames onto local area network 160. Again, normal IP routing mechanisms are responsible for delivering the real-time telephony frames to software adapter 2137 through local area network 160. One or more real-time terminals (such as VoIP terminals) may also transmit real-time frames (destined for client computer 112) to software adapter 2137 through local area network 160.

In addition, VPN server 122 may receive regular data frames (destined for client computer 112) from one or more of non-real-time nodes 2123 residing on local area network 160 or on the Internet 125. VPN server 122 encrypts the regular data frames and embeds the encrypted information into frames Uᵢ addressed to VPN client 93 on client computer 112. These frames Uᵢ are also referred to as tunnel frames. VPN server 122 transmits the tunnel frames Uᵢ to software adapter 2137 through local area network 160.

Software adapter 2137 may multiplex the real-time frames and tunnel frames into a second stream of tinygrams, and transmit the second stream of tinygrams to modem 2113, e.g. as described in connection with FIG. 21B. Modem 2113 demultiplexes the real-time frames and tunnel frames from the second stream of tinygrams, and presents the real-time frames and tunnel frames to client computer 112 in second PPP stream 2136. In particular, modem 2113 presents the second PPP stream 2136 to an IP stack 2126 running on client computer 2113. IP stack 2126 presents the tunnel frames to VPN client 93, and presents the real-time frames to the one or more real-time applications. In particular, IP stack 2126 presents the real-time telephony frames to the real-time telephony client 91. VPN client 93 receives the tunnel frames, decrypts the encrypted data embedded in the tunnel frames, and thereby, recovers the regular data frames transmitted by the non-real-time nodes 2123. VPN client 93 presents the regular data frames to non-real-time applications 92 running on client computer 112 as shown in FIG. 6.

As shown in FIG. 25B, VPN server 122 comprises a host computer coupled to a network interface card 2128′. Network interface card 2128′ provides connectivity to local area network 160. VPN server application 2138 runs on the host computer and gives the host computer its VPN server identity. VPN server 122 performs authentication for remote clients such as client computer 112 with respect to data resources available on local area network 160. VPN server 122 may prompt the remote client for identifying/authenticating information, and verify this information, before allowing the remote client to access local area network 160. VPN server 122 may maintain separate management domains in which resources on local area network 160 are partitioned into subsets and individually controlled. For example, a first remote client, “the president”, may have access to many or all of the domains, while a second remote client, “the worker”, may have access to fewer domains. If the remote client fails the authentication procedure, VPN server 122 may terminate communications with client computer 112. VPN server 122 performs (a) encryption on outward bound regular data traffic, i.e. regular data frames in transit to client computer 112, and (b) decryption on incoming regular data traffic. VPN server 122 operates in conjunction with the VPN client 91 running on client computer 112.

Telephony gateway 123 comprises a host computer (which may be the same as or distinct from the host computer for the proxy server 2120 and/or the host computer for the VPN server 122) coupled to a network interface card 2128″ and telephony interface hardware 2133. Network interface card 2128″ provides connectivity to local area network 160. Telephony interface hardware 2133 provides connectivity to telephony server 110 and/or PSTN 150. An IP stack 2130″ and telephony application 2132 run on the host computer. Telephony gateway 123 is configured to simultaneously handle multiple telephony clients of which client computer 112 is a representative. The telephony client 91 which runs on client computer 112 is logically connected to telephony application 2132 which runs on telephony gateway 123.

Telephony gateway 123 may perform client authentication with respect to telephony services. For example, telephony gateway 123 may prompt the remote client for identifying/authenticating information, and verify this information, before allowing the remote client to access the telephony services available via telephony gateway 123.

A user of client computer 112 initiates a telephone call by providing an input to telephony client 91. For example, the user may click on an icon displayed by telephony client 91 on the screen on client computer 112, or may simply pick up the handset of telephony device 2110 to initiate a conversation through telephony gateway 123. Telephony client 91 may prompt the user for a telephone number. When the user provides a telephone number, or designates a telephone number from a displayed list, telephony client 91 transmits real-time telephony frames encoding the telephone number to telephony gateway 123 through the telephony connection Cₜ. Telephony gateway 123 places the call to telephony server 110 or PSTN 150. When a voice correspondent (e.g. a coworker at office phone 142B or a external party at PSTN phone 35) answers the telephone call, telephony gateway 123 implements a bi-directional voice connection between the user situated at telephony device 2110 and the voice correspondent. Between modem 2113 and proxy server 2120 the voice conversation is carried on the real-time subchannel of the tinygram protocol connection Cₚ.

As mentioned above, proxy server 2120 may transmit a stream of real-time telephony frames, which originate from the client computer 112, to telephony application 2132. Telephony application 2132 receives the stream of real-time telephony frames transmitted by proxy server 2120. The real-time telephony frames may include voice data and/or telephony control data. For example, the real-time telephony frames may include encoded G.729 voice packets. Telephony application 2132 may decode the voice packets and provide the resulting digital voice stream to telephony interface 2133. Telephony application 2132 may also recover the telephony control data from the real-time telephony frames and provide the telephony control data to telephony interface 2133. Telephony interface 2133 may convert the digital voice stream into an analog voice signal for transmission to the voice correspondent through telephony server 110 and/or PSTN 150. In one embodiment, telephony interface 2133 connects to the telephony server 110 and/or PSTN 150 through digital telephone lines in which case the digital-to-analog conversion is not necessary. Furthermore, telephony interface 2133 transmits telephony control signals to telephony server 110 and/or PSTN 150 in response to the received telephony control data.

In the reverse direction, telephony interface hardware 2133 receives a voice signal from the voice correspondent through telephony server 110 or PSTN 150, and converts the voice signal into a digitized voice stream. Telephony interface hardware 2133 may encode the digitized voice stream using a vocoder protocol such as G.729, and provide the encoded voice packets to telephony application 2132. Telephony interface hardware 2133 may also translate control events asserted by telephony server 110 and/or PSTN 150 into corresponding control data items. Telephony application 2132 may encapsulate the encoded voice packets and control data into real-time telephony frames (e.g. RTP frames). Telephony application 2132 transmits the real-time telephony frames to software adapter 2137 through local area network 160.

VPN server 122 provides data security for LAN 160 by authenticating remote clients and performing data encryption/decryption on regular data traffic flowing to/from remote clients. Telephony gateway 123 may receive real-time telephony frames transmitted from remote clients via proxy server 2120. However, telephony gateway 123 does not have the capacity to forward these real-time telephony frames onto LAN 160. Thus, telephony gateway 123 does not pose a risk to the data security of LAN 160.

In addition to allowing remote clients to place telephony calls out through telephony server 110 and/or PSTN 150, telephony application 2132 may support virtual presence features. A remote user is said to be virtually present in the office environment when (a) some or all of the telephony and LAN access capabilities provided to the user in his/her work area at the office environment are extended to client computer 112, and (b) calls to the user's work phone (e.g. phone 142A) and/or VoIP terminal are redirected to the remote client computer 112.

Telephony application 2132 may operate in concert with telephony client 91 running on client computer 112 to support virtual presence for the remote user. When the remote user invokes telephony client 91, telephony client 91 sends signals (via real-time telephony frames) to telephony application 2132 (using the real-time subchannel of the tinygram protocol connection) establishing a telephony session. Telephony application 2132 directs telephony interface 2133 to invoke one or more call forwarding operations. Telephony interface 2133 commands telephony server 110 to forward any subsequent calls targeting the user's office phone 142A (which the user would normally use if he/she were physically in the office) to telephony interface 2133. In addition, telephony interface 2133 may command the PSTN 150 to forward any subsequent calls targeting a given PSTN telephone number to telephony interface 2133. For example, the given PSTN telephone number may be the remote user's home telephone. Telephony interface 2133 may be coupled to the PSTN 150 through a plurality of telephone lines.

Because of the call forwarding operations, telephony application 2132 advantageously receives PSTN calls and/or telephony server (e.g. PBX) calls intended for the user. In response to such a telephone call, telephony application 2132 informs telephony client 91. Telephony client 91 indicates the presence of an incoming call through any of a variety of mechanisms such as an audible beep, flashing icon, etc. In response to the remote user answering the telephone call (e.g. by picking up the handset of telephony device 2110 or clicking on a displayed icon), telephony client 91 and telephony application 2138 engage in a bi-directional exchange of telephony data which supports a telephone conversation between telephony device 2110 and the telephony correspondent. It is noted that the telephony data is carried by real-time frames (i.e. RTP or CRTP frames). Between modem 2113 and proxy server 2120 the real-time frames are transmitted in the real-time subchannel of the tinygram protocol connection Cₚ.

Telephony application 2132 and the telephony client may support various other virtual presence functions such as call forwarding, teleconferencing, redial, intercomm, voice mail, etc. for the remote user.

When telephony application 2132 receives a telephone call which has been redirected from the user's office number to telephony gateway 123, the telephony application 2132 may forward the telephone call to the remote user so that the caller is given the illusion that the remote user is physically present in the office. In another embodiment, telephony application 2132 may provide one or more indications to the caller that the remote user is not physically present in the office when handling the remote forwarding. Telephony application 2132 may be configured to operate in a nondisclosure mode or a disclosure mode at the remote user's selection. In the disclosure mode, telephony application 2132 may provide some indication of the user's absence from the office to callers when calls are forwarded to the remote user. In the nondisclosure mode, no such indications are provided, and callers are given the illusion that the remote user is physically present in the office.

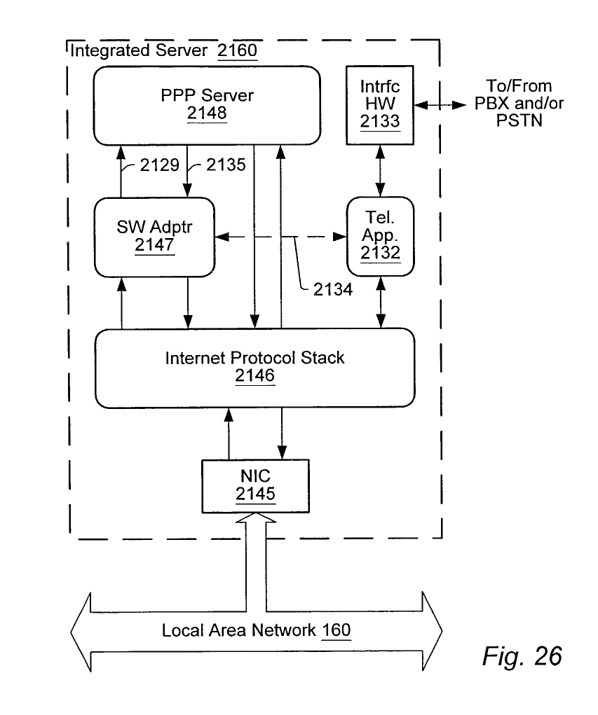

FIG. 26 illustrates an integrated server 2160 where the functions of proxy server 2120, VPN server 122 and telephony gateway 123 are implemented on a single host computer. Such an integrated server may be a more cost effective solution for smaller corporations/organizations.

Integrated server 2160 comprises a host computer coupled to network interface card 2145 and telephony interface hardware 2133. Network interface card provides the host computer with connectivity to local area network 160. The host computer executes software including software adapter 2147, PPP server 2148, telephony application 2132 and IP stack 2146. PPP server 2148 operates similarly to VPN server application 2138. However, PPP server 2148 communicates directly with software adapter 2147 using PPP streams 2129 and 2135. PPP stream 2129 comprises tunnel frames (i.e. encrypted regular data frames) transmitted from client computer 112. PPP stream 2135 comprises tunnel frames which are destined for client computer 112. PPP Server 2148 may be a conventional software product. Software adapter 2147 may be configured identically to software adapter 2137 except the socket interfaces corresponding to sockets S5 and S6 are replaced with a PPP interface to send and receive PPP streams 2129 and 2135. Software adapter 2147 may send and receive real-time telephony frames to telephony application 2132 through IP stack 2146. Alternatively, software adapter 2147 may send and receive real-time telephony frames more directly to/from telephony application 2132 as indicated by the dotted communication path 2134.

It is noted that alternate embodiments are contemplated where any subset of proxy server 2120, VPN server 122 or telephony gateway 123 are integrated on a common host computer. For example, corporate clients who already possess a VPN server may desire to purchase an integrated proxy server and telephony server without the VPN functionality. Arbitrary mappings of the servers onto any number of host computers are contemplated.

Although the system of the present invention has been described in connection with several preferred embodiments, it is not intended to be limited to the specific forms set forth herein, but on the contrary, it is intended to cover such alternatives, modifications, and equivalents, as can be reasonably included within the spirit and scope of the invention as defined by the appended claims.

We claim:

1. A communication system comprising:
a telephony server configured to provide telephony services for a first plurality of office communication lines;
a local area network coupled to the Internet;
a server system configured for coupling to the telephony server and to the local area network;
a first user communication device situated remotely from the telephony server and the local area network, wherein the first user communication device is configured to establish a first connection to the server system through the Internet;
wherein the server system is further configured to provide access for the first user communication device to the telephony server over the Internet in response to the first user communication device establishing the first connection to the server system; and
wherein the server system is further configured to invoke a call forwarding operation, in response to said first user communication device establishing the first connection to the server system, so that subsequent telephone calls, intended to reach a first office communication line of said first plurality of office communication lines, are forwarded to the server system to be forwarded to the first user communication device over the Internet.

2. The communication system of claim 1, wherein the telephony server is a Private branch exchange (PBX).

3. The communication system of claim 1, wherein the telephony server associates a first telephone number with the first office communication line, wherein the server system invokes said call forwarding operation by commanding the telephony server to redirect subsequent telephone calls addressing the first telephone number to a second telephone number, wherein the second telephone number is associated with the server system.

4. The communication system of claim 3, wherein said server system is coupled to said telephony server through a first collection of physical lines, wherein the telephony server associates a second plurality of telephone numbers to the first collection of physical lines, wherein the telephony server manages the first collection of physical lines as a hunt group with respect to the second plurality of telephone numbers.

5. The communication system of claim 4, wherein said server system is configured to support a plurality of user communication devices simultaneously connected to the server system, wherein each of the plurality of user communication devices connects to the server system over the Internet through one or more Internet Protocol connections, wherein the server system allocates the second telephone number from the second plurality of telephone numbers to the first user communication device in response to the first user communication device establishing the first connection to the server system.

6. The communication system of claim 5, wherein the first user communication device is configured to transmit information identifying a remote user of the first user communication device to the server system, wherein the server system is configured to look up the first telephone number based on the identifying information.

7. The communication system of claim 3, wherein the server system is configured to receive a first telephone call, which has been redirected by the telephony server from the first telephone number to the second telephone number, and to forward a first indication of the first telephone call to the first user communication device through the first connection.

8. The communication system of claim 7, wherein, in response to an answer indication received from the first user communication device, the server system is configured to receive a first voice signal from the telephony server, and to transmit corresponding first voice data to the first user communication device through the first connection.

9. The communication system of claim 8, wherein the first voice signal represents the voice signal of a correspondent who initiated the first telephone call expecting to be connected to the first office communication line.

10. The communication system of claim 7, wherein the first telephone call originates from a second office communication line of said first plurality of office communication lines.

11. The communication system of claim 7, wherein the telephony server couples to the Public Switched Telephone Network (PSTN), wherein the first telephone call originates from the PSTN.

12. The communication system of claim 1 wherein the server system is further configured to provide access for said first user communication device to said local area network.

13. The communication system of claim 12, wherein the server system is configured to provide access to the local area network and to the telephony server for a plurality of user communication devices including the first user communication device.

14. The communication system of claim 12, wherein the first user communication device comprises a client computer and a client modem.

15. The communication system of claim 14, wherein the server system further comprises a telephony gateway which interfaces with the telephony server, wherein the client computer is configured to execute a telephony client application, wherein the telephony client application is configured to establish the first connection through the Internet to the telephony gateway.

16. The communication system of claim 15, wherein the telephony client application supports a first phone for use by a remote user of the client computer, wherein the telephony client application and the telephony gateway maintain a voice and telephony control interface between the first phone and the telephony server by exchanging telephony packets through the first connection, wherein the telephony packets comprise voice data and control messages.

17. The communication system of claim 16, wherein the telephony client application is configured to repeatedly transmit a first control message in successive telephony packets to the telephony gateway through the first connection until receiving a return telephony packet from the telephony gateway containing an indication that the telephony gateway has received the first control message.

18. The communication system of claim 16, wherein the telephony gateway is configured to repeatedly transmit a first control message in successive telephony packets to the telephony client application through the first connection until receiving a return telephony packet from the telephony client application containing an indication that the telephony client application has received the first control message.

19. The communication system of claim 16, wherein the telephony server is configured to provide a first set of telephony functions to the first office communication line, wherein the voice and telephony control interface extends to the first phone at least a subset of the first set of telephony functions.

20. The communication system of claim 19, wherein said subset of telephony functions includes extension dialing, so that the user specifies only an extension number to the first phone in order to call a second office communication line of said first plurality.

21. The communication system of claim 16, wherein the first phone comprises a graphical user interface.

22. The communication system of claim 16, wherein the first phone comprises a physical phone.

23. The communication system of claim 16, wherein the telephony gateway is configured to measure an elapsed time from reception of a last telephony packet from the telephony client application, wherein said telephony gateway is configured to automatically cancel said call forwarding operation when said elapsed time exceeds a predefined timeout value.

24. The communication system of claim 23, wherein the telephony client application is configured to transmit telephony packets comprising keep-alive messages to the telephony gateway through the first connection to prevent cancellation of the call forwarding operation.

25. The communication system of claim 16, wherein the telephony client application is configured to transmit a third telephone number to the telephony gateway through the first connection in response to user manipulations of the first phone, wherein the telephony gateway is configured to receive the third telephone number, and to initiate a second telephone call addressed to the third telephone number through the telephony server.

26. The communication system of claim 25, wherein the server system is configured to maintain a log file which comprises information regarding each telephone call initiated for the remote user by the telephony gateway.

27. The communication system of claim 15, wherein the server system further comprises a virtual private network (VPN) server, wherein the client computer is further configured to execute a VPN client application, wherein the VPN client application is configured to establish a second connection through the Internet to the VPN server.

28. The communication system of claim 27, wherein the VPN server is further configured to receive first network data transmitted from the VPN client application through the second connection, and to transmit the first network data onto the local area network, wherein the VPN server is further configured to receive second network data, generated in response to the first network data, from the local area network, and to transmit the second network data to the VPN client application through the second connection.

29. The communication system of claim 27, wherein the telephony client application establishes the first connection to the telephony gateway and the VPN client application establishes the second connection to the VPN server, in response to a remote user invoking a virtual presence client which also executes on the client computer.

30. The communication system of claim 27, wherein the client modem is configured for coupling to a server modem through a switching network, wherein the server modem is configured for coupling to a remote access server, wherein the remote access server connects to the Internet.

31. The communication system of claim 30, wherein the remote access server is situated at an Internet service provider (ISP).

32. The communication system of claim 30, wherein the client computer is configured to execute one or more real-time applications including the telephony client application, wherein the telephony client application is configured to generate first telephony frames addressed for the telephony gateway, wherein the one or more real-time applications are configured to generate first real-time data frames, wherein the first real-time data frames include the first telephony frames generated by the telephony client application, wherein the VPN client application is configured to generate first regular data frames, wherein the client modem is configured to receive the first real-time data frames and the first regular data frames, and to transmit the first real-time data frames and the first regular data frames to the server modem through the switching network, wherein the server modem is configured to send the first real-time data frames and the first regular data frames to the remote access server, wherein the remote access server is configured to transmit the first real-time data frames and the first regular data frames onto the Internet.

33. The communication system of claim 32, wherein normal Internet Protocol (IP) routing mechanisms are responsible for delivering the first telephony frames to the telephony gateway through the Internet, and for delivering the first regular data frames to the VPN server through the Internet.

34. The communication system of claim 32, wherein telephony gateway transmits second telephony frames, addressed for the telephony client application, onto the local area network, wherein the VPN server transmits second regular data frames, addressed for the VPN client application, onto the local area network, wherein the remote access server is configured to receive the second telephony frames and the second regular data frames from the Internet, and to send the second telephony frames and second regular data frames to the server modem, wherein the server modem is configured to transmit the second telephony frames and the second regular data frames to the client modem through the switching network, wherein the client modem is configured to send the second telephony frames and the second regular data frames to the client computer.

35. The communication system of claim 34, wherein an IP stack executing on the client computer is configured to receive the second telephony frames and the second regular data frames from the client modem, and to send the second telephony frames to the telephony client application, and send the second regular data frames to the VPN client application.

36. The communication system of claim 34, wherein normal IP routing mechanisms are responsible for delivering the second telephony frames and the second regular data frames to the remote access server through the Internet from the local area network.

37. The communication system of claim 34, wherein the client modem receives the first real-time data frames and the first regular data frames from the client computer, stores the first real-time data frames in a first real-time buffer, stores the first regular data frames in a first regular data buffer, transmits real-time data from the first real-time buffer onto the switching network when the first real-time buffer is nonempty, and transmits regular data from the first regular data buffer onto the switching network only when the first real-time buffer is empty and when the first regular data buffer is nonempty.

38. The communication system of claim 37, wherein the client modem transmits a first escape sequence prior to transmitting the real-time data.

39. The communication system of claim 37, wherein the server modem receives the second telephony frames and the second regular data frames from the remote access server, stores the second telephony frames in a second real-time buffer, stores the second regular data frames in a second regular data buffer, transmits real-time data from the second real-time data buffer onto the switching network when the second real-time buffer is nonempty, and transmits regular data from the second regular data buffer onto the switching network only when the second real-time buffer is empty and when the second regular data buffer is nonempty.

40. The communication system of claim 39, wherein the server modem transmits a first escape sequence prior to transmitting the real-time data from the second real-time data buffer.

41. The communication system of claim 34, wherein the server system further comprises a proxy server, wherein the server modem comprises a conventional modem, wherein the client modem establishes a third IP connection to the proxy server through the switching network, the server modem, the remote access server, and the Internet.

42. The communication system of claim 41, wherein the client modem multiplexes the first real-time data frames and the first regular data frames into a first stream of tinygrams addressed for the proxy server, and transmits the first stream of tinygrams to the proxy server through the third IP connection, wherein the proxy server recovers the first real-time data frames and the first regular data frames from the first stream of tinygrams, and sends the first telephony frames to the telephony gateway through the local area network and sends the first regular data frames to the VPN server through the local area network.

43. The communication system of claim 42, wherein the client modem is configured to embed real-time data from the first real-time buffer into the tinygrams comprising the first stream with priority over regular data from the first regular data buffer.

44. The communication system of claim 42, wherein the proxy server receives the second telephony frames from the telephony gateway, and the second regular data frames from the VPN server, wherein the proxy server multiplexes the second telephony frames and the second regular data frames into a second stream of tinygrams and transmits the second stream of tinygrams to the client modem through the third IP connection, wherein the client modem recovers the second telephony frames and the second regular data frames from the second stream of tinygrams, and sends the second telephony frames and the second regular data frames to the client computer.

45. The communication system of claim 44, wherein the proxy server is configured to embed real-time data from the second real-time buffer into the tinygrams comprising the second stream with priority over regular data from the second regular data buffer.

46. A communication system comprising:
a telephony server configured to provide telephony services for a first plurality of office communication lines;
a local area network coupled to the Internet;
a server system configured for coupling to the telephony server and to the local area network;
a first user communication device situated remotely from the telephony server and the local area network, wherein the first user communication device comprises a client computer and a client modem, wherein the client modem is configured for coupling to a server modem through a switching network, wherein the server modem is configured for coupling to a remote access server, wherein the remote access server couples to the Internet;
wherein the server system comprises:
a telephony gateway which interfaces with the telephony server, wherein the client computer is configured to execute a telephony client application, wherein the telephony client application is configured to establish a first connection through the client modem, the switching network, the server modem, the remote access server and the Internet to the telephony gateway, wherein the telephony gateway is configured to automatically provide access for the first user communication device to the telephony server in response to the telephony client application establishing the first connection to the telephony gateway, wherein the telephony gateway is further configured to automatically invoke a call forwarding operation, in response to the telephony client application establishing the first connection to the server system, so that subsequent telephone calls, intended to reach a first office communication line of said first plurality, are forwarded to the telephony gateway;
a virtual private network (VPN) server, wherein the client computer is further configured to execute a VPN client application, wherein the VPN client application is configured to establish a second connection through the client modem, the switching network, the server modem, the remote access server and the Internet to the VPN server, wherein the VPN server is configured to provide access to the local area network for the first user communication device;
wherein the server system is configured to extend access to the telephony server and the local area network over the Internet for a plurality of user communication devices including the first user communication device.

47. The communication system of claim 46, wherein one or more real-time applications running on the client computer are configured to generate real-time frames, wherein one or more non-real-time applications also running on the client computer are configured to generate regular frames, wherein the client computer is configured to multiplex the real-time frames and the regular frames into a first stream, and to present the first stream to a data interface for transmission to the client modem.

48. The communication system of claim 47, wherein the client modem comprises:
a first real-time buffer;
a first regular buffer; and
first control logic, wherein the first control logic is configured (a) to receive the first stream from the first data interface, (b) to demultiplex the real-time frames and the regular frames from the first stream, (c) to store the real-time frames into the first real-time buffer and the regular frames into the first regular buffer, (d) to initiate transmission of a first regular frame from the first regular buffer onto a communication medium, (e) to temporarily interrupt transmission of the first regular frame in response to the first real-time buffer attaining a first non-empty condition, (f) to transmit one or more of the real-time frames from the first real-time buffer onto the communication medium until the first real-time buffer attains a first empty condition, (g) to resume transmission of the first regular frame in response to the first real-time buffer attaining the first empty condition.

49. The communication system of claim 48, wherein the communication medium comprises a subscriber line connection to the switching network, wherein the switching network connects the client modem and the server modem, wherein the transmissions of the client computer onto the communication medium comprise an output data stream, wherein the server modem is configured to recover the real-time frames and the regular frames from the output data stream, wherein the server modem is configured to send the real-time frames and the regular frames to the remote access server, wherein the remote access server is configured to transmit the real-time frames and the regular frames onto the Internet.

50. The communication system of claim 49, wherein the real-time frames include telephony frames, addressed for the telephony gateway and generated by the telephony client application, wherein the regular frames include tunnel frames addressed for the VPN server and generated by the VPN client application.

51. The communication system of claim 48, wherein the first control logic is further configured (h) to increment a real-time frame count in response to a completion of storage of any one of the real-time frames into the first real-time buffer, (i) to decrement the real-time frame count in response to completing transmission of any real-time frame from the first real-time buffer onto the communication medium, wherein the first real-time buffer attains the first non-empty condition when the real-time frame count attains a value greater than zero, wherein the first real-time buffer attains the first empty condition when the real-time frame count attains the value of zero.

52. The communication system of claim 46, wherein the remote access server is configured to receive real-time frames from the Internet and regular data frames from the Internet, to multiplex the real-time frames and the regular frames into a fourth stream, and to present the fourth stream to the server modem for transmission to the client modem.

53. The communication system of claim 52, wherein the server modem comprises:
a second real-time buffer;
a second regular buffer;
and second control logic, wherein the second control logic is further configured (h) to receive the fourth stream from the remote access server, (i) to demultiplex the real-time frames and the regular frames from the fourth stream, (j) to store the real-time frames in the second real-time buffer and the regular frames into the second regular buffer, (k) to transmit one or more of the real-time frames from the second real-time buffer onto the switching network in response to a second non-empty condition of the second real-time buffer and until the second real-time buffer attains a second empty condition, (l) to transmit a second regular frame from the second regular buffer onto the switching network in response to the second empty condition of the second real-time buffer and a third non-empty condition of the second regular buffer.

54. The communication system of claim 53, wherein the real-time frames include telephony frames generated by the telephony gateway and transmitted to the remote access server through the Internet, wherein the regular frames include tunnel frames generated by the VPN server and transmitted to the remote access server through the Internet.

55. The communication system of claim 48, wherein the first control logic comprises a central processing unit (CPU) of the client computer, wherein (a) through (g) are implemented by a first software module executing on the CPU, wherein the first software module receives the first stream from the data interface, wherein the communication medium comprises an interface to a conventional modem, wherein the conventional modem is configured for coupling to the switching network.

56. The communication system of claim 48, wherein the first control logic comprises a microprocessor configured within the client modem, wherein the first data interface comprises a physical interface between the client modem and the client computer.

57. The communication system of claim 48, wherein the first control logic is further configured to transmit an escape character onto the communication medium after said temporarily interrupting transmission of the first regular frame and prior to said transmission of said one or more of the real time frames from the first real-time buffer.

58. The communication system of claim 57, wherein the first control logic is further configured to scan characters of first regular frame prior to transmission, wherein said scanning operates on the characters of the first regular frame as a character stream, wherein said scanning includes injecting a secondary character after solo occurrences of the escape character in the character stream, wherein said secondary character is different from the escape character.

59. The communication system of claim 48, wherein the first control logic is further configured (h) to generate an initial portion of a first containing frame in response to the first real-time buffer attaining the first non-empty condition and the first regular buffer concurrently being empty, (i) to transmit the initial portion of the first containing frame onto the communication medium, (j) to repeatedly transmit a real-time frame from the first real-time buffer onto the communication medium until the first real-time buffer attains the first empty condition.

60. The communication system of claim 59, wherein the first control logic is further configured to transmit a terminating portion of the first containing frame in response to the first real-time buffer attaining the first empty condition and the first regular buffer concurrently being empty.

61. The communication system of claim 60, wherein the first control logic is further configured (k) to initiate transmission of a second regular frame from the first regular buffer in response to the first real-time buffer attaining the first empty condition and the first regular buffer concurrently being non-empty.

62. The communication system of claim 47, wherein the server system further comprises a proxy server, wherein the server modem comprises a conventional modem, wherein the client modem communicates with the proxy server through an third IP connection which spans the switching network, the server modem, the remote access server, and the Internet, wherein the client modem comprises:
a first real-time buffer;
a first regular buffer;
demultiplexing logic configured to receive the first stream from the data interface, to store the real-time frames from the first stream into the first real-time buffer, and to store the regular frames from the first stream into the first regular buffer; and
transmit logic configured to transmit data packets addressed to the proxy server onto a communication medium, wherein the transmit logic is further configured to embed real-time data from the first real-time buffer and regular data from the first regular buffer into the data packets, in a manner which prioritizes the real-time data over the regular data.

63. The communication system of claim 62, wherein the communication medium comprises a subscriber line connection to the switching network, wherein the switching network connects the client modem and the server modem, wherein the server modem is configured to receive the data packets from the switching network and to send the data packets to the remote access server, wherein the remote access server is configured to transmit the data packets onto the Internet.

64. The communication system of claim 63, wherein normal IP routing mechanisms are responsible for delivering the data packets to the proxy server through the Internet, wherein the proxy server is configured to recover the real-time frames and regular frames from the data packets, and to transmit the real-time frames and regular frames onto the local area network, wherein the real-time frames include telephony frames, addressed for the telephony gateway and generated by the telephony client application, wherein the regular frames include encrypted data frames addressed for the VPN server and generated by the VPN client application.

65. The modem of claim 62, wherein the transmit logic is configured to initiate transmission of a first packet comprising regular data from the first regular buffer in response to the first real-time buffer being empty and the first regular buffer being nonempty, wherein the transmit logic is further configured to discontinue transmission of the regular data in the first packet and to complete transmission of the first packet by transmitting a first real-time frame from the first real-time buffer in response to the first real-time buffer becoming non-empty, wherein the first packet is transmitted onto the communication medium.

66. The communication system of claim 65, wherein the real-time frames as received from the data interface are encapsulated in UDP frames, wherein the transmit logic is further configured to format the first packet according to the Transmission Control Protocol, and to perform header compression on the TCP-formatted first packet prior to transmission onto the communication medium.

67. The communication system of claim 65, wherein the transmit logic is further configured to format the first packet according to the User Datagram Protocol prior to transmission onto the communication medium.

68. The communication system of claim 65, wherein the transmit logic is further configured to complete transmission of the first packet if the first real-time buffer remains empty until an ending portion of a first regular frame has been transmitted from the first regular buffer.

69. The communication system of claim 68, wherein the transmit logic is further configured to embed a transmit frame number in the first packet which associates the first packet with the first regular frame.

70. The communication system of claim 69, wherein the transmit logic is further configured to embed a transmit section number in the first packet which defines a sequence number for packets, including the first packet, containing any portion of the first regular frame.

71. The communication system of claim 65, wherein the transmit logic is further configured (a) to determine if the first real-time buffer is non-empty after transmission of an immediately preceding packet, and (b) to transmit a second packet containing a second real-time frame from the first real-time buffer and none of the regular data from the first regular buffer in response to an affirmative determination that the first real-time buffer is non-empty.

72. The communication system of claim 71, wherein the transmit logic is further configured (c) to determine if the first regular buffer is non-empty after the transmission of the immediately preceding packet, and (d) to initiate transmission of a third packet containing more of the regular data from the first regular buffer in response to a determination that the first real-time buffer is empty and the first regular buffer is nonempty.

73. The communication system of claim 65, wherein the transmit logic is further configured to embed an acknowledgement type field in the first packet, wherein the acknowledgement type field indicates either (a) a full acknowledgement of one or more packets previously received from the proxy server, (b) a partial acknowledgement of a particular packet previously received from the proxy server, or (c) no acknowledgement.

74. The communication system of claim 65, wherein the demultiplexing logic and transmit logic are implemented by a software client running on the client computer, wherein the communication medium comprises a connection to a physical modem, wherein the physical modem is configured for coupling to the server modem through the switching network.

75. The communication system of claim 46, wherein the server system further comprises a proxy server, wherein the server modem comprises a conventional modem, wherein the proxy server communicates with the client modem through a third IP connection which spans the Internet, the remote access server, the server modem and the switching network, wherein the proxy server comprises:
a host computer coupled to the local area network;
a software adapter running on the host computer, wherein the software adapter comprises:
a first real-time buffer;
a first regular buffer;
a frame separator configured to receive real-time frames from a first data interface and regular frames from a second data interface, to store the real-time frames into the first real-time buffer, and to store the regular frames into the first regular buffer; and
a transmission interface configured to transmit data packets, addressed to the client modem, onto the local area network, wherein the transmission interface is further configured to embed real-time data from the first real-time buffer and regular data from the first regular buffer into the data packets in a manner which prioritizes the real-time data over the regular data.

76. The communication system of claim 75, wherein the real-time frames comprise telephony frames addressed for the telephony client application and transmitted by the telephony gateway through the local area network to the proxy server, wherein the regular frames comprise encrypted data frames addressed for the VPN client application and transmitted by the VPN server through the local area network to the proxy server.

77. The communication system of claim 75, where normal IP routing mechanisms are responsible for delivering the data packets from proxy server to the remote access server through the local area network and the Internet, wherein the remote access server is configured to send the data packets to the client modem through the server modem and the switching network, wherein the client modem is configured to recover the real-time frames and the regular frames from the data packets, and to send the real-time frames with priority over the regular frames to the client computer.

78. The communication system of claim 75, wherein the transmission interface is further configured to initiate transmission of a first packet comprising regular data from the first regular buffer in response to the first real-time buffer being empty and the first regular buffer being non-empty, wherein the transmission interface is further configured to discontinue transmission of the regular data in the first packet and to complete transmission of the first packet by transmitting a first real-time frame from the first real-time buffer in response to the first real-time buffer becoming non-empty, wherein the first packet is transmitted to a third data interface.

79. The communication system of claim 78, wherein the transmission interface is configured to initiate transmission of the first packet in response to (a) the first real-time buffer being empty, (b) the first regular buffer being non-empty, and (c) a clearing time variable being smaller than a first predetermined value.

80. The communication system of claim 79, wherein the transmission interface is configured to multiplex the real-time frames from the first real-time buffer and the regular frames from the first regular buffer into the data packets including the first packet, and to transmit the data packets to the third data interface, wherein the transmission interface is configured to increase the clearing time variable after transmission of each of the data packets by an amount proportional to a data length of the data packet, wherein the transmission interface is configured to deplete the clearing time variable with respect to time.

81. The communication system of claim 80, wherein the amount corresponds to time D/R, wherein D represents the data length of the packet and R represents a predefined data transfer rate.

82. The communication system of claim 78, wherein the transmission interface is further configured to complete transmission of the first packet without including any real-time data from the first real-time buffer in response to the first real-time buffer remaining empty until the regular data transmitted in the first packet attains a size equal to a first data limit.

83. The communication system of claim 82, wherein the first data limit is substantially equal to R(T−X), wherein T is a maximum time delay, X is the clearing time, and R is a predefined data transfer rate.

84. The communication system of claim 78, wherein the transmission interface is further configured to complete transmission of the first packet without including any real-time data from the first real-time buffer if the first real-time buffer remains empty until an ending portion of a first regular frame has been transmitted in the first packet.

85. The communication system of claim 78, wherein the transmission interface is further configured (a) to determine if the first real-time buffer is non-empty after transmission of an immediately preceding packet, and (b) to transmit a second packet containing a second real-time frame from the first real-time buffer and none of the regular data from the first regular buffer in response to an affirmative determination that the first real-time buffer is non-empty.

86. The communication system of claim 78, wherein the first data interface, second data interface and third data interface comprise socket interfaces between the software adapter and an internet protocol stack also running on the host computer.

87. The communication system of claim 86, wherein the transmission interface is further configured to format the first packet according to the User Datagram Protocol prior to transmitting the first packet through the third data interface to the internet protocol stack.

88. The communication system of claim 87 further comprising a device driver executing on the host computer, wherein the device driver is configured:
to receive the first packet from the internet protocol stack;
to reformat the first packet according to the Transmission Control Protocol;
to provide the first packet after said reformatting to a network interface for transmission onto the local area network.

89. The communication system of claim 78, wherein the software adapter further comprises:
a second real-time buffer;
a second regular buffer;
a reception interface configured (a) to receive a second stream of packets, transmitted by the client modem, from a fourth data interface, (b) to demultiplex real-time data frames and regular data frames from the second stream of packets, (c) to store the real-time data frames into the second real-time buffer, (d) to store the regular data frames into the second regular buffer; and
forwarding logic configured to transmit the real-time data frames from the second real-time buffer and the regular data frames from the second regular buffer onto the local area network.

90. The communication system of claim 98 further comprising a device driver which executes on the host computer, wherein the device driver is configured:
to receive a third stream of packets formatted according to the Transfer Control Protocol from the local area network;
to generate the second stream of packets by reformatting the third stream of packets according to the User Datagram protocol;
to provide the second stream of packets to a protocol stack running on the host computer;
wherein the protocol stack provides the second stream of packets to the reception interface through the fourth data interface.

91. A system, comprising:
a remote site having a user communication device configured to connect to an office site through an Internet connection, wherein said user communication device is remote from said office site;
said office site comprising:
a telephony server configured to provide telephony functionality to a plurality of office users over a plurality of office communication lines, wherein one of said office communication lines has an office number assigned to said user;
a local area network configured to provide data communication; and
a server system configured to automatically provide access for said user communication device to said local area network and to said telephony server in response to said user communication device connecting to the office site, wherein said server system is configured to automatically invoke a call forwarding operation in response to said user communication device connecting to the office site so that calls made to said office number intended to reach the user at said office site are forwarded to said server system, wherein said server system sends said calls to said user communication device through the Internet, and wherein said server system is further configured to send data communications from said office data network to said user communication device through the Internet while sending said calls to said user communication device through the Internet.

92. The system of claim 91, wherein the user communication device comprises a client computer and a client modem, wherein the server system further comprises a telephony gateway which interfaces with the telephony server, wherein the client computer is configured to execute a telephony client application, wherein the telephony client application is configured to establish a first connection through the Internet to the telephony gateway, wherein the telephony client application supports a first phone for use by said user, wherein the telephony client application and the telephony gateway maintain a voice and telephony control interface between the first phone and the telephony server by exchanging telephony packets through the first connection, wherein the telephony packets comprise voice data and control messages.

93. The system of claim 92, wherein the telephony server is configured to provide a first set of telephony functions to said one of the office communication lines, wherein the voice and telephony control interface extends to the first phone at least a subset of the first set of telephony functions.

94. The system of claim 93, wherein the server system further comprises a virtual private network (VPN) server, wherein the client computer is further configured to execute a VPN client application, wherein the VPN client application is configured to establish a second connection through the Internet to the VPN server.

95. The system of claim 94, wherein the VPN server is further configured to receive first network data transmitted from the VPN client application through the second connection, and to transmit the first network data onto the local area network, wherein the VPN server is further configured to receive second network data, generated in response to the first network data, from the local area network, and to transmit the second network data to the VPN client application through the second connection.

96. The communication system of claim 95, wherein the client modem is configured for coupling to a server modem through a switching network, wherein the server modem is configured for coupling to a remote access server, wherein the remote access server connects to the Internet, wherein the telephony client application establishes the first connection to the telephony gateway through the client modem, the switching network, the server modem, the remote access server and the Internet, wherein the VPN client application establishes the second connection to the VPN server through the client modem, the switching network, the server modem, the remote access server and the Internet.

97. A method for providing a remote user with access to an office telephony server and an office data network, wherein the office telephony server is configured to provide telephony services for a first plurality of office communication lines, wherein the office data network is coupled to the Internet, the method comprising:
a first user communication device, situated remotely from the office telephony server and the office data network, establishing a first connection to a server system through the Internet, wherein the server system couples to the office telephony server and to the office data network;
the server system automatically providing access for the first user communication device to the office telephony server in response to the first user communication device establishing the first connection to the server system;
the server system automatically invoking a call forwarding operation, in response to said first user communication device establishing the first connection to the server system, so that subsequent telephone calls, intended to reach a first office communication line of said first plurality, are forwarded to the server system.

98. A server system at an office site, comprising:
at least one host computer configured with (a) a telephony application to support a first connection through the Internet with a user communication device at a remote site, and (b) a virtual private network (VPN) server application to support a second connection through the Internet with the user communication device;
a telephony interface to a telephony server configured to provide telephony functionality to a plurality of office users over a plurality of office communication lines;
a network interface to a local area network configured to provide data communication; and
wherein the server system is configured to automatically provide access for said user communication device (c) to said telephony server in response to said user communication device establishing the first connection to the server system through the Internet, and (d) to said local area network in response to said user communication device establishing the second connection to the server system through the Internet;
wherein the server system is configured to automatically invoke a call forwarding operation in response to said user communication device establishing the first connection to the telephony application so that calls intended to reach the user at said office site are forwarded to the server system through the telephony interface, wherein the server system sends said calls to said user communication device through the first connection over the Internet, wherein the server system is further configured to send data communications from said local area network to said user communication device through the second connection while sending said calls to said user communication device through the first connection.

99. The server system as recited in claim 98, wherein said telephony interface to a telephony server comprises an interface to a private branch exchange (PBX).
